(19) United States
(12) Patent Application Publication
(10) Pub. No.: US 2018/0279429 A1
(43) Pub. Date: Sep. 27, 2018

(54) Solid State Lighting Systems

(71) Applicant: INNOSYS, INC., Salt Lake, UT (US)

(72) Inventor: Laurence P. Sadwick, Salt Lake City, UT (US)

(21) Appl. No.: 15/761,382

(22) PCT Filed: Sep. 19, 2016
(86) PCT No.: PCT/US16/52560

§ 371 Date: Mar. 19, 2018

Related U.S. Application Data
(60) Provisional application No. 62/220,140, filed on Sep. 17, 2015.
(60) Provisional application No. 62/220,145, filed on Sep. 17, 2015.
(60) Provisional application No. 62/220,151, filed on Sep. 17, 2015.

(51) Int. Cl. H05B 33/08; F21K 9/27; H05B 37/02

(52) U.S. Cl. CPC H05B 33/0815; F21K 9/27; F21Y 2103/00; H05B 37/0245; H05B 33/0845

(57) ABSTRACT

A lighting system includes at least one solid state light adapted to replace a lamp in a fluorescent lamp fixture, and a power supply configured to convert power drawn from the fluorescent lamp fixture to power the at least one solid state light. The power supply includes a rectifier, a voltage regulator, a power output for the at least one solid state light, and an auxiliary DC power output. The power supply is configured to generate a regulated DC voltage and/or current at the auxiliary DC power output based on the power drawn from the fluorescent lamp fixture.

### BACKGROUND

Fluorescent lamps are widely used in a variety of applications, such as for general purpose lighting in commercial, industrial, office, home and residential locations, etc. Conventional fluorescent tubes used for general lighting cannot, in general, be directly plugged into alternating current (AC) voltage lines. Fluorescent lamps generally include a glass tube, linear, circular, spiral or other shaped bulb containing a gas at low pressure, such as argon, xenon, neon, or krypton, along with low pressure mercury vapor. A fluorescent coating is deposited on the inside of the lamp. As an electrical current is passed through the lamp, mercury atoms are excited and photons are released, most having frequencies in the ultraviolet spectrum. These photons are absorbed by the fluorescent coating, causing it to emit light at visible frequencies.

Electronic ballasts convert the input AC voltage supplied (typically at a low AC frequency of 50 or 60 Hz) power into generally a sinusoidal AC output waveform typically designed for a constant current output in the frequency range of above 20 to 40 kHz to typically less than 100 kHz and sometimes greater than 100 kHz. Magnetic ballasts limit the typically 50 or 60 Hz current to an appropriate value for the florescent tubes and lamps.

Fluorescent lamps can suffer from a number of disadvantages, such as a relatively short life span, flickering, and noisy ballasts, etc. However nowadays there are many high quality electronic ballasts that are available. Although the ballasts may be of high quality and long life, often the fluorescent tubes that are powered by the ballasts, suffer from a number of undesirable effects including reduced lifetime due, for example, to being switched on and off too often.

### SUMMARY

The present invention provides solid state lighting including a fluorescent replacement that, for example, powers a solid state lighting source such as, for example, but not limited to, a LED and/or OLED and/or QD lamp from a fluorescent fixture, including operating and being powered by electronic ballasts. Embodiments of the present invention also allow for digital lighting and a digital platform in general.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE FIGURES

A further understanding of the various embodiments of the present invention may be realized by reference to the Figures which are described in remaining portions of the specification. In the Figures, like reference numerals may be used throughout several drawings to refer to similar components.

FIG. 1 is a block diagram of an embodiment of a solid state fluorescent replacement lighting system receiving power from both AC input and ballast output in accordance with some embodiments of the invention.

FIG. 2 is a block diagram of an embodiment of a solid state fluorescent replacement lighting system receiving power from both AC input and ballast output and with rectified EMI filtering in accordance with some embodiments of the invention.

FIG. 3 is a block diagram of an embodiment of a solid state fluorescent replacement lighting system receiving power from both AC input and ballast output and with rectified EMI filtering in accordance with some embodiments of the invention.

FIG. 4 is a block diagram of an embodiment of a solid state fluorescent replacement lighting system receiving power from a ballast output and with lighting and power supply outputs in accordance with some embodiments of the invention.

FIG. 5 is a block diagram of an embodiment of a solid state fluorescent replacement lighting system receiving power from both AC input and ballast output and with lighting and power supply outputs in accordance with some embodiments of the invention.

FIG. 6 is a block diagram of an embodiment of a solid state fluorescent replacement lighting system receiving power from both AC input and ballast output and with lighting and power supply outputs in accordance with some embodiments of the invention.

FIG. 7 depicts a block diagram of a dimmer for a solid state lighting system which can receive and transmit dimming commands through a variety of input sources and output interfaces in accordance with some embodiments of the invention.

FIG. 8 depicts a block diagram of a solid state lighting system which can receive and transmit commands through a variety and combination of wired and/or wireless communications protocols in accordance with some embodiments of the invention.

FIG. 9 depicts a block diagram of a solid state lighting system which includes a Control/Monitor/ Log/ Tracking circuit in accordance with some embodiments of the invention.

FIGS. 10-18 depict block diagrams of solid state lighting systems that can be powered by both AC lines and ballast outputs and can be remote controlled and dimmed in both modes in accordance with some embodiments of the invention.

FIG. 19 depicts a solid state lighting system with intelligent controller providing current control feedback based on a variety of sources, such as, but not limited to, one or more of an output current sensor, output voltage sensor, powerline interface, serial interface and/or other interfaces in accordance with some embodiments of the invention.

FIG. 20 depicts a wirelessly controlled solid state lighting system/LED fluorescent lamp replacement with multiple different color temperature lamps in accordance with some embodiments of the invention.

FIG. 21 depicts an array of wirelessly controlled solid state lighting system/LED fluorescent lamp replacements which can be individually identified and controlled which can identify and track occupants to provide services such as, but not limited to, lighting, energy savings, temperature and environment monitoring and control, IOT, comfort, surveillance, hot spot detection, use, usage, occupancy/vacancy information, security and other sensors, controls, detectors, analytics, Big Data, etc., combinations of these, etc. in accordance with some embodiments of the invention.

FIG. 22 depicts an array of wirelessly controlled solid state lighting system/LED fluorescent lamp replacements which can identify and track occupants to provide services such as, but not limited to, lighting, security and other controls in accordance with some embodiments of the invention.

FIGS. 23-24 depict examples of a self-contained solid-state fluorescent tube replacement with motion and optionally other sensors in accordance with some embodiments of the invention.

FIG. 25 depicts an example of a self-contained solid-state fluorescent tube replacement with motion and optionally other sensors incorporated therein including, for example, external motion and sound sensors in accordance with some embodiments of the invention.

FIG. 26 depicts a power conversion stage circuit in accordance with some embodiments of the invention.

FIG. 27 depicts a solid state lighting power supply that can draw power from a fluorescent lamp fixture in accordance with some embodiments of the invention.

FIG. 28 depicts an overcurrent protection circuit in accordance with some embodiments of the invention.

FIG. 29 depicts an undervoltage protection circuit in accordance with some embodiments of the invention.

FIG. 30 depicts a dither circuit in accordance with some embodiments of the invention.

FIG. 31 depicts a dual power source circuit in accordance with some embodiments of the invention.

FIG. 32 depicts a dual power source circuit with tagalong inductor to power internal circuits in accordance with some embodiments of the invention.

FIG. 33 depicts a boost power supply circuit that can be used in some embodiments of a solid state fluorescent replacement lighting system for either or both lighting or secondary power supply in accordance with some embodiments of the invention.

FIG. 34 depicts a buck-boost power supply circuit that can be used in some embodiments of a solid state fluorescent replacement lighting system for either or both lighting or secondary power supply in accordance with some embodiments of the invention.

FIG. 35 depicts a flyback converter power supply circuit that can be used in some embodiments of a solid state fluorescent replacement lighting system for either or both lighting or secondary power supply in accordance with some embodiments of the invention.

FIG. 36 depicts a flyback converter power supply circuit with half bridge that can be used in some embodiments of a solid state fluorescent replacement lighting system for either or both lighting or secondary power supply in accordance with some embodiments of the invention.

FIG. 37 depicts a buck-boost power supply circuit with inverted output that can be used in some embodiments of a solid state fluorescent replacement lighting system for either or both lighting or secondary power supply in accordance with some embodiments of the invention.

FIG. 38 depicts a buck power supply circuit that can be used in some embodiments of a solid state fluorescent replacement lighting system for either or both lighting or secondary power supply in accordance with some embodiments of the invention.

FIG. 39 depicts a forward converter power supply circuit with full bridge that can be used in some embodiments of a solid state fluorescent replacement lighting system for either or both lighting or secondary power supply in accordance with some embodiments of the invention.

FIG. 40 depicts a power supply circuit with feedback control that can be used in some embodiments of a solid state fluorescent replacement lighting system in accordance with some embodiments of the invention.

FIG. 41 depicts a power supply circuit with feedback control and variable input capacitor that can be used in some embodiments of a solid state fluorescent replacement lighting system in accordance with some embodiments of the invention.

FIG. 42 depicts a block diagram of a solid state lighting system with multiple fluorescent lamp replacements in accordance with some embodiments of the invention.

FIG. 43 depicts a block diagram of a solid state lighting system with multiple fluorescent lamp replacements and multiple control devices in accordance with some embodiments of the invention.

FIG. 44 depicts an example user interface that can be used to control a solid state lighting system in accordance with some embodiments of the invention.

FIGS. 45A-45B depict front and back sides of a solid state lighting panel for use in a circadian rhythm alignment lighting system in accordance with some embodiments of the invention.

FIGS. 46A-46B depict front and back sides of another solid state lighting panel for use in, for example health care and other applications including but not limited to, a circadian rhythm alignment lighting system in accordance with some embodiments of the invention.

FIGS. 47A-47B depict front and back sides of another solid state lighting panel for use in, for example health care and other applications including but not limited to, a circadian rhythm alignment lighting system in accordance with some embodiments of the invention.

FIGS. 48A-48B depict front and back sides of another solid state lighting panel for use in, for example health care and other applications including but not limited to, a circadian rhythm alignment lighting system in accordance with some embodiments of the invention.

FIG. 49 depicts a solid state fluorescent lamp replacement with sensor and/or control interface(s) in accordance with some embodiments of the invention.

FIG. 50 depicts a solid state fluorescent lamp replacement with multiple region control in accordance with some embodiments of the invention.

FIG. 51 depicts a solid state fluorescent lamp replacement input stage for receiving power from a ballast output in accordance with some embodiments of the invention.

FIG. 52 depicts a solid state fluorescent lamp replacement input stage with heater emulation circuits for receiving power from a ballast output in accordance with some embodiments of the invention.

FIG. 53 depicts a solid state fluorescent lamp replacement input stage with EMI filtering for receiving power from a ballast output in accordance with some embodiments of the invention.

FIG. 54 depicts a power supply circuit with output control that can be used in some embodiments of a solid state fluorescent replacement lighting system in accordance with some embodiments of the invention.

FIG. 55 depicts a solid state fluorescent lamp replacement input stage with variable capacitance circuit in accordance with some embodiments of the invention.

FIG. 56 depicts a pulse-width modulated (PWM) or one-shot controller or other control signal including, but not limited to a linear signal(s), that can be used to generate the variable capacitance control signal to control the AC switch across the power input of FIG. 55 to regulate the output current and/or power in accordance with some embodiments of the invention.

FIG. 57 depicts an example of a feedback control circuit to provide a constant output current or for other purposes using a setpoint reference signal in accordance with some embodiments of the invention.

FIG. 58 depicts a circuit schematic of an example embodiment of a solid state fluorescent lamp replacement where, among other things, shunting is used to set the solid state light output that can be remote controlled and monitored in accordance with some embodiments of the invention.

FIG. 59 depicts an example embodiment of a control circuit that can be used with a solid state fluorescent lamp replacement in accordance with some embodiments of the invention.

FIG. 60 depicts an over-voltage protection and/or over-temperature protection circuit that can be used with a solid state fluorescent lamp replacement in accordance with some embodiments of the invention.

FIG. 61 depicts a ballast sequencing circuit in accordance with some embodiments of the invention.

FIG. 62 depicts a solid state lighting power supply that can draw power from a fluorescent lamp fixture to power a lighting system and to provide power for internal circuits, sensors or other applications in accordance with some embodiments of the invention.

FIG. 63 depicts a ballast detection circuit that can be used, for example, to gate other circuits such as to gate diode 1434 and/or diode 1444 in the feedback control circuit of FIG. 57 to enable or disable power from a ballast output or to detect whether a ballast is present in accordance with some embodiments of the invention.

FIGS. 64-66 depict block diagrams of identification circuits that can be used to identify, interact, work with, turn on or off, dim, etc. solid state fluorescent lamp replacements in a solid state lighting system, powered by one or more of multiple sources in accordance with some embodiments of the invention.

FIG. 67 depicts a solid state lighting system with color controllable multiple light sources in accordance with some embodiments of the invention.

FIGS. 68-70 depict block diagrams of solid state lighting systems with isolated control inputs in accordance with some embodiments of the invention.

### DETAILED DESCRIPTION OF THE INVENTION

Solid state lighting systems, including solid state fluorescent lamp replacements, are disclosed herein that may be used to power one or more light-emitting diode (LED), organic light-emitting diode (OLED) and/or quantum dot (QD) or other solid state lamps from a fluorescent fixture, whether the fixture includes a ballast of any type or not, or from other sources. Various power supplies that draw power from the fluorescent fixture are disclosed to power one or more solid state lamps. Various dimming control systems are disclosed to receive and process control signals from one or more sources and to control one or more solid state lamps.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention comprise an LED Fluorescent Lamp Replacement that is remote dimmable and can also be Triac, Triac-based, forward and reverse dimmer dimmable, etc. Control systems can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc.

In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics.

Some embodiments of the present invention may use multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both.

The solid state lighting systems can include single and multi-color lights including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc.

Color-changing/tuning can include, but is not limited to, white color-tuning including the color temperature tuning/adjustments/settings/ etc., color correction temperature (CCT), color rendering index (CRI), etc. including but not limited to with one or more of a red, green, blue, amber, cool white (i.e., relatively high kelvin color temperature), warm white (i.e., relatively low Kelvin color temperature), etc., combinations of these, etc., combinations that produce full spectrum lighting, etc.

Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. Some embodiments of the present invention can change to different colors when using light sources capable of supporting such (i.e., LEDs, OLEDs and/or QDs including but not limited to red, green, blue, amber, white LEDs and/or any other possible combination of LEDs and colors).

Embodiments of the present invention have the ability to store color choices, selections, etc. and retrieve, restore, display, update, etc. these color choices and selections when using non-fluorescent light sources that can support color changing and can also coordinate, copy, duplicate color setting including but not limited to color settings that are stored, coded, interpreted, etc. in digital format.

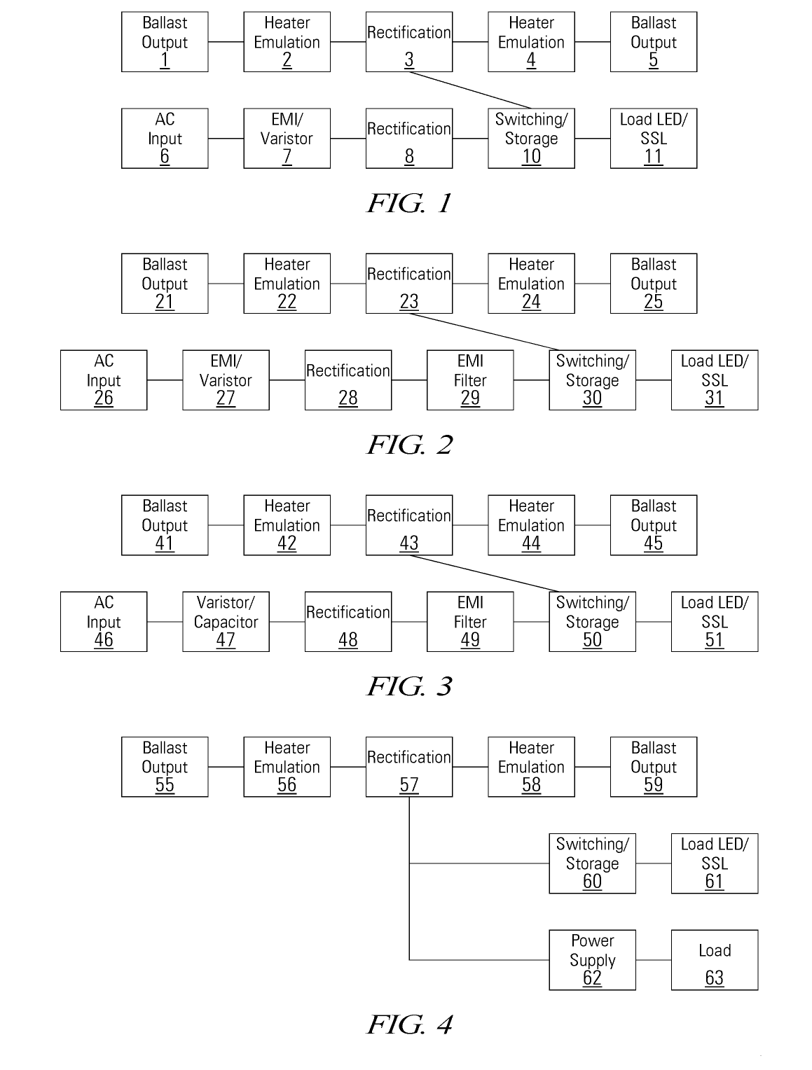

Turning to FIG. 1, an example embodiment of a solid state fluorescent replacement lighting system receiving power from both AC input and ballast output is depicted in accordance with some embodiments of the invention. The block diagrams do not show optional elements such as a snubber, the feedback, set point, control, sense, other components, UVP, OVP, OTP, OCP, SCP, remote interfaces including but not limited to 0 to 10 V, 0 to 3V, microcontrollers, digital signal processors, Bluetooth controllers, radio chips, other digital and analog systems and accessories, etc., other wired, wireless and/or powerline communications, other control, monitoring, measuring, storage, memory, FLASH, EEPROM, etc., combinations of these, etc. In the embodiment of FIG. 1, a solid state fluorescent replacement lighting system derives power from ballast outputs 1, 5 through optional heater emulation circuits 2, 4 and rectifier 3. Power can also or alternatively be derived from an AC input 6 through rectifier 8, with one or more optional EMI filters and varistor(s) 7. Power is converted in switch/storage circuit 10 to drive the solid state light(s) 11.

The EMI components are for illustrative purposes only and are not limited in any way or form to what is shown and depicted herein and may contain, but are not limited to, inductors, chokes, beads, capacitors, resistors, other types of passive and active components, etc., combinations of these, etc.

In some embodiments of the present invention, the rectification can be shared and common to both the ballast and AC line powered modes of operation, etc. In some embodiments of the present invention, power can also be by DC voltage including lower voltage DC such as 12 volts DC or even ˜3 volts DC.

Turning to FIG. 2, an embodiment of a solid state fluorescent replacement lighting system receiving power from both AC input and ballast output and with rectified EMI filtering is depicted in accordance with some embodiments of the invention. In this embodiment, a solid state fluorescent replacement lighting system derives power from ballast outputs 21, 25 through optional heater emulation circuits 22, 24 and rectifier 23. Power can also or alternatively be derived from an AC input 26 through rectifier 28, with one or more optional EMI filters and varistor(s) 27, 29. Power is converted in switch/storage circuit 30 to drive the solid state light(s) 31.

Turning to FIG. 3, an embodiment of a solid state fluorescent replacement lighting system receiving power from both AC input and ballast output and with rectified EMI filtering is depicted in accordance with some embodiments of the invention. In this embodiment, a solid state fluorescent replacement lighting system derives power from ballast outputs 41, 45 through optional heater emulation circuits 42, 44 and rectifier 43. Power can also or alternatively be derived from an AC input 46 through rectifier 48, with one or more optional EMI filters and varistor(s)/capacitors 47, 49. Power is converted in switch/storage circuit 50 to drive the solid state light(s) 51.

Turning to FIG. 4, an embodiment of a solid state fluorescent replacement lighting system receiving power from ballast outputs is depicted in accordance with some embodiments of the invention. In this embodiment, a solid state fluorescent replacement lighting system derives power from ballast outputs 55, 59 through optional heater emulation circuits 56, 58 and rectifier 57. Power is converted in switch/storage circuit 60 to drive the solid state light(s) 61. Power is also derived from the ballast outputs 55, 59 using power supply 62 to power loads 63 which can be, but which are not limited to, internal circuits in the solid state lighting system, sensors, etc.

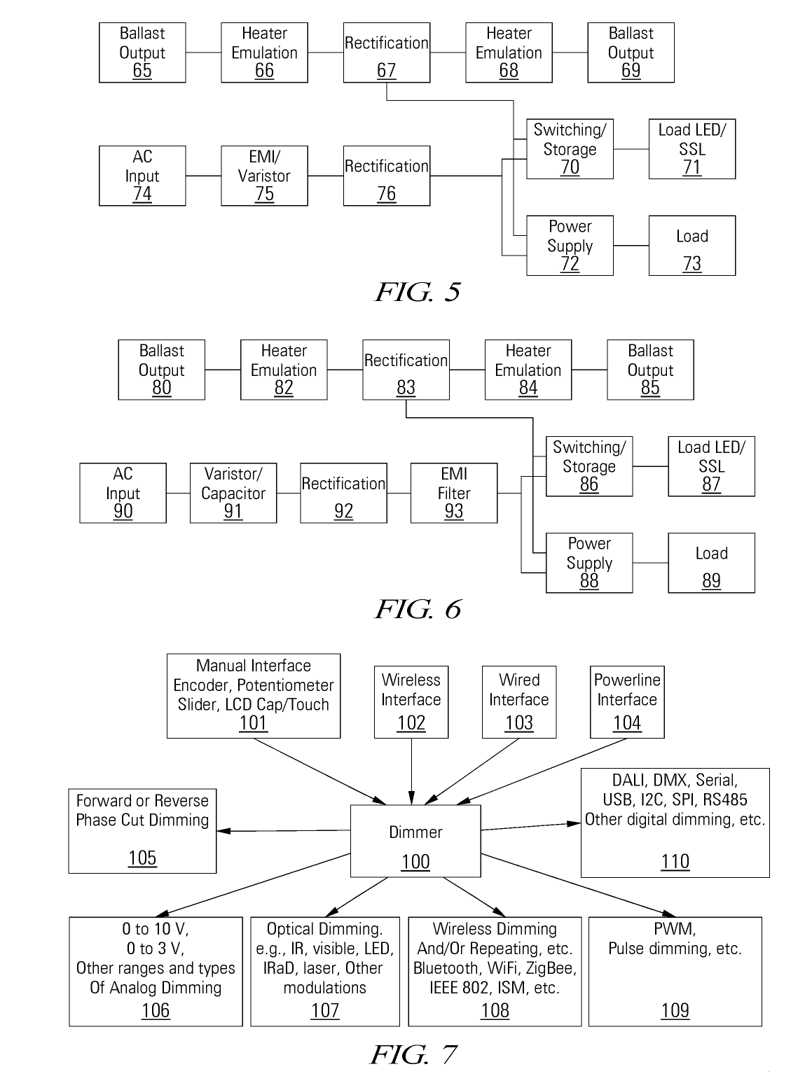

Turning to FIG. 5, an embodiment of a solid state fluorescent replacement lighting system receiving power from ballast outputs is depicted in accordance with some embodiments of the invention. In this embodiment, a solid state fluorescent replacement lighting system derives power from ballast outputs 65, 69 through optional heater emulation circuits 66, 68 and rectifier 67. Power can also or alternatively be derived from an AC input 74 through rectifier 76, with one or more optional EMI filters and varistor(s) 75. Power is converted in switch/storage circuit 70 to drive the solid state light(s) 71. Power is also generated in power supply 72 to power loads 73 which can be, but which are not limited to, internal circuits in the solid state lighting system, sensors, etc.

Turning to FIG. 6, an embodiment of a solid state fluorescent replacement lighting system receiving power from ballast outputs is depicted in accordance with some embodiments of the invention. In this embodiment, a solid state fluorescent replacement lighting system derives power from ballast outputs 80, 85 through optional heater emulation circuits 82, 84 and rectifier 83. Power can also or alternatively be derived from an AC input 90 through rectifier 92, with one or more optional EMI filters and varistor(s)/capacitors 91. Power is converted in switch/storage circuit 86 to drive the solid state light(s) 87. Power is also generated by power supply 88 to power loads 89 which can be, but which are not limited to, internal circuits in the solid state lighting system, sensors, internet of things sensors, detectors, devices, etc. including but not limited to those discussed herein such as motion, sound, light, temperature, etc., sensors, detectors, controllers, as well as communications devices including but not limited to wireless, wired, powerline, combinations of these, etc.

Embodiments of the on/off dimming implementations of the present invention can provide more than one way to turn on/off and/or dim including but not limited to 0 to 3 V, 0 to 10 V, 1 to 8 V, other voltage ranges, as well as providing forward or reverse phase cut dimming which can be selected including but not limited to manually, automatically, programmed, decision making, etc., powerline control in addition to one or more wireless (i.e., RF and/or optical, etc.) as well as other digital and/or analog interfaces, controls, etc. A non-limiting example of such a dimmer/switch is shown in FIG. 7. A dimmer circuit 100 can receive control signals from one or more of a variety of dimming interfaces, such as, but not limited to, manual interfaces 101, wired interfaces 102, wireless interfaces 103, powerline interfaces 104, etc., and can generate and send corresponding dimming commands or control signals to one or more fluorescent lamp replacements or other receivers by one or more of a variety of output interfaces, such as, but not limited to, forward or reverse phase cut dimming 105, 0 to 10 v, 0 to 3 v, other ranges and types of analog dimming 106, optical dimming e.g., IR, visible, LED, IrAD, laser, other modulations 107, wireless dimming and/or repeating, etc. Bluetooth, WiFi, 6LoWPAN, ZigBee, IEEE 802 including but not limited to 802.15.4, ISM, other IEE 80X etc. 108, PWM, pulse dimming, etc. 109, DALI, DMX, serial, USB, I2C, SPI, RS485, Power over Ethernet (POE), and other digital dimming, etc. 110 including but not limited to those discussed elsewhere in this document. The dimmer/switch can also use and/or be powered by POE and/or use the POE for communications.

The present invention can have one or more integrated motion sensors of any type or operation as part of the housing and can also use auxiliary motion sensors and can also have integrated light/photocell sensor as well as auxiliary sensors, power, transmitters, etc.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, including but not limited to, Bluetooth, RFID, WiFi, ZigBee, ZWave, LiFi, 6LoWPAN, Thread, IEEE 801, IEEE 802, ISM, etc. In addition the present invention can be connected to fire alarms, fire alarm, smoke detectors, thermostats, power management, home management and control, monitoring equipment, etc.

The present invention can use a BACnet or other network to wireless converter box or BACnet to Bluetooth including Bluetooth low energy (BLE) converter. The present invention can also use infrared signals to control and dim the lighting and other systems. In some configurations of the present invention, the system may use one or more WiFi networks to transmit the control and monitoring communications signals from one location to another and then use a WiFi to Bluetooth (such as a Bluetooth mesh) adapter to locally control/monitor the lighting. Some embodiments of the present invention also include BACNET to wireless adapters including but not limited to BACNET to WiFi and/or BACNET to Bluetooth and/or BACNET to other frequencies including RF frequencies including but not limited to communications within a building or buildings including but not limited to indoor and outdoor lighting, temperature, water, humidity, HVAC, sprinklers, pressure, light levels, motion, sequencing, switching, scenes, etc.

Embodiments and implementations of the present invention allow for optional add-ons including but not limited to wired, wireless or powerline control to be added later and interfaced to the present invention as well as allowing sensors such as daylight harvesting/photo/light/solar/motion/sound/ voice/voice recognition/etc. sensors, other sensors, technologies, techniques, detectors, etc. sensors as well as motion/PIR/proximity/other types of motion, distance, proximity, location, etc., sensors, detectors, technologies, etc., combinations of these, etc. to be used with the present invention.

Examples of adding smart control and monitoring include having wires or connectors that allow the connection of any or all of the sensors, detectors, techniques, technologies, etc. discussed herein.

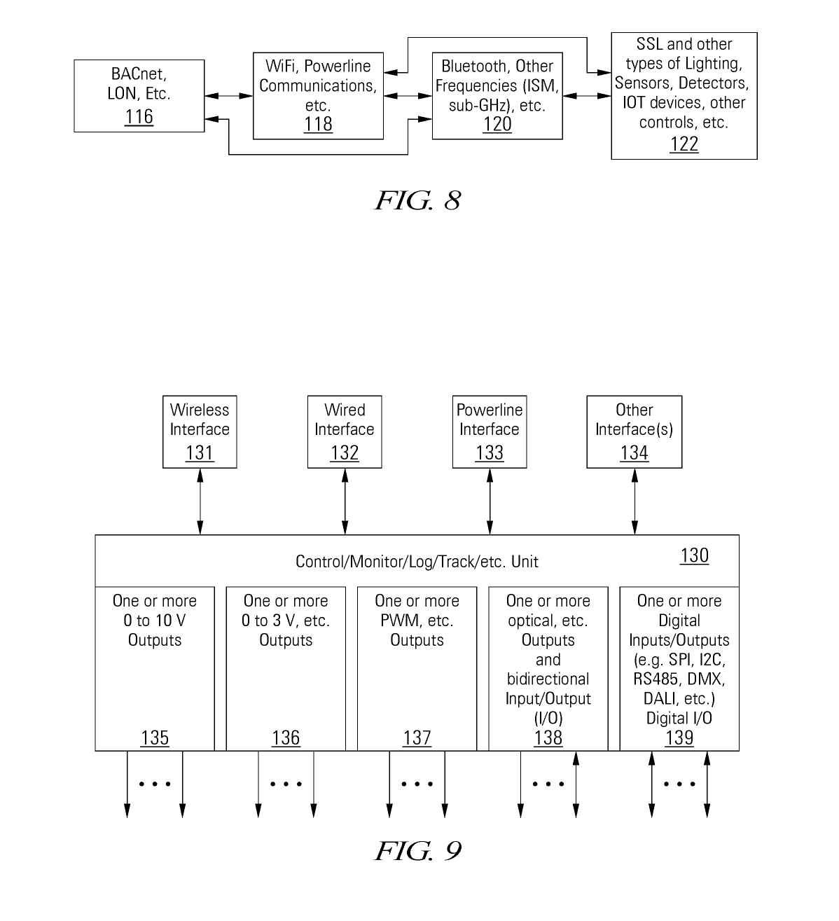

Turning to FIG. 8, an example embodiment of a solid state lighting system is depicted in which a solid state light 122 and/or other types of lighting, sensors, detectors, Internet of Things (IoT) devices, other controls, etc. are controlled by one or more or a BACnet or local operating network (LON) 116, WiFi and/or Powerline communications 118, Bluetooth or other wireless protocols 120, etc. Multiple communications networks or protocols can be used and linked as shown in FIG. 8, which should be viewed as merely non-limiting and non-exclusive examples. Connections between the example elements of the system (e.g., between WiFi 118 and SSL 122) are optional and can be omitted. Elements can be combined and provided in any suitable manner For example, SSL 122 can incorporate Bluetooth communications 120.

In some embodiments of the present invention, the lighting can be set/programmed including but not limited to active and/or dynamic processing and scene selection(s), programming, synchronizing, artificial intelligence, sequencing the lighting so that, for example but not limited to, the lighting being on, turned on/off, dimmed, etc. in certain ways, paths, etc. from less than one second to more than one hour. Such embodiments allow for special effects including the appearance that the light is following, leading, shadowing, tracking, anticipating, dimming up and down, etc., combinations of these, etc. the movement, direction, destination, or location, etc. that one or more people, living creatures, persons with permission, persons without permission, etc. may be heading to, going toward, etc. Such embodiments may use but are not limited to one or more motion sensing, radar, movement, vibration, sonar, ultrasonic, ultrasound, camera(s), vision recognition, pattern recognition, photocells, photo detector(s), electric eye(s), RFID, cell phone signals, smart phone signals, tablet signals, RF signal strength/detection including but not limited to Bluetooth, other 2.4 GHz, sub-GHz, ISM, WiFi, 6LoWPAN, ZWave, ZigBee, other types, protocols, frequencies, etc. discussed herein, including elsewhere in this document, etc., combinations of these, as well as other information including methods of identification, badge/sign-in entry, time of day, database information, web based information, signals, data, etc., day, date, weather, temperature, humidity, light level, solar/Sunlight level, gesturing, facial expressions, movements, ambient conditions, environment, track speed including but not limited to of a person or persons, etc., animal(s), other living creatures, animate or inanimate objects, etc. Such embodiments can make the speed of on/off and or dimming to whatever is desired, needed, required including from extremely fast to extremely slow including but not limited to fading in and out at any desired speed including different speed and time durations for fading on or off, respectively. Such embodiments may be used for any application or use including but not limited to indoor and/or outdoor applications including but not limited to hallways, rooms, meeting locations, conference rooms, conference centers, convention centers, sports events centers, parking lots, other outdoor uses, etc. to and from locations such as bathrooms, open or closed/covered parking lots and locations, street lighting, including but not limited to for pedestrians and vehicles, freeway and highway road and other lighting, signage lighting including but not limited to roadside and billboard lighting. Embodiments of the present invention can use the cloud and in general the Internet, to communicate to and from, to store information, to control and monitor devices and store, log, etc. information, settings, etc. that are part of the present invention, etc. and can include nodes, edge devices and routers, etc.

Embodiments of the present invention can have a wireless or wired device provide one or more and especially more than one 0 to 3 V and/or 0 to 10 V or other analog and/or digital signals including but not limited to simple and/or complex pulsing including simple to complex and sophisticated PWM. Such embodiments can control/monitor/log/store/analyze/perform analytics, etc. on more than just the lighting and can also be used to do different things including but not limited to heat, cool, light, protect, detect, etc. A non-limiting example of such an embodiment of the present invention is shown in FIG. 9, which can include one or more Control/Monitor/ Log/ Tracking circuits 130 that receives control input from any available source, such as, but not limited to, wired interfaces 131, wireless interfaces 132, powerline interfaces 133, and other interfaces 134. The Control/ Monitor/Log/Tracking circuits 130 can include microcontrollers/microprocessors or other control systems to gather the commands, gather and log information, and generate appropriate corresponding commands to one or more fluorescent lamp replacements through one or more interfaces, such as, but not limited to, one or more 10V outputs 135, one or more 3V outputs 136, one or more PWM, etc., outputs 137, one or more optical, etc. outputs and bidirectional Inputs/Outputs(I/0) 138, one or more digital inputs/outputs (e.g. SPI, I2C, RS485, DMX, DALI, others discussed elsewhere in this document, etc.) digital I/O 139, etc. Such implementations can provide analytics and Big Data and be used for more than lighting and include but are not limited to heating, cooling, HVAC, temperature, humidity, window coverings, entertainment, etc. as well as lighting including specialized lighting and general lighting. Embodiments of FIG. 9 can also use and be powered by Power Over Ethernet (POE).

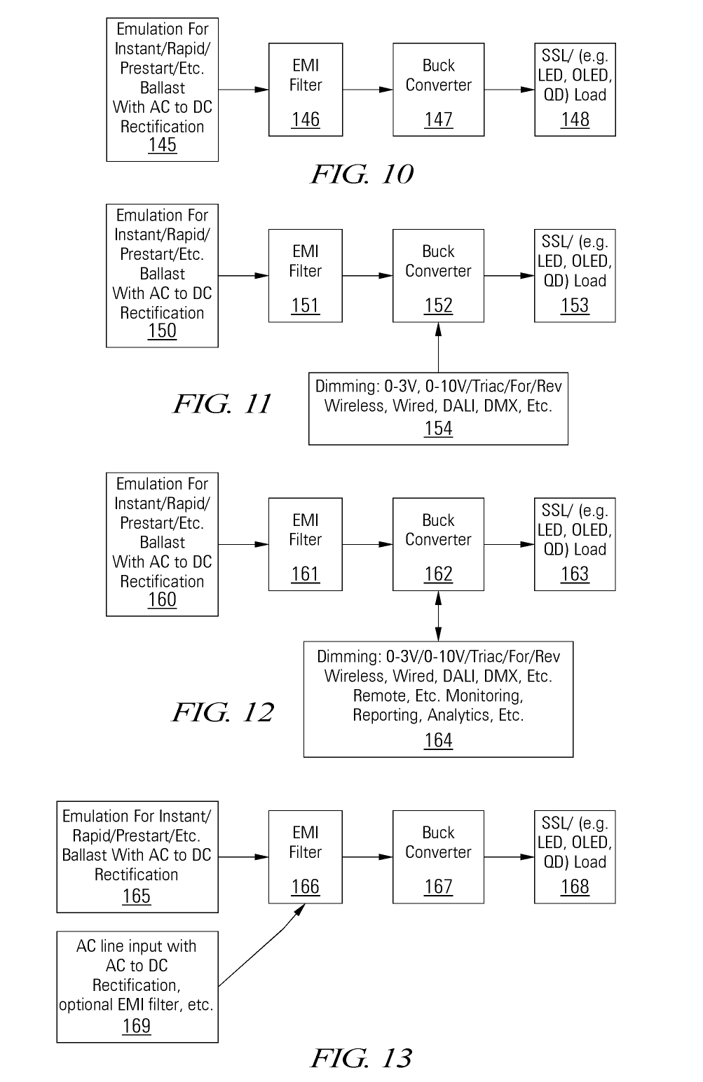

Turning to FIG. 10, a block diagram of a solid state lighting system is depicted that can be powered by both AC lines and ballast outputs, and that can be remotely controlled and dimmed in both modes. An emulation circuit 145 can be included to emulate a fluorescent or HID tube for instant/rapid/prestart ballasts to enable or assist the ballast to operate normally when the fluorescent or HID tube has been replaced, as well as to provide AC to DC rectification. An EMI filter 146 can be included to reduce EMI. A buck or other type of converter 147 converts the input power to the power signal required for the LED, OLED, QD and/or combinations of these and/or other loads 148. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit.

The buck converter can have OVP, OTP, OCP, shock hazard/pin safety protection, constant current, etc. Normally on (NO) and normally closed (NC) switches that are, for example single or double (or higher) and single (or higher) pole can be used.

The present invention can be used with AC line voltage including but not limited to 80 to 305 VAC 50/60 Hz, 347 VAC 50/60 Hz, 480 VAC 50/60 Hz other 50/60 Hz voltages, magnetic and electronic ballasts, low frequency and high frequency ballasts, instant start, rapid start, programmed start, program start, pre-start, warm, cold, hot types of ballasts, etc. In some embodiments a switch, including a mechanical, electromechanical, semiconductor, solid state, relay, etc., of any types and forms, etc., combinations, etc. can be used to connect and control power to the present invention.

Many embodiments and implementations of the present invention use the ballast itself to set the frequencies and time periods rather than using internally generated frequencies or periods. Some embodiments and implementations of the present invention use both the ballast generated signals and frequencies (and periods) and internally generated frequencies and periods as well as combinations of these, etc. Other embodiments and implementations may use internal signals, frequencies, periods, etc.

Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc.

Embodiments of the present invention can employ cost effective, energy efficient, fully controlled and protected electronics coupled with, for example, high quality, efficient color temperature controlled/maintained SSLs. Adaptive sensors and controls can communicate typically at low data rates with low data content to achieve energy usage reduction for the SSL FLR lighting products. Embodiments of the present invention can also be able to respond to voice commands. Smart phones and tablets can be connected in a number of ways with the implementations of the present invention to energy savings sensor systems including BACNET, LONNET, other building automation systems, Bluetooth, Bluetooth Low Energy (BLE) and other ways without or with the internet or IPs. The present invention also supports all forms and sorts of intentional brown outs, load shedding, peak power reduction, etc. including those with signals and information provided by the utility companies or other sources of the power including on-grid and off-grid power sources.

The power supplies/drivers for the present invention can include compatibility with essentially all or specific dimming protocols such as but not limited to triac/forward/reverse dimmers and all digital dimming protocols; and is compatible with ambient light sensors. The power supplies and drivers for SSL FLRs can convert relatively high frequency (typically 40 to 100 kHz) AC input to DC output power, and are able to support various types of remote control/dimming, provide over-current (OCP), over-voltage (OVP), over-temperature (OTP) and short circuit protection (SCP). Embodiments of the present invention can be ultra-efficient, highly flexible and allow SSL FLRs to support white light, white color tuning and, for example, optional features including color tunable red/green/blue (RGB), RGB and amber (RGBA), etc. modes of SSL operation.

Embodiments of the present invention, in addition to being ballast-compatible SSL direct replacement FLRs that work with electronic ballasts including but not limited to, instant-start, rapid-start, etc. ballasts, are also able to bypass the ballast and be plugged directly into the AC 50/60 Hz line voltage should, for example, the ballast fail. Therefore, in addition, to ballast AC input to DC output power, these embodiments also are able to directly work with 50/60 Hz and have a high power factor (PF) and low total harmonic distortion (THD), are also able to support various types of remote control/dimming, provide over-current (OCP), over-voltage (OVP), over-temperature (OTP) and short circuit protection (SCP).

Implementations of the present invention can be wirelessly dimmed and can support both manual and daylight harvesting controls, including optional standard 0 to 10 V, DALI, DMX, and other interoperable protocols and interfaces including, but not limited to, interfaces that support standards including Building Automation Control Network (BACnet) and can be designed to be interoperable with other building automation system (BAS) vendors, manufacturers, suppliers, etc. to enhance and further enable the adoption of LED luminaires and FLRs in building automation.

The controls allow multiple control systems manufactured by different vendors to work together, sharing information via a common Web, cloud, internet, local area network, or other-based interface, etc. combinations of these, etc.

Turning to FIG. 11, a block diagram of a solid state lighting system is depicted that can be powered by both AC lines and ballast outputs, and that can be remotely controlled and dimmed in both modes. An emulation circuit 150 can be included to emulate a fluorescent or HID tube for instant/rapid/prestart ballasts to enable or assist the ballast to operate normally when the fluorescent or HID tube has been replaced, as well as to provide AC to DC rectification. An EMI filter 151 can be included to reduce EMI. A buck or other type of converter 152 converts the input power to the power signal required for the LED, OLED, QD and/or combinations of these and/or other loads 153. Although a buck circuit can be used for power conversion, as an example, most any other type of switching circuit such as, but not limited to, a buck-boost, boost, boost-buck, Cuk, SEPIC, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 154 can be received and processed to control the current and/or voltage to the load 153, such as, but not limited to, optional wall (Triac), 0 to 3 VDC, 0 to 10 VDC, powerline (PLC), wireless, DMX, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, combinations of these, etc.

Turning to FIG. 12, a block diagram of a solid state lighting system is depicted that can be powered by both AC lines and ballast outputs, and that can be remotely controlled and dimmed in both modes. In some embodiments of the present invention, the power input can automatically switch to AC line when the ballast is deactivated, turned off, removed, not functioning, not operating, fails, etc. An emulation circuit 160 can be included to emulate a fluorescent or HID tube for instant/rapid/prestart ballasts to enable or assist the ballast to operate normally when the fluorescent or HID tube has been replaced, as well as to provide AC to DC rectification. An EMI filter 161 can be included to reduce EMI. A buck converter 162 converts the input power to the power signal required for the LED, OLED, QD and/or combinations of these and/or other loads 163. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 164 can be received and processed to control the current and/or voltage to the load 163, such as, but not limited to, optional wall (Triac), 0 to 3 VDC, 0 to 10 VDC, powerline (PLC), wireless, DMX, DALI, RS485, RS232, SPI, I2C, RS 422, UART, CAN bus, Ethernet, Profibus, Modbus, etc., other serial and parallel standards and interfaces and/or DALI dimming as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc., others discussed herein, etc. The control signal 164 can also support remote and/or local monitoring, reporting, analytics, etc.

Turning to FIG. 13, a block diagram of a solid state lighting system is depicted that can be powered by both AC lines and ballast outputs, and that can be remotely controlled and dimmed in both modes. An emulation circuit 165 can be included to emulate a fluorescent or HID tube for instant/rapid/prestart ballasts to enable or assist the ballast to operate normally when the fluorescent or HID tube has been replaced, as well as to provide AC to DC rectification. An EMI filter 166 can be included to reduce EMI. A buck converter 167 converts the input power to the power signal required for the LED, OLED, QD and/or combinations of these and/or other loads 168. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 169 with AC to DC rectification and optional EMI filter, etc. provides power to the solid state lighting system in the absence of a ballast in the fluorescent lamp fixture.

Notably, all embodiments of the solid state lighting system can be adapted for use with multiple power sources including, but not limited to, the output of a ballast in a fluorescent lamp fixture and an AC line which may be accessed in some embodiments through a fluorescent lamp fixture. The omission of any inventive feature of the solid state lighting system from an example embodiment disclosed herein or depicted in the Figures should not be interpreted as an indication that the embodiment cannot include the feature, or that the invention is limited to the specific depictions in the Figures. For example, embodiments depicted without AC line inputs can be configured to accept power both from an output of a ballast and from an AC line input as disclosed elsewhere herein. Again, the embodiments disclosed and depicted in the Figures are non-limiting examples intended to depict example features which can be combined in any number of fashions depending on the application and requirements.

Furthermore, embodiments in which smart fluorescent lamp replacements provide an isolated power output to remote sensors, communications, control, IOT devices in general via a control system with peripheral interface, can include lighting power supplies such as, but not limited to, buck or other converters, and of course the inverse is also true. Thus, any particular embodiment can include the isolated power generation, the solid state lighting power generation, dimming control, and other features disclosed herein, or any subset of them, in any combination. Embodiments of the solid state lighting systems can include buck converters as shown in the Figures, or buck-boost, boost, boost-buck, Cuk, SEPIC, quasiresonant, Flyback, forward converters, push-pull, current mode, voltage mode, etc. combinations of these, etc. In general, any type of switching/storage power supply can be adapted for use in the solid state lighting systems.

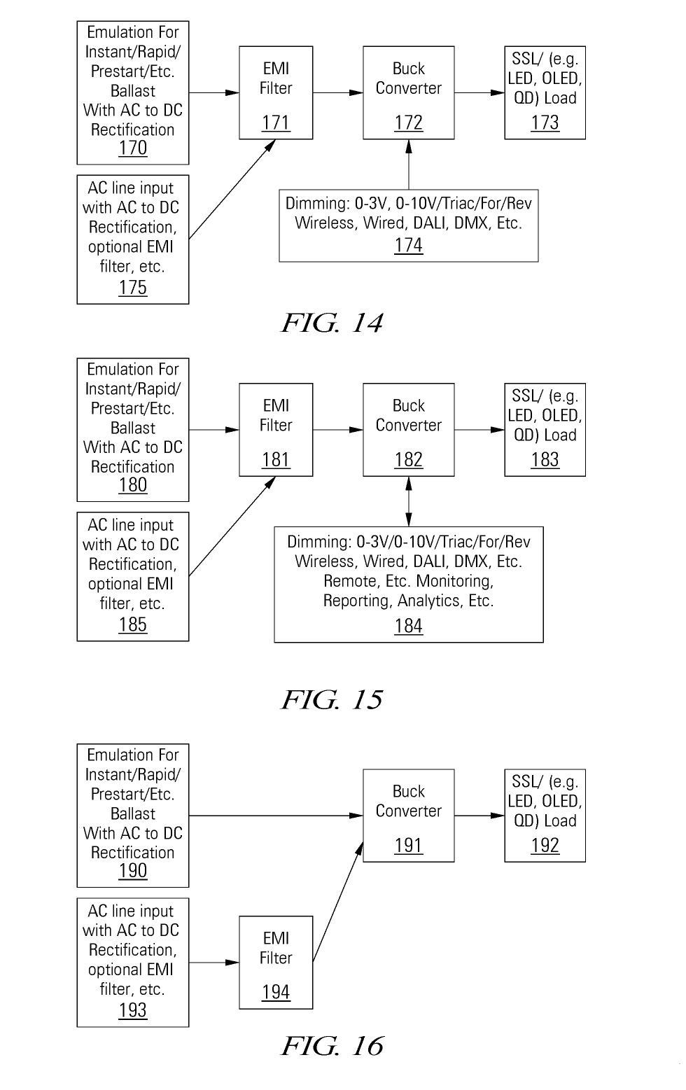

Turning to FIG. 14, a block diagram of a solid state lighting system is depicted that can be powered by both AC lines and ballast outputs, and that can be remotely controlled and dimmed in both modes. An emulation circuit 170 can be included to emulate a fluorescent or HID tube for instant/rapid/prestart ballasts to enable or assist the ballast to operate normally when the fluorescent or HID tube has been replaced, as well as to provide AC to DC rectification. An EMI filter 171 can be included to reduce EMI. A buck converter 172 converts the input power to the power signal required for the LED, OLED, QD and/or combinations of these and/or other loads 173. Although a buck circuit can be used for power conversion, as an example, most any other type of switching circuit such as, but not limited to, a buck-boost, boost, boost-buck, Cuk, SEPIC, quasi-resonant, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 174 can be received and processed to control the current and/or voltage to the load 173, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 175 with AC to DC rectification and optional EMI filter, etc. provides power to the solid state lighting system in the absence of a ballast in the fluorescent lamp fixture.

Turning to FIG. 15, a block diagram of a solid state lighting system is depicted that can be powered by both AC lines and ballast outputs, and that can be remotely controlled and dimmed in both modes. An emulation circuit 180 can be included to emulate a fluorescent or HID tube for instant/rapid/prestart ballasts to enable or assist the ballast to operate normally when the fluorescent or HID tube has been replaced, as well as to provide AC to DC rectification. An EMI filter 181 can be included to reduce EMI. A buck converter 182 converts the input power to the power signal required for the LED, OLED, QD and/or combinations of these and/or other loads 183. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 184 can be received and processed to control the current and/or voltage to the load 183, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 184 can also support remote and/or local monitoring, reporting, analytics, Big Data, etc. An AC line input 185 with AC to DC rectification and optional EMI filter, etc. provides power to the solid state lighting system in the absence of a ballast in the fluorescent lamp fixture.

Turning to FIG. 16, a block diagram of a solid state lighting system is depicted that can be powered by both AC lines and ballast outputs, and that can be remotely controlled and dimmed in both modes. An emulation circuit 190 can be included to emulate a fluorescent or HID tube for instant/rapid/prestart ballasts to enable or assist the ballast to operate normally when the fluorescent or HID tube has been replaced, as well as to provide AC to DC rectification. A buck converter 191 converts the input power to the power signal required for the LED, OLED, QD and/or combinations of these and/or other loads 192. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. An AC line input 193 with AC to DC rectification and optional EMI filter, etc. provides power to the solid state lighting system in the absence of a ballast in the fluorescent lamp fixture. An EMI filter 194 can be included to reduce EMI. An optional wired or wireless control can be used in some implementations.

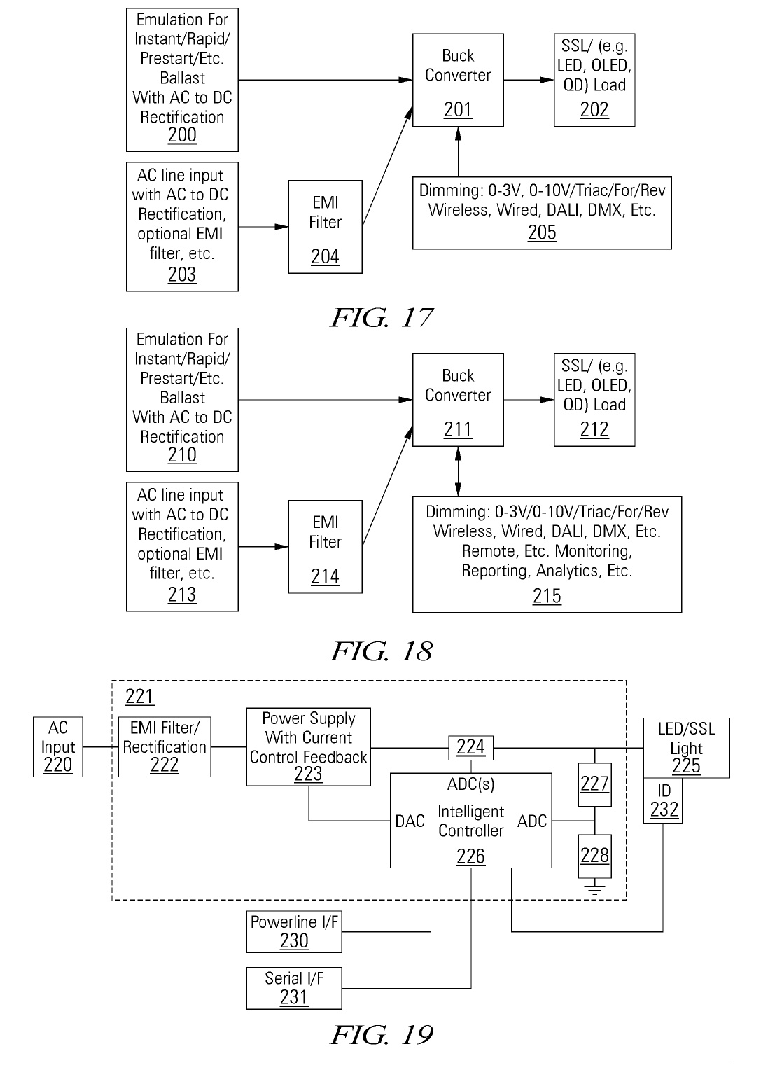

Turning to FIG. 17, a block diagram of a solid state lighting system is depicted that can be powered by both AC lines and ballast outputs, and that can be remotely controlled and dimmed in both modes. An emulation circuit 200 can be included to emulate a fluorescent or HID tube for instant/rapid/prestart ballasts to enable or assist the ballast to operate normally when the fluorescent or HID tube has been replaced, as well as to provide AC to DC rectification. A buck converter 201 converts the input power to the power signal required for the LED, OLED, QD and/or combinations of these and/or other loads 202. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 205 can be received and processed to control the current and/or voltage to the load 202, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. An AC line input 203 with AC to DC rectification and optional EMI filter, etc. provides power to the solid state lighting system in the absence of a ballast in the fluorescent lamp fixture. An EMI filter 204 can be included to reduce EMI.

Turning to FIG. 18, a block diagram of a solid state lighting system is depicted that can be powered by both AC lines and ballast outputs, and that can be remotely controlled and dimmed in both modes. An emulation circuit 210 can be included to emulate a fluorescent or HID tube for instant/rapid/prestart ballasts to enable or assist the ballast to operate normally when the fluorescent or HID tube has been replaced, as well as to provide AC to DC rectification. A buck converter 211 converts the input power to the power signal required for the LED, OLED, QD and/or combinations of these and/or other loads 212. Although a buck circuit can be used for power conversion, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc. discussed herein, etc. may be used in place of the buck circuit. Any type of dimming control signal 215 can be received and processed to control the current and/or voltage to the load 212, such as, but not limited to, optional wall (Triac), 0 to 3 VDC, 0 to 10 VDC, powerline (PLC), wireless, DMX, DALI, other analog and digital wired communications including but not limited to those discussed herein including but not limited to dimming and control and monitoring as well as one or more radio protocols including but not limited to 2.4 GHz ones such as Bluetooth, Bluetooth Low Energy, ZigBee, Zwave, WiFi, LiFi, Thread, 6LoWPAN, LoRa, Sub-GHz, including mesh, network, etc. The control signal 215 can also support remote and/or local monitoring, reporting, analytics, etc. An AC line input 213 with AC to DC rectification and optional EMI filter, etc. provides power to the solid state lighting system in the absence of a ballast in the fluorescent lamp fixture. An EMI filter 214 can be included to reduce EMI.

Lighting is becoming important as an integral part of many types of operations. Digitally addressable control of the lighting fixtures and associated circuits, for example, can be used to dim and/or turn the lights on and off depending on what is required or desired. Control of lighting can be a critical operations factor. The present invention includes smart lighting that provides control and dimming of lighting fixtures and associated circuits down to individual light/circuit level.

The present invention includes smart modules that are be able to recognize the lighting package configuration and what type of light fixture it is controlling through embedded firmware/software; this would allow lights of different functions and power requirements to, for example, be daisy chained, significantly reducing cable runs and installation costs.

Implementations of the present invention including smart modules, therefore, allow for the capability that, as lights are added to the system, the lights would self-configure and appear on the operator control panel in the correct lighting group. The proposed smart module solution would also eliminate the need for multiple configurations, set-up issues and complex and tedious troubleshooting while providing a simplified configuration that allows easy field replacement when a light is short circuited or not able to be turned on/off, dimmed, or flashed from the operator control panel. As a result, failures of any light would not affect the operation of any other light.

The present invention can address, but is not limited to, lighting fixtures that range from a single LED fixture to fixtures containing multiple LED strings (e.g., but not limited to 1-6 or higher) with different voltage (e.g., but not limited to˜less than 3 to greater than 120 VDC) and current (less than 20 mA to greater than 100 A) requirements.

The present invention also addresses the needs for reducing system cabling, minimizing system interconnections, etc. and can provide redundancy for fault tolerance, provides for on/off, flashing and dimming control of various lighting groups, configurations that can be incorporated into existing lighting fixtures or interconnection junction boxes while minimizing total system cost of ownership. The consolidated control of the total system can be of any form, type, approach, method, technology, protocol, interface(s), etc. including but not limited to those discussed herein, and, for example, over a mesh network including but not limited to a Bluetooth mesh or it could be over a local area network (LAN), WiFi, etc., combinations of these, etc.

Embodiments of the present invention can be isolated (galvanic) or non-isolated. Both the isolated and non-isolated embodiment of the present invention can be used for universal smart LED lighting including but not limited to with respective embedded firmware/software capable of having universal applications and are able to digitally control SSL including LED, OLED, QD, combinations of these, etc. A simple yet sophisticated wiring cable can be used for the present invention.

Embodiments of the present invention can include but are not limited to modular isolated forward or flyback converter and driver architecture and design including, for example, but not limited to, a buck (down) converter.

Embodiments of the present invention can provide extensive driver/power supply protection, safeguards and fault detection/redundancy/override detection/protection/response. For example, but not limited to, the power supplies and drivers for lighting (e.g., OLED, LED, CFL, CCFL) can be fully protected including protected against arcs, shorts, over voltage and over current, over power, etc. and can be either (or both) digital or analog controlled.

Embodiments of the present invention can provide for sophisticated, advanced, low-cost wired or powerline (or optionally wireless) control and monitoring and data and status/fault logging of each and every individual driver/power supply/module and LED lighting source including but not limited to extensive remote monitoring and control including auto/self-identification, configuring and commissioning and can also be used to monitor all key parameters including, but not limited to, input current, input voltage, inrush current, voltage spikes, power factor, true input power, Volt-Amp (VA) input power, output current, output voltage, output power, output voltage overshoot, output current overshoot, temperature at multiple locations, humidity (if desired), etc. Most of these parameters and especially the input parameters can be transmitted either as waveforms (e.g., amplitude vs. time) or as instantaneous or average data points.

Embodiments of the monitoring, interface and control can perform and permit self-configuration where the smart module will configure itself to the type of fixture and recognize how it fits into the configuration of one or more of a group or groups, mesh or meshes, system or systems, organization, room, home, building, office, suite, warehouse, etc., other types of buildings, housing, living space, hospitals, schools, etc., including but not limited to those discussed herein, combinations of these, etc. including for visible and infrared and other SSL including but not limited to LED lighting as well as, for example, essentially any indoor or outdoor application or use and also, for example, attempt to prevent SSL LED junction overheating SSL lighting while delivering maximum possible lifetime including under all conditions such as full on, flashing, maximum (deep) dimming The ‘self-configuring’ is an important aspect and feature for some embodiments of the present invention as well as thermal monitoring, control and management including both full and partial thermal interface and control systems that either completely turn off the LED at a prescribed temperature or gently reduce the power supplied to the LED once a specific temperature is reached with the power continually reduced to the LED until a maximum safe operation area (SOA) upper limit temperature is reached at which point the LED is fully turned off, respectively; of course all of these modes allow for ‘emergency’ overrides and in general, provide optimal protection while balancing all related trade-offs including providing maximum permissible light output for the SSL/LED lighting without fatally damaging or seriously degrading the SSL/LED source and being able to activate emergency override capability in case a situation, due to some unforeseen event or failure, occurs.

Embodiments of the present invention may use different materials, devices, thermal, mechanical and electrical parts, components, subsystems, etc. that may be incorporated into the digitally addressable and controlled power supplies and constant current and constant voltage drivers. Silicon carbide (SiC) or gallium nitride (GaN)-based semiconductor power devices including diodes and transistors may be used with the present invention to increase efficiency, switching frequencies and reliability while reducing size and mass and waste heat.

Some implementations of the present invention may use redundant circuits within a module or modules or redundancy in the modules so that if one circuit or module, respectively, fails, overheats, degrades, etc., the system can automatically switch over to the other circuit or module, respectively and can provide status and diagnostics including manual override of any automatic operation and remote reprogramming if deemed necessary. Implementations can include wired, wireless and powerline control and monitoring.

The present invention can use ‘self-configuration’, where the smart module will automatically self-configure itself to the type of fixture and be able to recognize how it fits into the configuration of the lighting in a room, in a building, in a ship, in an airplane, in a hotel, in a home, in a hospital, in a school, etc., any other type of building, facility, etc., in an outdoor setting, including but not limited to concerts, events, camping, mobile living, temporary living, field hospitals, military mobile units, others discussed herein, combinations of these, etc.

In the case of a power failure, there may be a short interruption, therefor implementations of the present invention can be designed to anticipate the possibility of a short interruption and not be negatively impacted, affected or impaired by such an interruption and could have, for example but not limited to, non-volatile memory to backup and maintain pertinent information including setup and self-configuration/identifying/addressing information, etc.

Any form, type, protocol, interface, etc. may be used for communications including, for example, but not limited to, RS485 and others discussed herein. Implementations of the present invention may use wiring redundancy and data redundancy.

Embodiments of the present invention can self-configure without user interaction. Some embodiments of the present invention may use an electronic identifier for each module or a physical connection to its neighbors to set, determine, ascertain, etc. such information as part of the automatic self-configuration. Dimming can be from 0% to 100% using, for example, but not limited to, pulse width modulation (PWM).

Implementations of the present invention include but are not limited to constant current source with adjustable current setting and adjustable compliance (i..e., maximum) voltage settings that support analog and digital dimming coupled with, for example, being dynamically adjustable and programmable. For example, a buck converter can be used to provide a constant output current to convert the input AC voltage down to a lower DC voltage at the desired constant current which can also be PWM digitally dimmed or optionally analog dimmed In general the AC to DC buck converter works equally well as a DC to DC buck converter. In other embodiments the buck converter can be replaced with other types of non-isolated converters such as boost, buck-boost, boost-buck, Cuk, etc. or an AC to AC or AC to DC isolation converter which, for example but is not limited to, could consist of one or more individual or power combined forward converters of any type but most likely a low noise, low EMI, current fed forward converter(s) or flyback converter(s).

Turning to FIG. 19, a solid state lighting system with intelligent controller is depicted, providing current control feedback based on a variety of sources, such as, but not limited to, one or more of an output current sensor, output voltage sensor, powerline interface, serial interface and/or other interfaces in accordance with some embodiments of the invention. In this embodiment power, for example but not limited to, 120 VAC to 480 VAC, 50/60 Hz power from an AC input 220 is fed directly to a module 221 and rectified and filtered DC current from EMI filter/rectifier 222. A power supply with current control feedback 223 (e.g., but not limited to a DC to DC buck converter) outputs a constant current power at the appropriate LED forward voltage to the SSL/LED load 225. An intelligent controller 226 can generate a feedback signal(s) for the power supply 223 from one or more sources, with optional and non-limiting examples shown in FIG. 19, including a current sensor 224 (e.g., a low impedance sense resistor and corresponding analog-to-digital converter or analog processing circuits), voltage sensor 227, 228 (e.g., a voltage divider and corresponding analog-to-digital converter), a powerline interface 230, serial interface 231 or other wired and/or wireless communications interface for receiving control commands and optionally transmitting status information. An ID circuit 232 or device associated with the SSL 225 enables the SSL 225 and associated module 221 to be uniquely controlled when grouped in a system with an array of SSLs and modules.

The intelligent controller 226 can contain a number of functional features and elements including but not limited to one or more digital to analog converters (DACs) with, for example but not limited to, at least one of the DACs providing a reference voltage for the buck converter 223 to use to set the output current to the SSL/LED light 225 or SSL/LED array light. Note that such a DAC current reference/set point can also be used to provide, for example, flashing or PWM digital dimming Analog to digital converters (ADCs) can be used to read a typically reduced (i.e., voltage divider) replica of LED forward voltage of the SSL/LED light which could be corrected for any wire/cable losses from the current output of the module. One or more optional photosensors (e.g., phototransistors) can be placed at an appropriate point(s) so as to not interfere with the SSL/LED lights and can effectively calibrated and used with the module to determine the real time efficacy (i.e., lumens/watt) of the SSL/LED light(s) and also flag any apparent degradation in the SSL/LED lighting.

As an example, two types of bidirectional communications between the module and central or distributed control include but are not limited to powerline communications (PLC) 230 to the AC lines (or optionally could be from a daisy-chained AC to AC or AC to DC and a serial connection 231 using low voltage and low current twisted pair wiring supporting one or more interfaces/protocols including but not limited to RS485, controller area network (CAN) bus, UARTs, SPI, I2C, etc. The ID circuit 232 is used to provide an ID type for the SSL/LED or SSL/LED array lamp. Such an ID can range from a simple analog identification such as a certain resistance value which corresponds to a particular LED lamp current and associated voltage to a simple integrated circuit (IC) or application specific IC (ASIC) that sends out an ID data byte or bytes when commanded to do so or a sophisticated code using discrete ICs and components or and ASIC. In other embodiments a low voltage, low current wire or wires can be used measure a resistor that is uniquely associated with a particular current and voltage LED light. In some embodiment of the present invention, a small IC or ASIC that contains an ID, calibration data, and could also measure and digitally transfer/transmit the current, voltage and power usage requirements of the SSL/LED or SSL/LED array light. Serial interfaces and UARTs as well as SPI, I2C, CAN Bus, Ethernet, etc. can be used. In some embodiments of the present invention, secure communications including cybersecure communications and related technologies, techniques, methods, methodologies, etc. can be used

Implementations of the present invention can also use only the power (DC current) lines to the SSL/LED elements or arrays and superimpose small AC signals that identify the particular light source.

Various embodiments of the present invention include some or all of the following features:
Direct and simple replacement for existing fluorescent tubes including T8 fluorescent tubes
Requires no special installation—installs directly to replace fluorescent tubes—no tools and no special skills required
Meets and passes all safety and regulatory agencies requirements
Provide constant lumens out regardless and virtually independent of the ballast make and model
Has full protection for the circuit, the LEDs and living creatures who come in contact with or install it.
Smart versions that save additional energy and last longer
Can work with daylighting, motion, proximity, light, sound, etc. sensors
Can work with existing motion and daylight harvesting sensors and systems
No retrofitting needed
No harmful or toxic materials
High quality and high reliability design, construction and implementation

Various embodiments of the solid state lighting systems disclosed herein provide smart/intelligent replacement solutions to fluorescent linear lamp tubes that are fully compatible with sensors and control hardware that are both inexpensive and easily integrated, incorporated, and/or used in conjunction with existing office, home and building infrastructure. The system replaces, for example, but not limited to, T4, T5, T8, T10 and T12 as well as other linear fluorescent lamps and/or HID lamps but does not require the ballast to be replaced or rewired—literally a direct drop-in replacement—and yet can be fully dimmed and controlled and monitored while using virtually any existing ballast including magnetic and electronic ballasts that (i.e., the existing installed ballasts), have no capabilities to dim or be controlled including responding to sensors/detectors.

Embodiments of the present invention reduce wire/cabling and associated costs, complications, and logistics and provide extensive driver/power supply protection, safeguards and fault detection/redundancy/ override detection/protection/response can include but are not limited to a robust maximum power measurement, management and monitoring for the module and related systems including for the LED drivers, power supplies, and related electronics.

Implementations of the present invention can include N+1 redundancy and possibly N+2 redundancy where N=1 for, for example, the buck)or other) converter of the module and N may be greater than 1 for other critical components used in the module including monitoring and logging pertinent data and parameters including input current, input voltage, inrush current, voltage spikes, power factor, true input power, Volt-Amp (VA) input power, output current, output voltage, output power, output voltage overshoot, output current overshoot, optional temperature at multiple locations, humidity (if desired), etc. Most of these parameters and especially the input parameters can be transmitted via the candidate communications interface as either waveforms (e.g., amplitude vs. time) or as instantaneous or average data points.

The control and monitoring interface and control strategies performs and permits ‘self-configuration’ where the smart module will configure itself to the type of fixture and recognize how it fits into the overall, local, and/or global, etc. configuration of, for example, but not limited to, the SSL/LED lighting as well as, for example, attempt to prevent SSL LED junction overheating of the SSL/LED lighting while delivering maximum possible lifetime including under all conditions such as full on, flashing, maximum (deep) dimming, short detection, short circuit protection, etc.

Implementations of the present invention can use various ‘IDer’ and addressing/self-configuration approaches including but not limited to those discussed herein. Some embodiments could employ RS485 or RS485 derivatives including Profibus and Modbus as well as other serial protocols/interfaces. Implementations of the present invention can have redundant circuits within a modules or redundancy in the modules so that if one circuit or module, respectively, fails, overheats, degrades, etc., the system can automatically switch over to the other circuit or module, respectively and can provide status and diagnostics including manual override of any automatic operation and remote reprogramming if deemed necessary. The redundant modules can be built in or be stackable and hot swappable.

As a non-limiting example, implementations of the present invention can use but are not limited to, 2 ft. and 4 ft. T8 and T12 linear fluorescent tube sockets and receive power directly from electronic and also magnetic ballasts (i.e., instant start, rapid start, programmed start) and also from AC 50/60 Hz 80 to 305 VAC, 347 VAC, 480 VAC, etc. It should be noted that these retrofit SSLs and SSL systems do not necessarily need to have the same form factor or footprint as the original light sources (i.e., the LED lights and luminaires can be very different from what they are replacing). Implementations of the present invention can, for example, but not limited to, use wireless (and also, depending on the facility design and intended application and use, wired) signals to both control (e.g., dim) the SSL/LED FLRs and monitor the respective SSL/LED current, voltage and power. For example, a set of low cost, low power sensors allow for relative light output to be measured and wirelessly reported, monitored, and logged permitting analytics to be performed. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost/simplicity or Bluetooth, Bluetooth low energy (BLE or BTLE), ZigBee, ZWave, IEEE 802, WiFi, etc., and can be secure/encrypted. Occupancy/motion sensors, photo sensors, noise, proximity, ultrasonic, other sound, vision recognition, pattern recognition, voice recognition, other types of recognition(s), etc., other types of sensors and detectors discussed herein, etc., daylight harvesting controls, simple and low cost interfaces that allow existing or other brands, makes, and models of daylight harvesting controls, photo sensors, occupancy/motion sensors to be connected to and control/dim the wireless SSL/LED FLRs and other implementation of the SSL/LED lighting present invention.

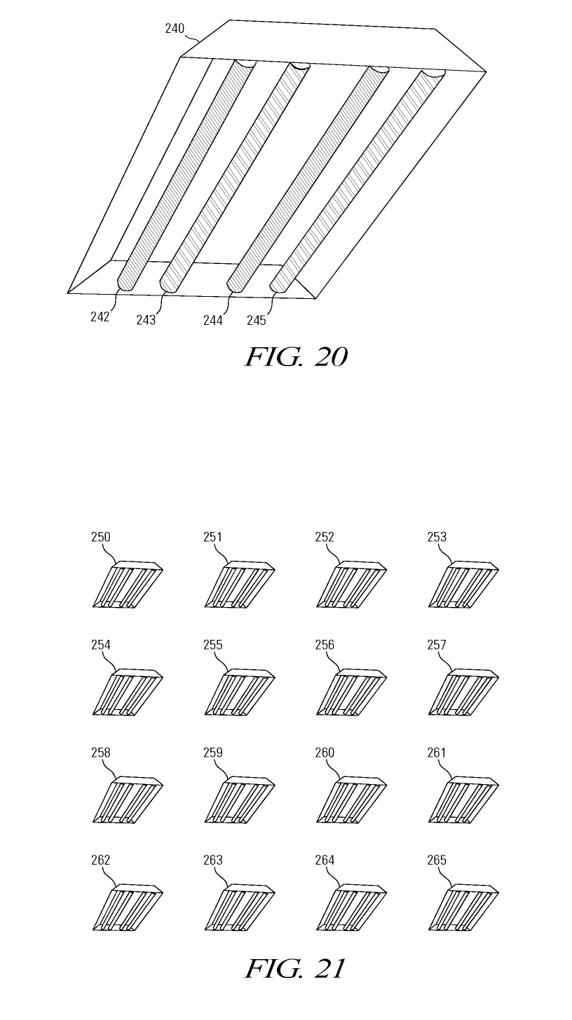

Turning to FIG. 20, a wireless controlled solid state lighting system 240 includes a number of LED fluorescent lamp replacements (FLRs) 242, 243, 244, 245 in a fluorescent lamp fixture 240. In some embodiments, the FLRs can include multiple different color temperature lamp types (which is merely one of a more conventional example of innovative and novel SSL/LED lighting) where there are one or more of at least two different color temperatures (e.g., cool and warm white) is depicted in accordance with some embodiments of the invention. In this embodiment, for example, two fluorescent lamp replacements 242, 244 have a first color temperature and two other fluorescent lamp replacements 243, 245 have a first color temperature. Of course, the form factor, the number of different color temperatures, etc., are merely non-limiting examples. Other embodiments of the present invention can have more than one color temperature and/or color inside of the fluorescent lamp replacement (FLR). Other form factors, implementations, etc. including but not limited to having both cool and warm LEDs in the same wireless controlled FLR as well as novel form factors can be employed in implementations of the present invention. As also discussed herein, embodiments and implementations of the present invention can also include one or more SSLs/LEDs with different color temperatures as well as one or more colors or LEDs including but not limited to red, green, blue (RGB), red, green, blue, amber (RGBA), other colors, wavelengths, etc. of SSLs/LEDs, etc. A capacitor can be put across the two power legs of the ballast output through, for example, the tombstones that carry the current to drive the SSL (e.g., LED and/or OLED, QD) fluorescent lamp replacement to effectively reduce the maximum voltage including the open circuit voltage of the ballast.

In some embodiments a switch, including a mechanical, electromechanical, semiconductor, solid state, relay, etc., of any types and forms, etc., combinations, etc. can be used to connect and control power to the present invention.

With, for example but not limited to, a diffuser the effective color can be varied from completely cool white to completely warm white with intermediate color blended combinations of cool and warm white in between. The diffuser or diffusers can essentially be of virtually any type, form, design, etc. This can be accomplished, for example but not limited to by dimming one or both the different color temperature smart and/or smart enabled FLRs. The simplistic rendering shows alternating cool and warm white lighting where the coloring has been exaggerated for clarity of presentation. Note, other form factors, implementations, etc. including but not limited to having both cool and warm LEDs in the same wireless controlled FLR as well as novel form factors can be employed in implementations of the present invention. As also discussed herein, embodiments and implementations of the present invention can also include one or more SSLs/LEDs with different color temperatures as well as one or more colors or LEDs including but not limited to red, green, blue (RGB), red, green, blue, amber (RGBA), whiteRGBA, multiple color temperatures of whiteRGB and multiple colors of whiteRGB, etc. other colors, wavelengths, etc. of SSLs/LEDs, etc. A capacitor can be put across the two legs of the ballast through, for example, the tombstones that carry the current to drive the SSL (e.g., LED and/or OLED, QD) fluorescent lamp replacement to effectively reduce the maximum voltage including the open circuit voltage of the ballast.

Some embodiments of the present invention allow for solid state lighting in fixtures with more than one lamp or socket, allowing for one or more of the fluorescent lamp replacements to be completely turned or dimmed off while permitting one or more of the remaining lamps to be on at dimming levels from zero to one hundred percent. This allows for any combination of color combination tuning and mixing, and color tuning and mixing.

Embodiments of the present invention including but not limited to those depicted in the Figs. can include but are not limited to various implementations of proximity sensors including passive or active or both, IR-based proximity detectors, capacitance-based proximity sensors, other types of proximity sensors, etc., as well as voice commands and can be used to turn on, turn off, dim, flash or change colors including doing so in response to an emergency situation.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

Turning to FIG. 21, an array/group of FLRs 250-265 in a solid state lighting system is depicted in accordance with some embodiments of the invention. In some embodiments, each of the FLRs 250-265 is provided with a unique identifier or address, whether hard-wired, set using switches, programming, set during manufacturing and/or testing, ‘burned in’ permanently at time of manufacture or assembly, etc. or in any other suitable manner During provisioning or installation, each of the FLRs 250-265 can be added to or associated with a control system. For example, in some embodiments each of the FLRs 250-265 is made to turn on or blink or flash or change color, using a command to its unique identifier or address, enabling the installer or administrator to identify that FLR in a control system or user interface. In some other embodiments, a bar code or QR code or other identifier can be applied to each FLR, enabling an installer to scan the identifiers when adding the FLR to the control system. During configuration, FLRs can be grouped into zones or subsets of lights so that lighting control, sensor input, and/or control algorithms can be applied to groups of the FLRs. For example, the user interface might be configured such that some of the FLRs are identified as being in a public space while others are in a private space, enabling the system to detect unauthorized entry of persons into private spaces. Schedule- or time-based control can also be applied to the FLRs, either or both individually or in groups. For example, arrays of FLRs deployed in a public, commercial, industrial etc. setting can be configured so that during normal hours when persons are authorized to be in the area, sensors in or associated with the FLRs can be used for configuring light output or color, and that after normal hours when the public is not authorized to be in the area, sensors in or associated with the FLRs can be used for detecting and/or tracking and/or reporting unauthorized entry or movement. Tracking of motion across multiple sensors can be used in some embodiments to distinguish actual unauthorized entry from a single sensor glitch or other anomaly, such as a falling object or, for example, a small moving object in the close field of view of, for example but not limited to, one sensor such as an insect, spider, small rodent, etc. These types of events can be distinguished by other means including but not limited to pattern recognition, visual recognition and identification, etc., combinations of these, etc.

Motions (sensors) can be used to control lights, report occupancy, vacancy, hot spot (heat maps) and also set (e.g., security protection mode) to report intruders including turning or not turning the lights on, tracking movements, paths, etc., strobe the lights, flash or strobe other lights, auxiliary lights, etc. report events, movements, activate cameras, text, e-mail, phone, contact building owners, occupants, police, private security, fire departments, etc. Some embodiments of the invention can work with APPs and smartphones, tablets, laptop computers, desktop computers, Cloud, servers, mobile carrier modems, etc.

Tracking and identification from cellphones and other devices can be monitored or accessed by sensors in lighting systems and other interfaces. Such identification information can be monitored, reported, stored, etc. For example, such information can be retrieved by sensors in public places such as a university or school, and can be tracked for safety purposes. Such functionality can be included, for example, in motion sensing lights that can detect who has passed nearby based on their cellphone ID or other means.

Some embodiments of the invention use bar codes (and bar code readers) or Quick Response (QR) codes that can be scanned with code scanner, cellphones/tablets, etc. to read in the ID/Address/Name/etc. of each smart/intelligent lamp, dimmer, light, etc. so as to assign each to its proper place.

In some embodiments, voice commands are used to identify lights during provisioning or configuration of the solid state lighting system. A non-limiting example process of such an identification process is as follows: Speak Word Command(s)→Word Recognition→Word Parsing and Identification→Process Command→Perform Function→Wait for Next Command. Voice commands can be received by a sensor at a control circuit or by one or more microphones positioned at one or more locations, including in some embodiments in FLRs. Voice commands can also be used in some embodiments to control lights or lighting levels, for example with voice commands such as Light, dim level 3; Light, white dim level 7; Light, blue dim level 8.

Some embodiments of the present invention can use proximity and signal strength of Cellular phone, smart phone, tablet, RFID tag, etc. to turn on the lights if it recognizes the phone as someone walks past the smart dimmer switch with a known ID such as a known Bluetooth previously joined/connected phone. Such a turning on can be to a particular light intensity/dimming level and a particular color temperature. If an unknown ID, for example but not limited to, a Bluetooth ID passes by, the smart dimmer could do one of many things including but not limited to, flashing the lights on and off, alerting including alerting by one or more of alarm, e-mail, text message, web alert, sending photos, flashing the lights one or more color or color temperatures, making audible sounds, setting off alarms, including but not limited to audible alarms, silent alarms, sirens, etc., combinations of these, etc. or turning on the lights to a prescribed value and color temperature or color, etc.

Some embodiments of the present invention can have permission levels and priorities, etc. to distinguish between levels of users and also for the master user/controller to assign the levels of use including event based decisions and conflict overrides, etc.

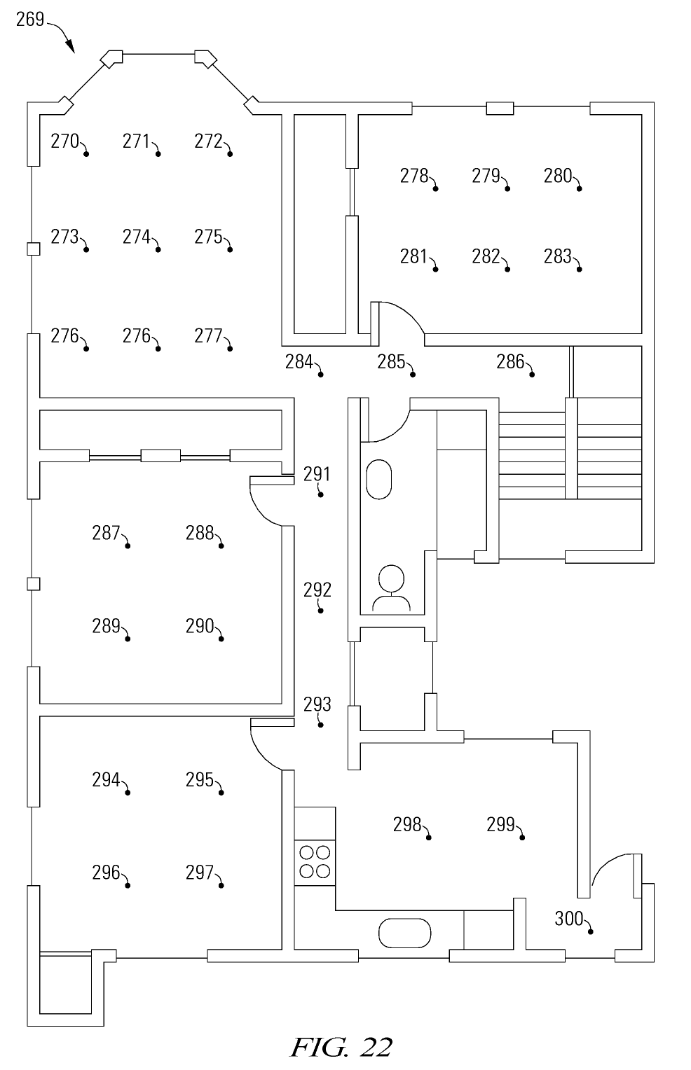

Turning to FIG. 22, an array of wirelessly controlled solid state lighting system/LED fluorescent lamp replacements/sensors 270-300 is depicted which can identify and track occupants to provide services such as, but not limited to, lighting, security and other controls in accordance with some embodiments of the invention. An array of sensors can be provided in solid state fluorescent lamp replacements or as external sensors or both, and in some embodiments are powered by power supplies that draw power from fluorescent lamp fixtures, either drawing current from ballasts or AC lines or any other suitable source, or by combinations thereof. Any type of sensor can be used, or combinations of sensor types, that can detect when a person or other moving object is within range of the sensors. In the example shown in FIG. 22, the array of SSL's/sensors is dispersed throughout a residence such as a private home 269, but such sensor arrays can be used in any building or outdoor space or combinations thereof. As motion is detected, lights, heating and cooling, and other systems can be controlled, powered on and off, dimmed, adjusted, etc. based on the detected presence. In some embodiments, security functions are also provided, for example providing authentication and authorization functions for a person carrying a registered smart phone within sensor range. In such cases, customized actions can be performed for authorized persons, such as controlling the light levels, light colors, audio and sound system control, etc., as preprogrammed or intelligently learned for the person, and can also be customized based on time of day, day of the week, ambient light conditions, temperature, schedules programmed for the person, etc. Actions can also be performed for unauthorized entry or presences as well, such as, but not limited to, alerting authorities, flashing lights, triggering sirens, coloring the lights, etc. Such systems can also be used in commercial, manufacturing, industrial settings as well, for example controlling lighting for shoppers, receiving voice inquiries or voice commands, monitoring persons transitioning from public spaces into unauthorized or private areas, etc.

The SSL's/sensors/detectors/controllers/transducers (e.g., sirens, microphones, speakers, etc.) etc. can be connected using any suitable communications networks or combinations of networks to form a hybrid network, such as with combinations of WiFi, Bluetooth, ISM, other radio frequencies, etc. such that the lighting is able to communicate via such a hybrid network.

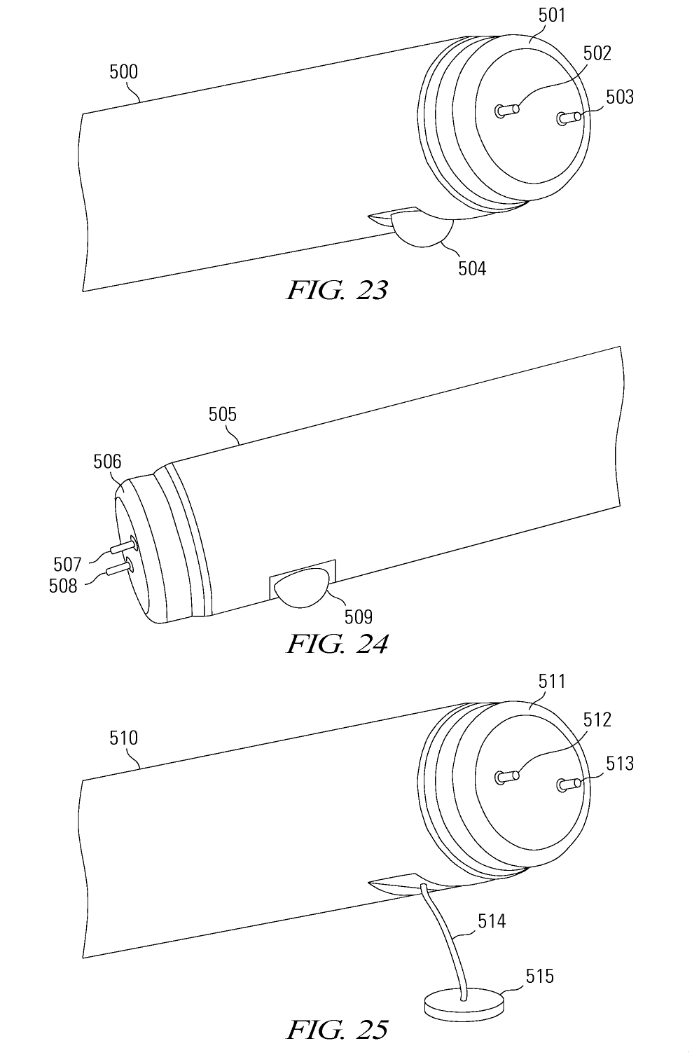

Turning to FIG. 23, an example of a self-contained solid-state fluorescent tube replacement 500 with motion and optionally other sensors 504 is depicted in accordance with some embodiments of the invention. A tube replacement 500 can have any form factor to replace a fluorescent or HID lamp and can include power sources, converter circuits, heater emulation circuits, feedback circuits, dimming circuits, user interface circuits, sensor control and integration circuits, LED and/or other light sources, etc. Sensor(s) (e.g., 504, 509) of any number and type can be directly integrated into the tube replacements 500, 505 at ends near end caps 501, 506 or at any other location, such as motion sensors, light sensors, temperature sensors, combination sensors, IOT interfaces, IR receivers and/or transmitters to interface with and/or control other devices, cameras, photosensors, light sensors, ambient light sensors, color sensors, RGB sensors, RGB clear sensors, RGBA sensors, RGBWhite with one or more white sensors, full spectrum sensors, temperature sensors, humidity sensors, air quality sensors, RF sensors, ultrasonics, motion, gesture, pattern recognition sensors, voice recognition, face recognition, cameras including but not limited to surveillance cameras, infrared sensors, heat sensors, smoke sensors, carbon monoxide sensors, carbon dioxide sensors, gas sensors, density sensors, occupancy sensors, vacancy sensors, etc., combinations of these, etc. The sensors can include multiple sensors of one type or of multiple types. Bi-pins 502, 503, 507, 508 can be provided as needed to connect to the tombstone fixture or other lamp fixture interfaces.

As shown in FIG. 25, in some embodiments of a fluorescent or HID tube replacement 510 can include wired connections 514 to power and/or interface with external sensors 515 or other devices or control, enabling the fluorescent or HID tube replacement 510 to create a smart home or smart building environment that can be easily installed and easily transferred or moved to another facility. This also enables the fluorescent or HID tube replacement 510 to be used to power external devices, greatly simplifying installation and configuration and provisioning of a smart building environment. Sensor(s) (e.g., 515) of any number and type can be directly integrated into the tube replacements 510 at ends near end caps 511 or at any other location, such as motion sensors, light sensors, temperature sensors, combination sensors, IOT interfaces, IR receivers and/or transmitters to interface with and/or control other devices, cameras, photosensors, etc., other sensors discussed herein or elsewhere, sensors, detectors, control in general, wired, wireless, powerline, etc. communications, combinations of these, etc. Bi-pins 512, 513 can be provided as needed to connect to the tombstone fixture or other lamp fixture interfaces.

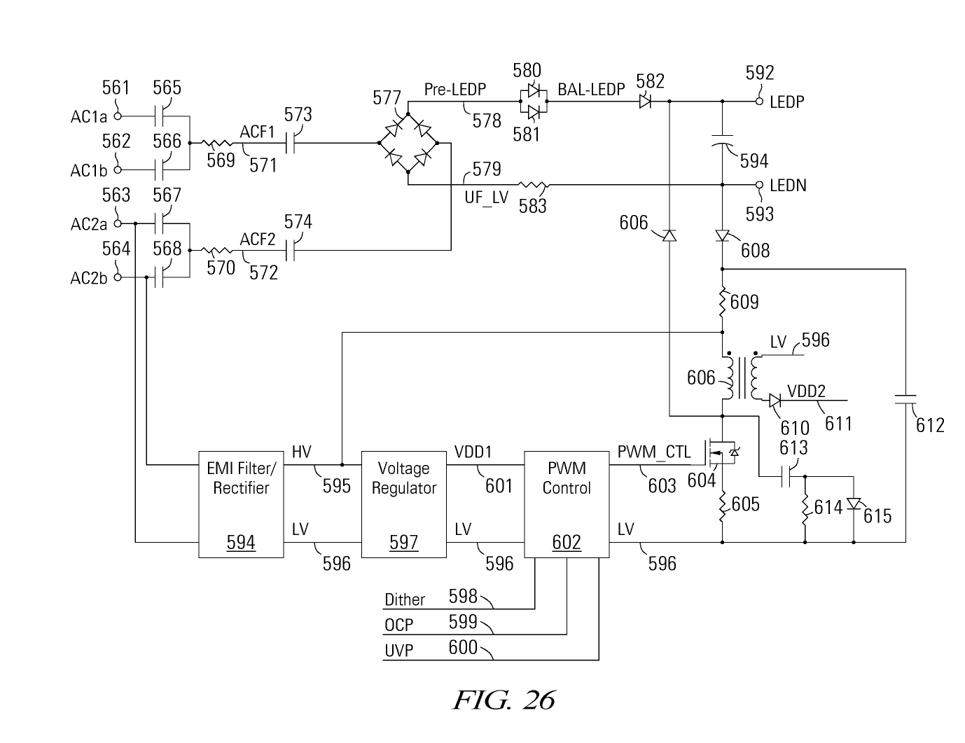

Turning to FIG. 26, a solid state lighting power supply is depicted that can draw power from a fluorescent lamp fixture in accordance with some embodiments of the invention, wherein ballasted power can be drawn from bi-pins 561, 562, 563, 564 at both ends of the lamp fixture when a fluorescent ballast is installed in the fixture, or AC power can be drawn from bi-pins 563, 564 just one end of the lamp fixture when the fluorescent ballast is not installed or has been removed from the fixture. The solid state lighting power supply can be used with all types of ballasts including electronic rapid start, instant start, programmed start, preheat, magnetic, etc. that can be remote controlled and monitored and also has remote control/dimming In some embodiments of the present invention, some of the capacitors may be replaced, for example, but not limited to, with shorts and/or resistors.

When an electronic ballast is installed and functioning in the fluorescent lamp fixture, high frequency current flows between the bi-pins 561, 562 at one end of the lamp fixture and the bi-pins 563, 564 at the other end of the lamp fixture, and the solid state lighting power supply draws from this power to power a load connected to output nodes LEDP 592, LEDN 593. In ballast-powered operation, power is drawn through AC coupling capacitors 565, 566, 567, 568 and resistors 569, 570, which can be included along with, if desired, any other heater emulation or other input conditioning elements in any configuration to enable the ballast to function normally. Some or all of these capacitors may be optional in some embodiments of the present invention. For example, one or more resistors can each be connected in parallel with each of the input coupling capacitors 565, 566, 567, 568. One or more rectifiers 577 can be included, as well as signal conditioning components and/or EMI components which can be included as desired, such as, but not limited to, diodes 580, 581, 582, capacitors 584, as well as sensing components such as current sensing resistor(s) (e.g., 583) that can be used, for example, to sense the current through the output nodes LEDP 592, LEDN 593 which supply current to a solid state lighting load.

When the ballast is not installed in the fluorescent lamp fixture, AC line power is drawn from the pair of bi-pins 563, 564 at one end of the lamp fixture. An EMI filter/rectifier 594 filters and rectifies the input power to yield a rectified AC signal HV 595, which is at or near the line voltage and is therefore referred to herein as a high voltage signal in comparison with lower DC voltages (e.g., 15 VDC, 5 VDC, 3 VDC, etc.) that can be generated in the solid state lighting power supply to power circuits in the solid state lighting power supply or any other desired load including but not limited to sensors, IOT, controls, communications, etc. including but not limited to those discussed herein, combinations of these, etc.

A voltage regulator 597 regulates the rectified AC signal HV 595 to yield a lower voltage DC signal VDD1 601, used to power at least a pulse width modulation control circuit 602. The voltage regulator 597 can be a linear regulator or can comprise a buck converter circuit or, in other embodiments, as an example, most any other type of switching circuit such as, but not limited to, a buck-boost, boost, boost-buck, flyback, forward converter of any type including but not limited to resonant, push pull, half bridge, full bridge, current-mode, voltage-mode, current-fed, voltage-fed, etc. or any other type of switching circuit, converter, etc.

In some embodiments, a dither signal 598, over-current protection 599, under-voltage protection 600, or any other control and protection signals and circuits can be used with the PWM control or other type of pulse control 602, including but not limited to over-temperature protection, over-voltage protection, etc.

The pulse width modulation control circuit 602 generates a pulse width modulated control signal PWM_CTL 603 to control the current drawn from the rectified AC signal HV 595 and supplied to the output nodes LEDP 592, LEDN 593 in AC power mode. The pulse width modulated control signal PWM_CTL 603 controls a switch 604 which passes or blocks current between the rectified AC signal HV 595 and return signal LV 596 through the switch 604, a current sensing resistor 605 and an inductor 606 or transformer. The AC supply side is coupled to the output nodes LEDP 592, LEDN 593 by diodes 606, 608 and capacitor 612. In AC power mode, when the switch 604 is closed, current flows from the rectified AC signal HV 595, through inductor 606, diode 606 to output node LEDP 592, returning from output node LEDN 593, through diode 608, and capacitor 612. When the switch 604 is opened to control the average load current, power stored in inductor 606 flows through diode 606 to output node LEDP 592, returning from output node LEDN 593, through diode 608 and current sense resistor 609. Such a switching or storage circuit depicted in FIG. 8 can be, for example but not limited to a buck, buck-boost, boost-buck, boost, flyback, forward converter, SEPIC, Cuk, etc.

In some embodiments, power can be obtained through a tagalong winding on inductor 606 for other purposes, yielding power signal VDD2 611 through diode 610 which can be used for any purpose.

Dimming control can be applied to the pulse width modulation control circuit 602 in any suitable manner to modify or control the pulse width of the pulse width modulated control signal PWM_CTL 603 from the pulse width modulation control circuit.

In some embodiments of the present invention, snubber and/or clamp circuits (e.g., including but not limited to capacitor 613, resistor 614 and diode 615) may be used with the rectification stages (which, for example, could be diodes or transistors operating in a synchronous mode) or elsewhere as shown; such snubbers could typically include capacitors, resistors and/or diodes or be of a lossless type of snubber where the energy is recycled or be made of capacitors only or resistors only, etc. Such snubbers can be of benefit in reducing radiated emissions and limiting the voltages seen by switching elements. Some embodiments of the present invention can use lossless snubbers.

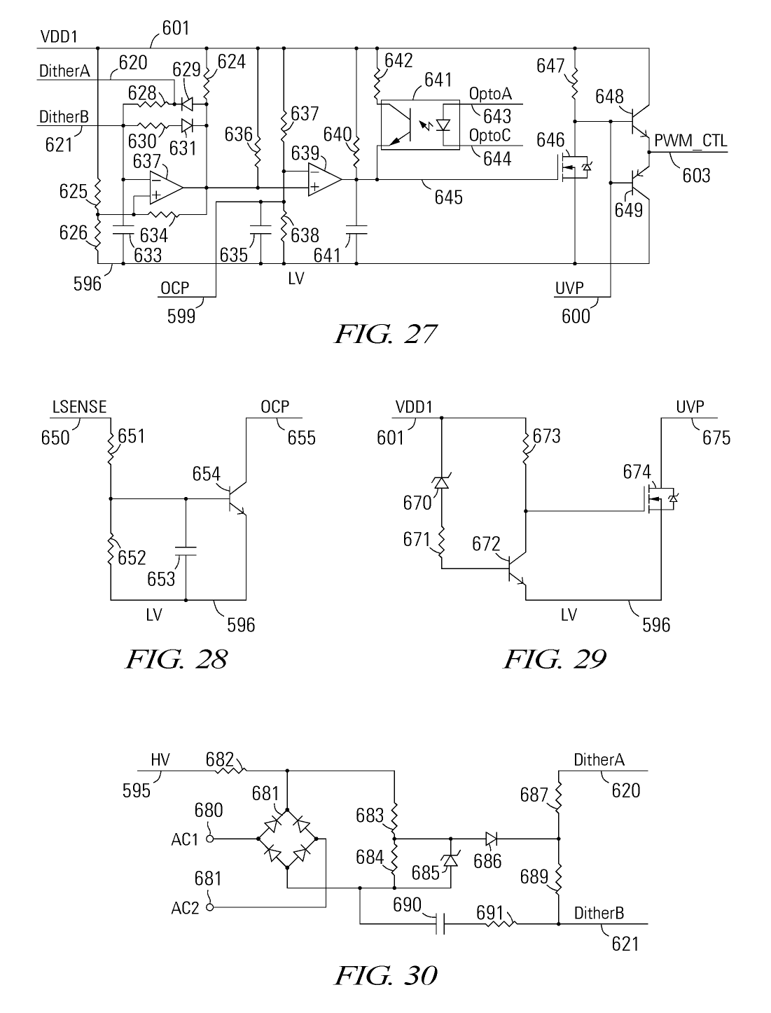

Turning to FIG. 27, a power conversion stage circuit is depicted in accordance with some embodiments of the invention which can be used in place of the voltage regulator 597. The power conversion stage circuit includes a voltage ramp circuit including op-amp or comparator 247, diodes 629, 631, resistors 624, 625, 626, 628, 630, 634, 636 and capacitor 633 that generates a ramp signal at the non-inverting input of op-amp 639. Op-amp 639 compares the ramp signal against a reference voltage, which can be generated from VDD1 601 by resistors 637, 638 and capacitor 635, yielding a pulse width modulated signal 645. The pulse width modulated signal 645 can be buffered by transistors 646, 648, 649 and resistor 647 to yield pulse width modulated control signal PWM_CTL 603. Devices and components including but not limited to diodes including but not limited to Zener or equivalent diodes may be added to enhance system or other performance and/or ballast compatibility as shown in FIG. 27. FIG. 27 is intended to be a non-limiting example and is illustrative of the present invention. Any such circuit or circuits including ones in an integrated circuit form that performs a similar or the same function as shown in FIG. 27 can be used as part of the present invention.

Dithering can be applied in the power conversion stage circuit, for example at nodes DitherA 620 and DitherB 621. Dithering of, for example, but not limited to, frequency, duty cycle, width, etc. may be used with the example embodiments shown herein and in general for the present invention to, for example, provide EMI dithering and reduction. The example dithering is not intended to be limiting in any way or form and is merely provided as a non-limiting example.

Other protection circuits can be used to control the power conversion stage circuit, for example by applying an overcurrent protection signal 599 at the inverting input to op-amp or comparator 639, an undervoltage protection signal 600 can be applied at the base of transistors 648, 649, etc. Again, the types of circuit protection and the circuit nodes at which they are applied are not limited to these examples. Other control signals (e.g., OptoA 643, OptoC 644) can be applied, for example through opto-isolator 641 and resistor 642. For example, output voltage limiting can be applied in this manner

Turning to FIG. 28, an overcurrent protection circuit is depicted in accordance with some embodiments of the invention. A current level signal LSENSE 650, derived, for example, from the voltage level across resistor 605 in FIG. 26 or any other suitable source, is divided and filtered as desired, for example by resistors 651, 652 and capacitor 653 to drive transistor 654. When the current level becomes excessive, the transistor 654 pulls down an overcurrent signal OCP 655, which can correspond to OCP 599 in FIG. 26, and limits the current.

Turning to FIG. 29, an undervoltage protection circuit is depicted in accordance with some embodiments of the invention. When a voltage signal VDD1 601 falls too low, a Zener diode 670 and resistor 671 turn off transistor 672, pulling up the gate of transistor 674 through resistor 673 and turning on transistor 674, which pulls down the undervoltage signal UVP 675, which can correspond to UVP 600 in FIG. 26. The undervoltage signal UVP 675 can be used, for example, to disable transistors 648, 649 in FIG. 27 to turn off the pulses on the pulse width modulated or variable pulse control signal PWM_CTL 603.

Turning to FIG. 30, a dither circuit is depicted in accordance with some embodiments of the invention. AC power taken from inputs 680, 681 connected, for example, in EMI Filter/Rectifier 204 before rectification, is rectified in diode bridge 681, referenced to HV 595 through resistor 682. Voltage divider 683, 684 and Zener diode 685 generate a reference voltage, passed through diode 686. A low side dither signal DitherB 621 is tied to the low side of diode bridge 681 through capacitor 690 and resistor 691. A voltage divider 687, 689 generates the high side dither signal DitherA 620 based on the output of diode 686. The dither circuit can be used, for example, to alter the feedback paths to op-amp 637 in the ramp generator of the power conversion stage circuit of FIG. 27 to, for example, provide EMI dithering and reduction. Again, dithering is an optional feature in some embodiments of the solid state lighting system, and can be applied using a circuit or device, applied at any suitable point and in any suitable manner in the solid state lighting system. The dithering example shown in FIG. 30 again, is not intended to be limiting in any way or form and is merely provided as an example.

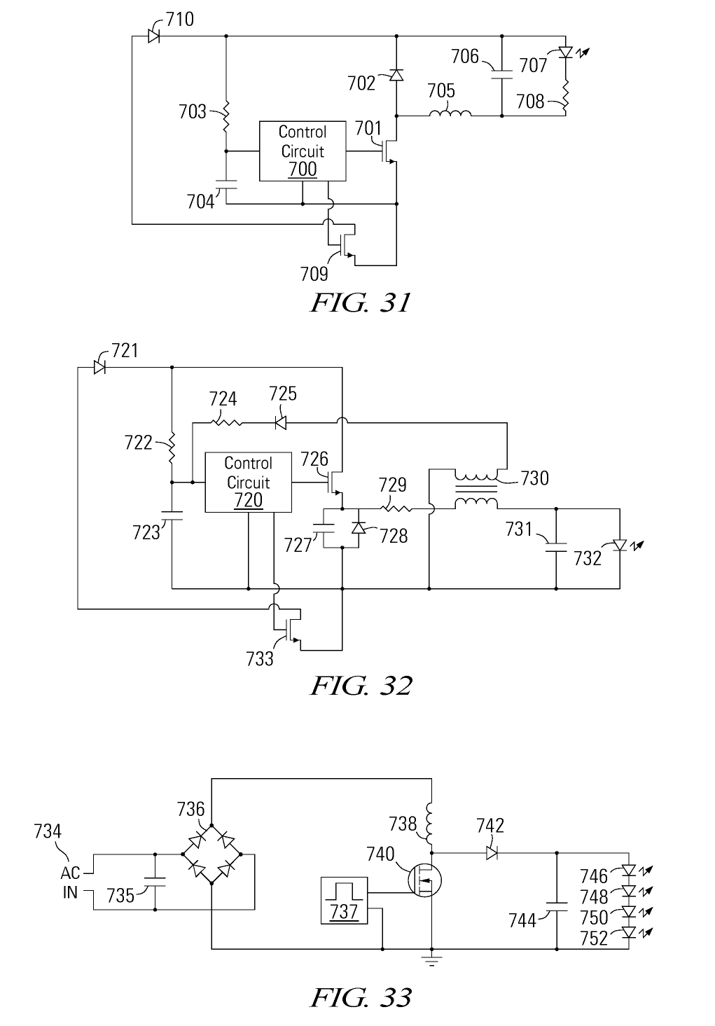

Turning now to FIG. 31, a dual power source circuit is depicted which can be used in various solid state lighting systems for any purpose in accordance with some embodiments of the invention, for example to draw power from a ballast output or an AC input. In one example embodiment, a control circuit 700 generates a PWM signal to control a transistor 701, with a diode 702 and inductor 705 forming a buck converter along with the transistor 701 to power a load 707 and output capacitor 706. Current limiting or sense resistors (e.g., 708) can also be included as desired. As a second source of power in the circuit, the drain of a transistor 709 can be connected to a connection to either an AC input or ballast output, if a ballast is installed. A diode 710 can correspond with diode 582 of FIG. 26. This enables the buck converter to be turned off to control the output using transistor 709. Although a buck converter is depicted and discussed with respect to FIG. 31, in general, any type of switching/storage circuit, including non-isolated and/or isolated circuits such as but not limited to boost, buck-boost, boost-buck, flyback, forward converters, Cuk, SEPIC, etc. can be used for the present invention.

Turning now to FIG. 32, a dual power source circuit with a tagalong inductor 730 to power internal circuits is depicted which can be used in various solid state lighting systems for any purpose in accordance with some embodiments of the invention, for example to draw power from a ballast output or an AC input. In one example embodiment, a control circuit 720 generates a PWM signal to control a transistor 726, with a diode 729, capacitor 727 and tagalong inductor 730 forming a buck converter along with the transistor 726 to power a load 732 and output capacitor 731. In this embodiment, the control circuit 720 is powered through diode 725 and resistor 724 from tagalong inductor 730. As a second source of power in the circuit, the drain of a transistor 733 can be connected to a connection to either an AC input or ballast output, if a ballast is installed. A diode 721 can correspond with diode 582 of FIG. 26.

Again, various embodiments of the solid state lighting systems disclosed herein can include/use/incorporate power converters of any type or topology. The schematics shown for, for example but not limited to, the buck, buck-boost, boost-buck, boost, Flyback, forward converters, etc. are intended to be representative only and in no way or form limiting and are merely intended as simple example references for some of the approaches, topologies, circuits, drivers, power supplies, etc. discussed herein and previously incorporated in patents and patent applications. For example, in some embodiments the switching/storage inductor or inductors in the buck circuit may be placed in a different position relative to other components.

Turning now to FIG. 33, a boost power supply circuit that can be used in some embodiments of a solid state fluorescent replacement lighting system for either or both lighting or secondary power supply is depicted in accordance with some embodiments of the invention. The boost power supply circuit can provide a higher voltage to the load than received at the input. Power is received from an AC input 734 across capacitor 735 and is rectified in diode bridge 736. The capacitor 735 can be for example, one or more fixed or variable capacitors, and when receiving power from a ballast output, can be used to lower the output voltage of the ballast and can be used for dimming purposes. A PWM generator 737 drives a transistor 740 to allow current from the diode bridge 736 to flow through inductor 738 and storing energy in a magnetic field around inductor 738 (referred to herein as storing energy in the inductor) when transistor 740 is closed. When transistor 740 is open, the inductor 738 releases current (or resists the change to the current) through diode 742, charging capacitor 744 and powering LEDs 746, 748, 750, 752, with diode 742 preventing capacitor 744 from discharging through transistor 740 when it is closed.

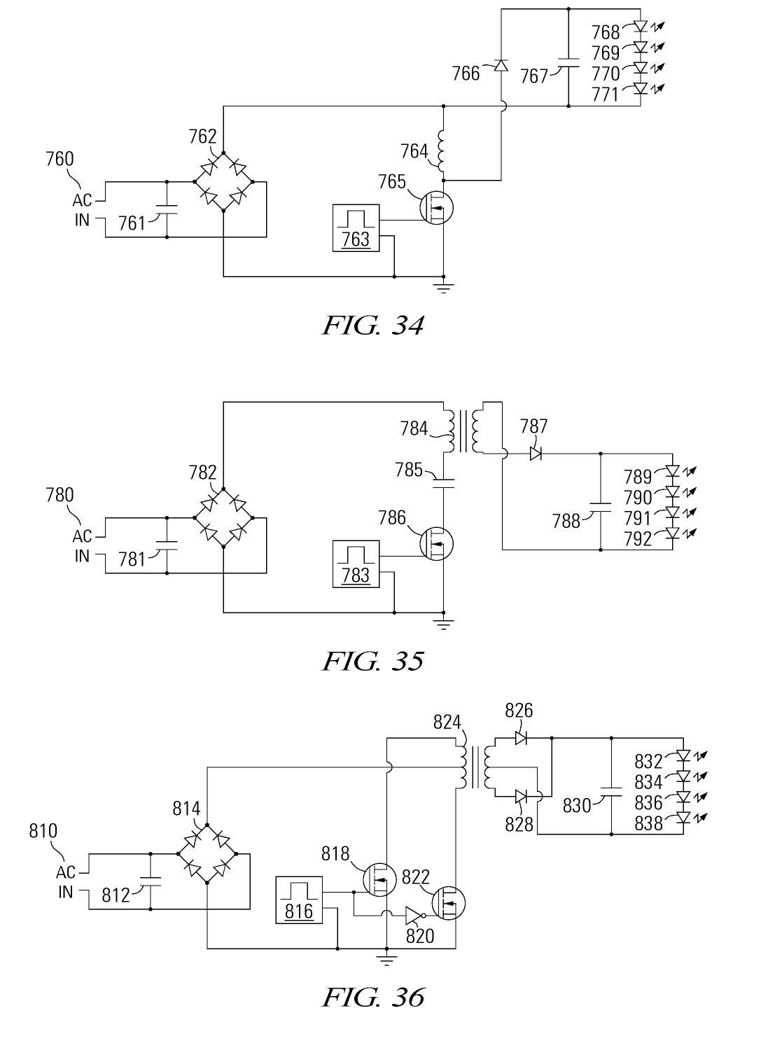

Turning now to FIG. 34, a buck-boost power supply circuit is depicted that can be used in some embodiments of a solid state fluorescent replacement lighting system for either or both lighting or secondary power supply in accordance with some embodiments of the invention. The buck-boost converter can be configured to increase or decrease the output voltage with respect to the input voltage. Power is received from an AC input 760 across capacitor 761 and is rectified in diode bridge 762. A PWM generator 763 drives a transistor 765 to allow current from the diode bridge 762 to flow through inductor 764 as transistor 765 is closed. As transistor 765 is opened, the inductor 764 releases current through diode 766, charging capacitor 767 and powering LEDs 766, 768, 770, 772. (If the transistor 765 is left either closed or open, DC current is effectively blocked.)

Turning now to FIG. 35, a flyback converter power supply circuit is depicted that can be used in some embodiments of a solid state fluorescent replacement lighting system for either or both lighting or secondary power supply in accordance with some embodiments of the invention. Power is received from an AC input 780 across capacitor 781 and is rectified in diode bridge 782. A PWM generator 783 drives a transistor 785 to allow current from the diode bridge 782 to flow through the primary winding of transformer 784 as transistor 765 is closed. As transistor 765 is opened, the transformer 784 releases current through diode 787, charging capacitor 788 and powering LEDs 789, 790, 791, 792.

Turning now to FIG. 36, a flyback converter power supply circuit with half bridge is depicted that can be used in some embodiments of a solid state fluorescent replacement lighting system for either or both lighting or secondary power supply in accordance with some embodiments of the invention. Power is received from an AC input 810 across capacitor 812 and is rectified in diode bridge 814. A PWM generator 816 drives transistors 818, 822 to allow current from the diode bridge 814 to flow through one side or the other of the primary winding of center-tapped transformer 824 as the transistors are opened and closed. Although an inverter 820 is depicted to indicate that the transistors 818, 822 are not closed simultaneously, any suitable circuit or algorithm can be used to drive the transistors 818, 822. Based upon the disclosure herein, one of ordinary skill in the art will recognize a variety of ways in which transistors 818, 822 can be driven in a mutually exclusive fashion. As each transistor 818, 822 is opened, the transformer 824 releases current either through diode 826 or diode 828, charging capacitor 830 and powering LEDs 832, 834, 836, 838.

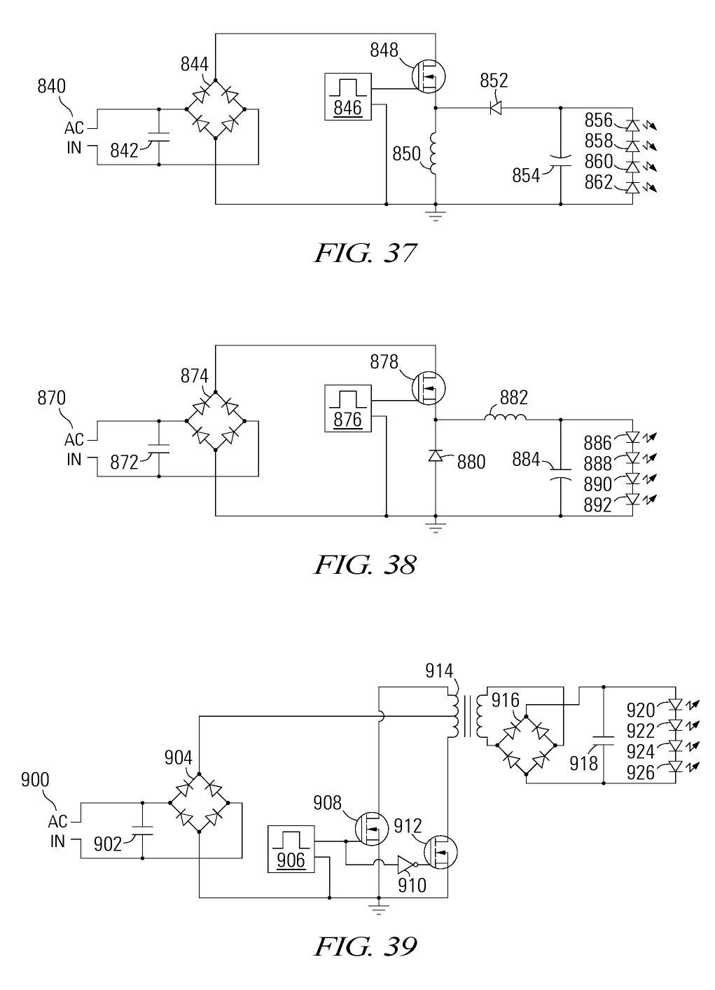

Turning now to FIG. 37, a buck-boost power supply circuit is depicted with inverted output that can be used in some embodiments of a solid state fluorescent replacement lighting system for either or both lighting or secondary power supply in accordance with some embodiments of the invention. The buck-boost converter can be configured to increase or decrease the output voltage with respect to the input voltage. Power is received from an AC input 840 across capacitor 842 and is rectified in diode bridge 844. A PWM generator 846 drives a transistor 848 to allow current from the diode bridge 846 to flow through inductor 850 as transistor 848 is closed. As transistor 848 is opened, the inductor 850 releases current, charging capacitor 854 and powering LEDs 856, 858, 860, 862 through diode 852.

Turning now to FIG. 38, a buck power supply circuit is depicted that can be used in some embodiments of a solid state fluorescent replacement lighting system for either or both lighting or secondary power supply in accordance with some embodiments of the invention. Power is received from an AC input 870 across capacitor 872 and is rectified in diode bridge 874. A PWM generator 876 drives a transistor 878 to allow current from the diode bridge 876 to flow through inductor 882 as transistor 878 is closed, charging capacitor 884 and powering LEDs 886, 888, 890, 892. As transistor 878 is opened, the inductor 882 releases current through diode 880.

Turning now to FIG. 39, a forward converter power supply circuit with full bridge is depicted that can be used in some embodiments of a solid state fluorescent replacement lighting system for either or both lighting or secondary power supply in accordance with some embodiments of the invention. Power is received from an AC input 900 across capacitor 902 and is rectified in diode bridge 904. A PWM generator 906 drives transistors 908, 902 to allow current from the diode bridge 904 to flow through one side or the other of the primary winding of center-tapped transformer 914 as the transistors are opened and closed. Although an inverter 910 is depicted to indicate that the transistors 908, 902 are not closed simultaneously, any suitable circuit or algorithm can be used to drive the transistors 908, 902. Based upon the disclosure herein, one of ordinary skill in the art will recognize a variety of ways in which transistors 908, 902 can be driven in a mutually exclusive fashion. As each transistor 908, 902 is opened, the transformer 914 releases current through diode bridge 916, charging capacitor 918 and powering LEDs 920, 922, 924, 926. Although only four LEDs are depicted in, for example, FIGS. 31 through 39, in general any number of LEDs in parallel, series, etc., combinations of these can be used in embodiments and implementations of the present invention.

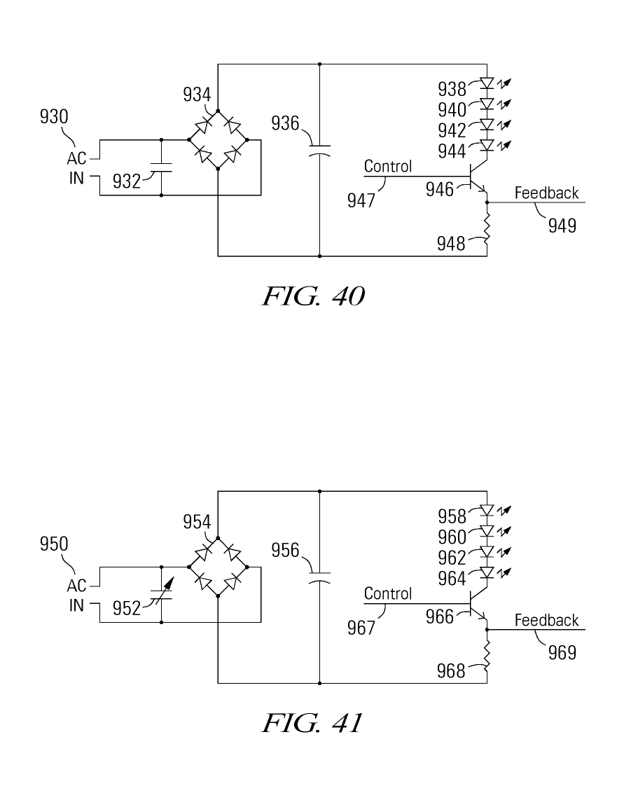

Turning now to FIG. 40, a power supply circuit with feedback control is depicted that can be used in some embodiments of a solid state fluorescent replacement lighting system in accordance with some embodiments of the invention. Power is received from an AC input 930 across capacitor 932 and is rectified in diode bridge 934. An output capacitor 936 is connected across the output of the diode bridge 934. When a control switch 946 is closed, current from the diode bridge 934 can flow, powering LEDs 938, 940, 942, 944 and charging output capacitor 936. A feedback signal 949 can be used to measure the load current across sense resistor 948, and any suitable circuit such as, but not limited to, the feedback and control circuits disclosed herein can be used to generate the control signal 947 for switch 946 based on the feedback signal 949.

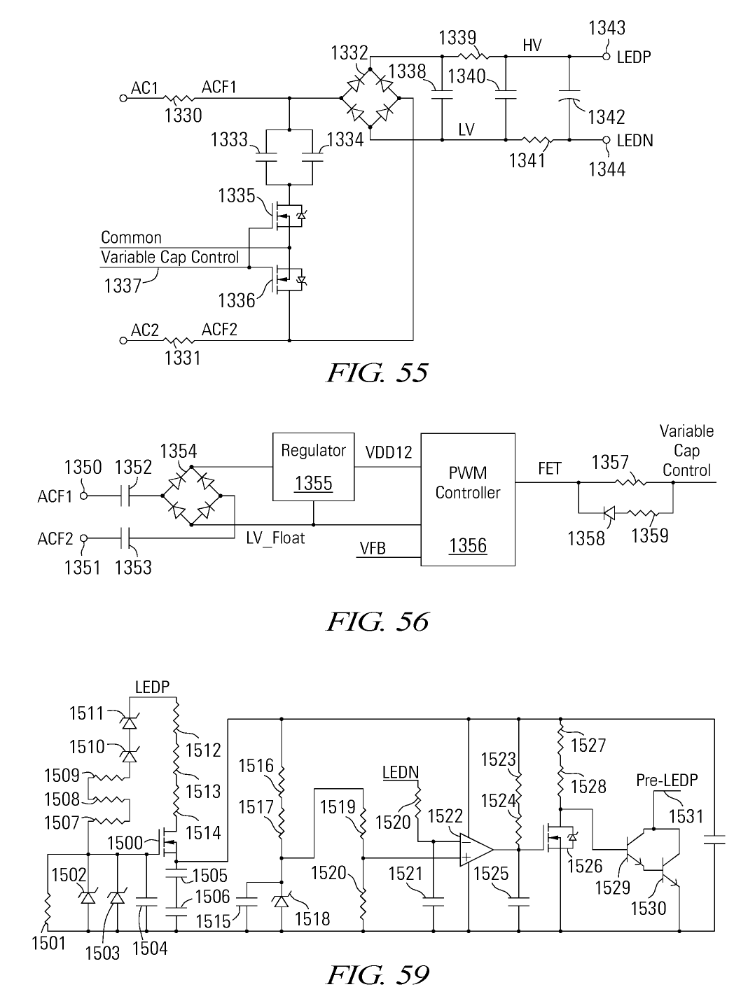

Turning now to FIG. 41, a power supply circuit with feedback control and variable input capacitor is depicted that can be used in some embodiments of a solid state fluorescent replacement lighting system in accordance with some embodiments of the invention. Power is received from an AC input 930 across variable input capacitor 952 and is rectified in diode bridge 954. An output capacitor 956 is connected across the output of the diode bridge 954. When a control switch 966 is closed, current from the diode bridge 954 can flow, powering LEDs 958, 960, 962, 964 and charging output capacitor 956. A feedback signal 969 can be used to measure the load current across sense resistor 968, and any suitable circuit such as, but not limited to, the feedback and control circuits disclosed herein can be used to generate the control signal 967 for switch 966 based on the feedback signal 969. Furthermore, the capacitance of variable input capacitor 952 based upon the feedback signal 969 or any other measured signal or control signal, providing further control of the load current. Such a variable capacitor can be implemented, for example but not limited to, as depicted in FIG. 55.

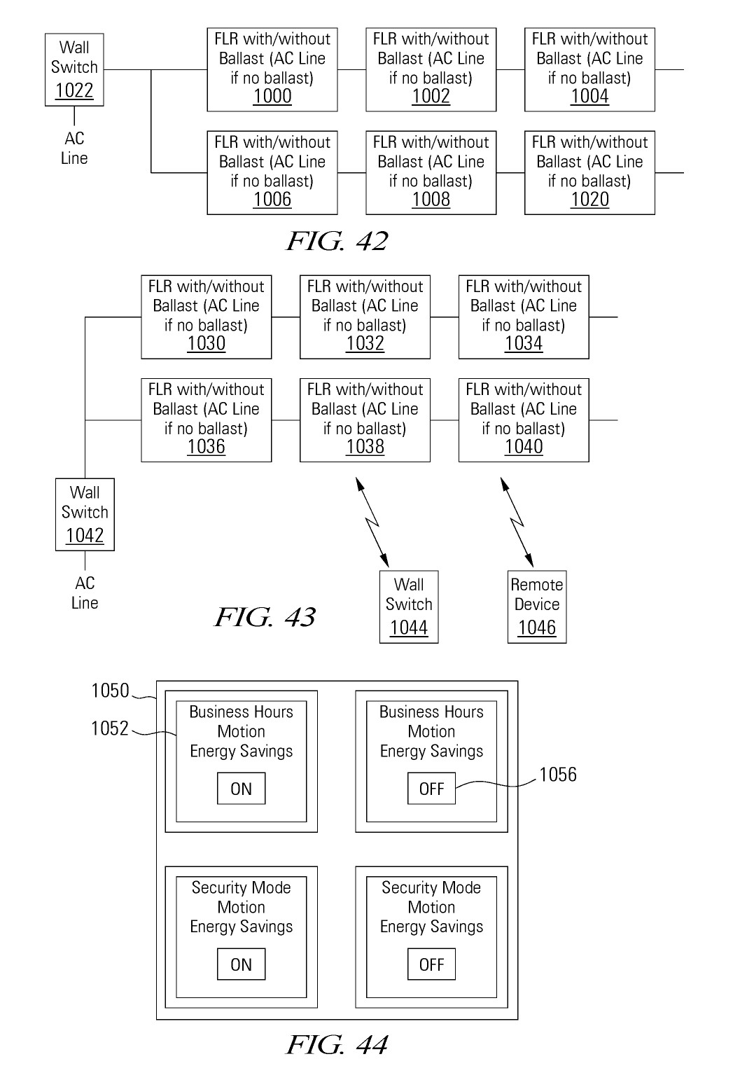

Turning to FIG. 42, some examples of the solid state lighting system include multiple fluorescent lamp replacements 1000, 1002, 1004, 1006, 1008, 1020 and control devices such as, but not limited to wired wall switch 1022. As shown in FIG. 43, some examples of the solid state lighting system include multiple fluorescent lamp replacements 1030, 1032, 1034, 1036, 1038, 1040 and multiple control devices such as, but not limited to wired wall switch 1042, wireless wall switch 1044, remote control device(s) 1046 such as cell phones, tablets, computers, etc., which can be networked and interconnected in any suitable manner or using a combination of wired and wireless networks. Remote control device(s) 1046 can be powered in any manner, for example using AC line, battery, solar, power over Ethernet (POE), mechanical generators, vibrational power harvesters, energy harvesters in general, etc.

Embodiments of the present invention can be used for both retrofit and replacement and operate (plug and play) together seamlessly including that the software is the same for the new construction retrofit and the old/existing replacement as well as other systems including BACNET systems made from, for example, Johnson Controls, Siemens, Honeywell, etc. As an example embodiment of the present invention, an interface can be implemented that takes the, for example, but not limited to, 24 volt system interfaces such as used by, for example, Johnson controls, Acuity, Lutron, and others.

The block diagrams of FIG. 42 and FIG. 43 depict example implementation of the present invention in which a smart switch (Wall Switch) which could be a physical wall switch or other such switch provides power either directly or indirectly (i.e., via ballast(s)) to the SSL FLRs. Such example implementations can be powered off completely by the smart wall switch and dimmed directly without a ballast using the wall switch which optionally could be a dimmer and on/off switch and optionally support powerline control and dimming and dimmed by wireless means for either directly AC line powered or by an AC line powered ballast (note, the ballast does not need to be a dimmable ballast). Embodiments of the present invention for the smart/intelligent wall switch can include the capability to measure input and output current, voltage, power, power factor, harmonics, total harmonic distortion (THD), crest factor, efficiency, etc. and can include sensors either internal/incorporated as part of the smart dimmer or remotely wired, wireless or powerline communications—such sensors can be of any type and form including but not limited to any type of light, solar, spectrum, color, noise, motion, proximity, radar, sonar, ultrasonic, sound, voice, voice recognition, RFID, proximity, signal strength based, wireless, RF, infrared, etc., combinations of these, etc. The smart wall switch can be directly or indirectly AC powered, battery powered, solar powered, solar charged, etc., combinations of these, etc. as well as any or all of the sensors being directly or indirectly AC powered, battery powered, solar powered, solar charged, etc., combinations of these, etc. Such a present invention also fully supports load shedding, brown-outs, scheduled power decreases, load reduction, power reduction, commanded power demand reduction, etc. for both grid and off grid energy/power sources.

In some embodiments of the present invention, some or all of the sensors are incorporated into the implementations of the present invention or located close by and, for example, tethered by wires (or in some cases using wireless technology including but not limited to, wireless communications and wireless power transfer) with power being provided by the AC or ballast or indirectly powered, battery powered, solar powered, solar charged, etc., combinations of these, etc.

Some embodiments of a FLR replacement include tethered motion, sound, noise, ultrasonic, temperature, humidity, gas, other environmental sensors, detectors, controllers, etc.

and optional light sensors which could be attached to the fixture including the outside of the fixture past the diffuser, if there is a diffuser. The light sensor could include one or more of a projection, cover, lens, cone cylinder, etc. to block direct light from the FLRs reaching the light sensor(s).

Some embodiments of the present invention can recognize specific devices including but not limited to cell phones, smart phones, tablets, RFID tags, laptops, smart watches, wearables, remote devices, Bluetooth devices, etc., combinations of these, etc., other radio communications, voice identification, signal strength, etc., combinations of these. The wall switch also supports scheduling, sequencing, programming, synchronizing, adapting, etc.

Multiple light sensors at different angles with, in some embodiments, different focal points can be used as part of the present invention. The multiple sensors can be located in the same housing or disbursed, distributed, etc. and communicate by wired or wireless means. Some embodiments of the light sensor(s) include a sleek nearly 2-D (i.e., very thin) sensor that can be mounted at appropriate places including on the wall. Some embodiments of the invention provide plug and play installation while producing constant lumens outputs. The present invention can also support multiple temperature sensors that communicate, for example, but not limited to wired or wirelessly.

Some embodiments of the present invention use capacitors in series to limit AC line (50, 60, 400 Hz, etc.) input current and power and use capacitors in parallel to limit ballast (output) input (to the circuit) current and power which can also prevent mis-wiring which might cause damage. SCP can also be used in conjunction to also limit current and prevent damage.

Some embodiments of the present invention provide a USB port which can used to set addresses, ID, upload new versions, set priorities, set and program priority levels, etc.

Some embodiments of the present invention can be used to provide festive lighting including for holidays (Christmas, New Years, Halloween, Fourth of July, St Patrick's Day, etc.), favorite/local (high school, college, university, professional) team, company, state, personal, college, university, etc., colors, etc.

Some embodiments of the present invention provide the ability to disable current control (e.g., constant current/constant lumens) including remotely disable in ballast mode.

Some embodiments of the present invention include a fluorescent tube replacement such as a T4, T5, T8, T10, T12, etc. that can use a motor or similar device to raster or scan the SSL/LED lighting which could include but is not limited to one or more white color temperatures, one or more colors including but not limited to red, green, blue, amber, yellow, etc., combinations of these, etc. Some implementations of the present invention can include but are not limited to addressable arrays of LEDs including white color temperatures (W, WW, WWW, etc.) and colors such as RGB, RGBA, etc.

Some embodiments of the present invention can measure the input current, voltage, power, power factor, etc. of, for example, but not limited to, each unit (lamp), the group or groups of lamps controlled by a ‘wall dimmer’ of the present invention, etc. By measuring such input power used/consumed, implementations of the present invention can measure/calculate/determine/etc. the power/energy consumed and the both the energy (which essentially equals power×time) consumed and the energy saved for example, but not limited to, for the SSL/LED direct fluorescent replacement lamp that, for example, uses a ballast or a SSL/LED AC retrofit fluorescent replacement lamp that runs directly off the AC power and use such information to calculate the energy savings including but not limited to the energy savings based on the difference between the old/previous fluorescent lamp with ballast. Using such energy savings measurements/calculations/determinations/etc., the monetary savings value can be calculated/deduced/determined, etc. from the energy cost rate for example, but not limited to, by using the energy cost in, for example, but not limited to, multiplying the energy (equals power times time) in for example, but not limited to, kilowatthours (kWH) times the rate (in, for example, dollars per kWH=/kWH) to determine the financial monetary savings. Such monetary savings can be used as the basis for determining the return on investment or, for example, to determine the value of a leasing agreement, etc. Such information, determinations, processing, etc. can be done, stored, compiled performed, etc. by firmware, software, etc., stored anywhere in one or more locations, including but not limited and not necessarily in embodiments and implementations of the present invention, etc. (and more types of places, locations, facilities, etc.), the cloud, servers, internet, can use mobile carriers to communicate two-way information, controls, commands, monitoring, analytics, Big Data, events, alerts, security information, movements, heat maps, etc., combinations of these, etc.

Some embodiments of the present invention include dimming/control units that can also optionally measure and monitor and log data, information, performance, etc. Such embodiments can use 0 to 10 V, 0 to 3 V, other analog protocols, ranges, etc., powerline communications, wireless, wired other digital protocols, etc., forward or reverse phase dimming of any kind and type including ones that involve one or more of triacs, transistors, diodes, etc., combinations of these, etc. and can use light level motion, ultrasonic, noise, sound, voice, etc.

The present invention includes power supplies and drivers that are ballast replacements (ballast replacement power supplies and ballast replacement drivers (BRPS and BRD, respectively) designed specifically for SSL/LED FLRs).

Some embodiments of the present invention can be used to replace, for example, 32 W with a lower wattage that can be increased manually or automatically by, for example, but not limited to, switches, software, hardware, firmware, manual and/or automatic controls, etc.

Some embodiments of the present invention can use a smart circuit breaker(s) and/or switch(es) that, in addition to performing normal circuit breaker functions, can be turned on and off by wired, wireless and/or powerline communications

Some embodiments and implementations of the present invention can work with virtually any type of ballast including all types of magnetic and electronic ballasts and, regardless of the ballast type and ability (i.e., a fixed power, non-dimmable, non-controllable, etc. ballast) make the ballast and fluorescent lamp replacement into a smart and intelligent system capable of virtually any control and monitoring including but not limited to daylight harvesting, dimming, motion, noise, audio, ultrasonic, sonar, radar, proximity, cell phone, RFID, light, solar, time of day, week, month, date, etc., web, environment, etc. sensing and responding, etc. one or two way communications, data logging, analytics, fault reporting, etc. and other functions, features, modes of operation, etc. discussed herein. Such embodiment and implementations can also be implemented to work directly with AC and/or DC power. Although primarily discussed in terms of fluorescent lamp replacements, all of the functions, abilities, capabilities, features, modes of operation, approaches, methods, techniques, technologies, designs, architectures, topology, etc. apply directly and equally to high intensity discharge (HID) lighting including but not limited to metal halide, and all types of sodium and other gaseous low pressure and high pressure lighting, etc., other types of lighting discussed herein including various types of fluorescent lighting including but not limited to compact fluorescent lamps, PL and PLC fluorescent lamps, cold cathode fluorescent lamps, T1 through T13 fluorescent lamps including but not limited to T4, T5, T8, T12, fluorescent lamps of any length and shape including but not limited to linear, U-shaped, rectangular shape, one or more U-shaped, etc.

The heater emulation circuits may employ one more switches that can open or close as needed depending on for example, frequency of applied current, voltage, power, etc., temperature, operating conditions, etc., type of ballast, etc. Such one or more switches can be of any appropriate type or form including ones that are manually or automatically activated, mechanically or electrically activated, are semiconductor switches such as but not limited to field effect transistors (FETs) including but not limited to MOSFETs, JFETs, UFETs, etc., of both depletion and enhancement types, bipolar junction transistors including but not limited to PNP and NPN, heterojunction bipolar transistors (HBTs), unijunction transistors, triacs, silicon controlled rectifiers (SCRs), diacs, insulated gate bipolar transistors (IGBTs), GaN-based transistors including but not limited to GaNFETs, silicon carbide (SiC) based transistors including but not limited to SiCFETs, etc., solid state and mechanical relays, reed relays, electromechanical relays, latching relays, contactors, etc. photodiodes, phototransistors, optocouplers, etc. vacuum tubes, etc. thermistors, thermistor-based switches, etc. Temperature sensing can be accomplished using any technique including but not limited to thermistors, semiconductor junctions, thermocouple junctions, resistors, fuses, thermal methods, etc.

The present invention provides for convenient direct replacements for fluorescent, HID and other types of lighting using SSL including but not limited to LEDs, OLEDs, QDs, etc. that enables smart and intelligent operation where there was none before. Embodiments of the present invention provide for SSL FLRs that can perform smart and intelligent dimming and power reduction including autonomously, automatically, manually, with one-way or two-way (i.e., bidirectional) communications and reporting using smart local or remote sensors including but not limited to those discussed herein. Such sensors can be manually, automatically, programmed, modified, set, determined, changed, etc. including locally and remotely. For example, a motion sensor can be programmed/set by, for example, but not limited to, an app on a phone, tablet, laptop, other personal digital assistant, other device, etc. for sensitivity, time on, time off, trigger level, distance, reporting level and status, alarms, etc. either locally or remotely via, for example, but not limited to, an phone/tablet app. In addition, embodiments and implementations of the present invention can also be set to monitor and report back any fault conditions including but not limited to power interruptions, power loss, improper operation, too little power, too much power, too much voltage (over voltage), too little voltage (under voltage), too little current (under current), too much current (over current), too little light output, too much light output, too high of a temperature, too low of a temperature, etc., arcing, damage, combinations of these, etc. and alert/request maintenance/repair, etc.

In some embodiments, bathroom, closet, stairwell, garage, conference room, other locations which may or may not be used frequently, etc. can make use of the ballast-compatible direct fluorescent lamp replacement embodiments of the present invention including but not limited to the smart/intelligent ones discussed herein.

Embodiments of the present invention can also monitor and report power, current, voltage usage to, for example, but not limited to, measure, determine and calculate energy and cost savings and to also, but not limited to, determine SSL/LED usage in terms of hours on and current through the SSL/LEDs to determine, estimate, extrapolate, calculate, etc. lifetime remaining, SSL/LED degradation, depreciation, etc. Optional temperature and/or light sensors may also be used to keep track, track, log, perform additional analytics including but not limited on the lifetime, performance, degradation, decrease in lumens, lumens depreciation, etc. of the SSL/LEDs, etc.

Various embodiments of the present invention can be used to replace any and all types of gaseous lighting including but not limited to fluorescent, HID, metal halide, sodium, low and/or high pressure lamps, etc. for parking lights, street lights, outdoor lights, indoor lights, sports lights, gymnasium lights, office lights, stair well lighting, virtually any type of indoor or outdoor lighting, stair case lights, bathrooms, closets, bedrooms, living rooms, family rooms, hospitals, hospital rooms, surgery rooms, urgent care, emergency care, classrooms, auditoriums, offices, lobbies, gyms, sports centers, community centers, recreational centers, libraries including but not limited to libraries for schools, colleges, universities, public and private libraries, study areas, individual cubicle lighting including, for example, but not limited to individual lighting in a library where the lighting preference including, for example, but not limited to light intensity, color temperature, color rendering index (CRI), light pattern and location, etc., color lighting, etc. could be selected for/by, etc. each individual or user, etc. and also includes additional facilities, rooms, homes, residences, apartments, etc. Implementations of the present invention can also be used for cleanroom applications including but not limited to photolithography applications and locations where the wavelength and associated energy, color, etc. must be restricted to typically a yellow color or below (i.e., to the red wavelengths as opposed to the blue wavelengths). For such implementations yellow SSL including but not limited to yellow phosphor coated (PC) SSLs including LEDs, OLEDs, QDs, etc. can be used to provide the appropriate and needed color of light while still being highly efficient and with long life.

Some embodiments of the present invention can also use, employ, interact with, be controlled, respond to, etc., combinations of these, etc. emotion sensors and mood sensors.

Systems of SSL FLR, direct AC replacement kits, panels including panels of any size from inches (or less) on a side to feet on a size and larger including but not limited to 1×2 foot, 2×2 foot, 1×3 foot, 2×3 foot, 2×4 foot, 3×4 foot, 4×4 foot and larger (and also smaller), PLC lamps, PAR lamps, A lamps, R lamps, BR lamps, etc., any other type of lamp, light, light fixture, combinations of these, etc.

Embodiments of the present invention can control, monitor, color change, color temperature change, etc. all types of lighting which can all be controlled by the same interface and control.

In some embodiments of the present invention, the lighting can be set/programmed including but not limited to active and/or dynamic processing, programming, synchronizing, sequencing the lighting so that, for example but not limited to, the lighting being on, turned on/off, dimmed, etc. in certain ways, paths, etc. from less than one second to more than one hour. Such embodiments allow for special effects including the appearance that the light is following, leading, shadowing, tracking, anticipating, etc., combinations of these, etc. the movement, direction, destination, or location, etc. that one or more people, living creatures, persons with permission, persons without permission, etc. may be heading to, going toward, etc. Such embodiments may use but are not limited to one or more motion sensing, radar, movement, vibration, sonar, ultrasonic, ultrasound, camera(s), vision recognition, pattern recognition, photocells, photo detector(s), electric eye(s), RFID, cell phone signals, smart phone signals, tablet signals, RF signal strength/detection including but not limited to Bluetooth, other 2.4 GHz, ISM, WiFi, ZigBee, Zwave, 5LoWPAN, LoRa, PLC, other types, protocols, frequencies, etc. discussed herein, etc., combinations of these, as well as other information including methods of identification, badge/sign-in entry, time of day, database information, web based information, signals, data, etc., day, date, weather, temperature, humidity, light level, solar/Sunlight level, gesturing, facial expressions, movements, ambient conditions, environment, track speed including but not limited to of a person or persons, etc., animal(s), other living creatures, animate or inanimate objects, etc. Such embodiments can make the speed of on/off and or dimming to whatever is desired, needed, required including from extremely fast to extremely slow. Such embodiments may be used for any application or use including but not limited to indoor and/or outdoor applications including but not limited to hallways, rooms, meeting locations, conference rooms, conference centers, convention centers, sports events centers, to and from locations such as bathrooms, open or closed/covered parking lots and locations, street lighting, including but not limited to for pedestrians and vehicles, freeway and highway road and other lighting, signage lighting including but not limited to roadside and billboard lighting.

Embodiments of the present invention can have a wireless or wired device provide one or more and especially more than one 0 to 3 V and/or 0 to 10 V or other analog and/or digital signals including but not limited to simple and/or complex pulsing including simple to complex and sophisticated PWM as well as, in many cases, DC or, in some cases, AC. Such embodiments can control/monitor/log/store/analyze/perform analytics, etc. on more than just the lighting and can also be used to do different things including but not limited to heat, cool, light, protect, detect, etc. Such implementations can be used for more than lighting and include but are not limited to heating, cooling, HVAC, temperature, humidity, window coverings, entertainment, etc. as well as lighting including specialized lighting and general lighting.

Some embodiments of the present invention include implementations that can replace the ballast power with power supplies that effectively and essentially perform the same function as the ballast but are specifically designed to work with fluorescent lamp replacements (FLRs) and provide a constant AC or DC current to the FLRs. Such embodiments of the present invention can, for example, but not limited to, provide numerous additional functions, features, etc. including remote control, monitoring, logging, tracking, analytics, dimming, scheduling, etc. using, for example, but not limited to, wired, wireless, powerline control (PLC), etc. Such embodiments of the present invention can also have a maximum current level set and also a maximum voltage level set.

Some embodiments use a DC buss—for example, 24 V to supply all of the ballast (re-wire from AC line voltage (e.g., 120 VAC, 240 VAC, 277 VAC, 347 VAC) to DC) using, for example, a AC to DC power supply, an off-grid source such as, but not limited, to solar, geothermal, hydro, fuel cell, battery, etc., combinations of these, etc.

In some embodiments of the present invention, a wireless or wired or powerline interface may be added to a dimmable/controlled enabled FLR which can be hung, clipped, attached, etc. to the fixture, to the hanger (“hangar”). If higher than 24 V is needed, then a buck-boost, boost, boost-buck, flyback, forward converter, push-pull, SEPIC, Cuk, two-stage converter, inverter, etc. can be used. Such a system can use virtually any type of light source including solid state lighting to be powered off of fluorescent lamp fixtures using any type of power source including but not limited to ballasts and AC line voltage. Some embodiments of a hanger-based lighting system use a relatively low voltage out (e.g., 24 volts or less or so). Such a hanger-based lighting system allows modular, plug-in approach for lighting, supporting different plug in LEDs, lamps, etc. In some embodiments, the user can replace, mix and match, change, etc. light or power supply/driver or any type of accessories including but not limited to fans, microphones, speakers, sensors, sirens, horns, buzzers, strobes, detectors, cameras, IOT, etc.

Some embodiments of the invention make measurements of the external voltage and current to determine output power.

Some embodiments of the invention use daisy chain power drops. Some embodiments of the invention can detect shorts and are short circuited protected (SCP). Embodiments of the present invention can ensure that maximum power is not exceeded by measuring and determining the power being drawn.

The present invention supports/can use the low voltage hangar approach as well as AC to low voltage DC.

Some embodiments of the present invention can use powerline communications including but not limited to either AC or DC or both AC and DC power communications.

Some embodiments of the present invention can use the isolated dimming function with isolated voltage/power to safely power, for example, but not limited to, sensors including, but not limited to, motion, sound, voice, voice recognition, noise, proximity, sonar, radar, ultrasonic, daylight harvesting, solar, light, signal strength including wireless signal strength, etc., combinations of these, etc., in addition to others, etc.

Some embodiments of the invention can use one or more lighting fixtures of any type or form including ceiling, wall, desk, etc. to communicate, for example, but not limited to communicate sensor information regarding light intensity, sound, solar, photo, color, spectrum, motion, sound, voice, voice recognition, noise, proximity, sonar, radar, ultrasonic, daylight harvesting, solar, light, etc., combinations of these, etc., as well as other, etc. As an example, a desk lamp or other object, piece of equipment, computer, computer monitor, television, desk, wall, shelf, cabinet, etc.

In some embodiments of the invention, a desk lamp can be used to support, house, power, etc. one or more smart/intelligent sensors including, but not limited to, light intensity, sound, solar, photo, color, spectrum, motion, sound, voice, voice recognition, noise, proximity, sonar, radar, ultrasonic, daylight harvesting, solar, light, etc., combinations of these, etc., etc., etc. as well as others, etc., etc. that are incorporated into the desk lamp. For example, a desk lamp can have one or more photosensors that sense the light level and report, adjust, etc. the overhead lighting, including but not limited to the smart, dimmable FLRs.

Some embodiments of the invention use one or more hangars to hang/support lighting. Some embodiments of the invention use bar codes (and bar code readers) or the squares that cell phones/tablets read, etc. to read in the ID/Address/Name/etc. of each smart/intelligent lamp, dimmer, light, etc. so as to assign each to its proper place.

Turning to FIG. 44, an example user interface 1050 is depicted that can be used to control a solid state lighting system in accordance with some embodiments of the invention. A user interface for the solid state lighting systems disclosed herein is not limited to the example layout or content depicted. Such a user interface can, for example but not limited to, control multiple FLRs and associated sensors, whether incorporated in the FLRs or external or both. In some embodiments, the user interface 1050 can be used to place FLRs or groups or zones of FLRs in one of multiple operating modes, for example placing them either in a business hours mode (or normal operating mode) or a security mode (or after-hours operating mode). For example, control regions (e.g., 1056) in the user interface 1050 can be tapped or otherwise selected to place the system in an operating mode or to perform other control operations. Other means of inputting control commands can also be used, such as, but not limited to, voice commands, gestures, speech recognition, etc. The user interface 1050 can be displayed or implemented with any suitable device or devices, such as, but not limited to, smartphones, tablets, laptop computers, desktop computers, wall panels, consoles, etc. For example, when configured in business hours mode, FLRs in the group can be configured so that sensors in or associated with the FLRs can be used for configuring light output or color, and when configured in security mode, sensors in or associated with the FLRs can be used for detecting and/or tracking and/or reporting unauthorized entry or movement. Tracking of motion across multiple sensors can be used in some embodiments to distinguish actual unauthorized entry from a single sensor glitch or other anomaly, such as a falling object.

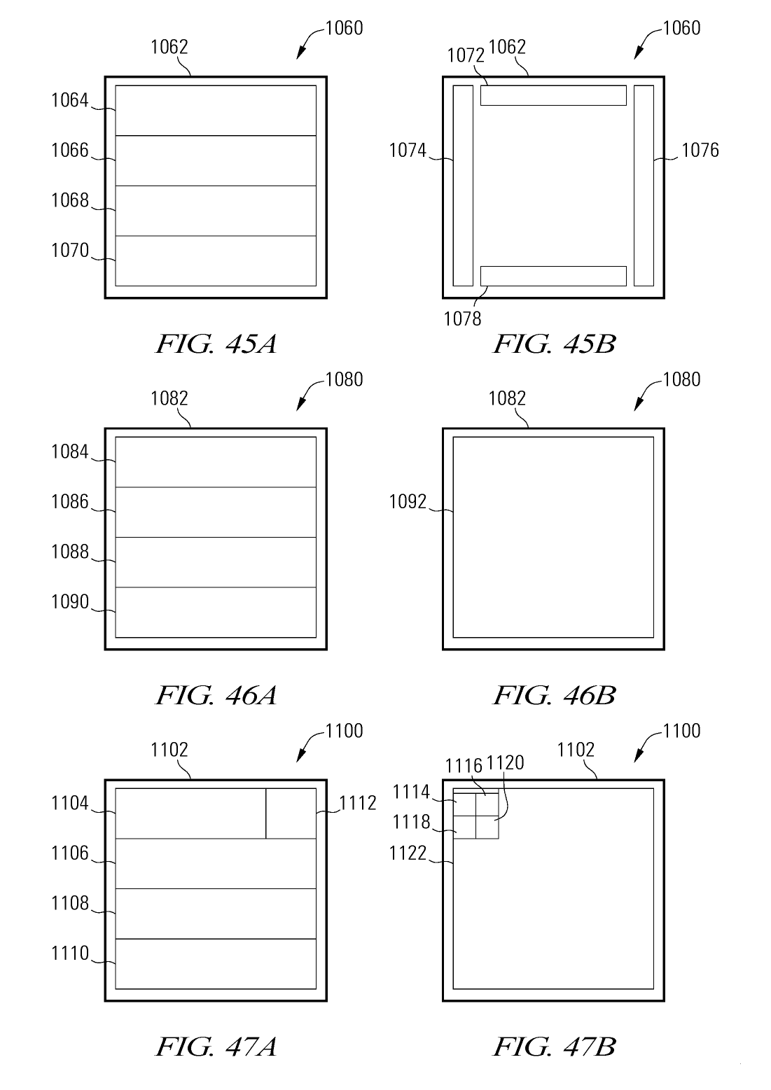

Turning to FIGS. 45A-45B, front and back sides of a solid state lighting panel 1060 for use in, for example health care and other applications including but not limited to, a circadian rhythm alignment lighting system are depicted in accordance with some embodiments of the invention. In some embodiments, multiple light-emitting elements are mounted on both sides of a frame or substrate 1062. The terminology applied to the sides herein, and the orientation of the sides of the panel, is somewhat arbitrary and is not limited to any particular configuration. In some embodiments, the side of the panel 1060 shown in FIG. 45A is referred to as the front side if mounted to a wall or sitting on a table, on a floor, etc., or is referred to as the bottom side if mounted to a ceiling, etc. Similarly, the side of the panel 1060 shown in FIG. 45B can be referred to as the back side if mounted to a wall or sitting on a table, on a floor, etc., or as the top side if mounted to a ceiling, etc. Multiple light emitting panels, point light sources, arrays of point light sources, etc. can be arranged on the front side of the panel 1060 in any suitable configuration, such as an array of OLED or LED light emitting panels 1064, 1066, 1068, 1070 that could be yellow, orange, amber etc. or any desired colors or one or more colors, multiple colors, with light emitting panels 1072, 1074, 1076, 1078 in white, blue, etc. on the back side. In some embodiments, the colors emitted on each side of the panel can be used to emit different wavelengths and intensities of light to influence and improve, for example health care and other applications including but not limited to, circadian rhythms, for example emitting light during normal waking hours that promotes wakefulness and provides sufficient illumination for task lighting or other normal lighting, and then emitting the same level or dimmer light in wavelengths that promote sleep near the end of normal waking hours. In some embodiments of the present invention, the dimmer light in wavelengths that promote sleep near the end of normal waking hours may continue to become controllably dimmer and dimmer until the light is turned out/off. Embodiments of the present invention can also be used to treat migraine headaches, seasonal affective disorder (SAD), cancer, illnesses, other ailments and diseases and aid in recovery including post-operative recovery, recuperation, well-being, providing partial, selected, full spectrum lighting, etc. and can be coupled/connected to/with one or more sensors and/or sensor arrays including but not limited to light sensors, color sensors, temperature sensors, other sensors, detectors, controls, communications, etc. described herein, etc., combinations of these, etc.

In some embodiments, blue and amber OLEDs can be stacked with the blue and amber each having a least one separate electrode, respectively to provide current/power to the respective OLED or both OLEDs, providing the ability to turn on blue light, amber light, or both in a combination to yield a controllable and adjustable white light over a range of color temperatures.

In some embodiments, sensors and/or cameras of any numbers, types, models, functions, etc. are included in lighting panels, enabling monitoring of users or patients undergoing treatment for seasonal affective disorder (SAD) and other types of health issues including but not limited to Alzheimer's, Parkinson disease, mental health problems, physical health problems, depression, addiction, therapy, Jet Lag or Rapid Time Zone Change Syndrome, Shift Work Sleep Disorder, Delayed Sleep Phase Syndrome (DSPS), Advanced Sleep Phase Syndrome (ASPD), Non 24-Hour Sleep Wake Disorder, etc., combinations of these, etc. Such sensors and/or cameras can determine time periods and/or constancy of gaze of users looking at the lights for treatment periods. Resulting measurements can be recorded, can be provided to users, can be forwarded to treatment providers for review, etc.

Turning to FIGS. 46A-46B, front and back sides of another solid state lighting panel 1080 for use in, for example health care and other applications including but not limited to, a circadian rhythm alignment lighting system are depicted in accordance with some embodiments of the invention. On one side, multiple light emitting panels 1084, 1086, 1088, 1090 that could be yellow, orange, amber etc. or any desired colors are mounted on a substrate 1082, with a light emitting panel 1092 in one or more white color temperatures, blue, etc. on the back side. In some embodiments, the one or more white color temperatures and/or blue, etc. on the front side with the one or more of yellow, orange, amber, etc. are on the front side. In some embodiments there are also light sources on the sides.

Turning to FIGS. 47A-47B, front and back sides of another solid state lighting panel 1100 for use in, for example health care and other applications including but not limited to, a circadian rhythm alignment and/or general lighting system are depicted in accordance with some embodiments of the invention. On one side, multiple light emitting panels 1104, 1106, 1108, 1110 that could be yellow, orange, amber etc., combined with a blue OLED panel 1112, are mounted on a substrate 1102, with a light emitting panel 1122 in white, blue, etc. on the other side, implemented using one or more OLED panels, combinations of variously colored and/or one or more white color temperature LEDs 1114, 1116, 1118, 1120, or in any other suitable manner

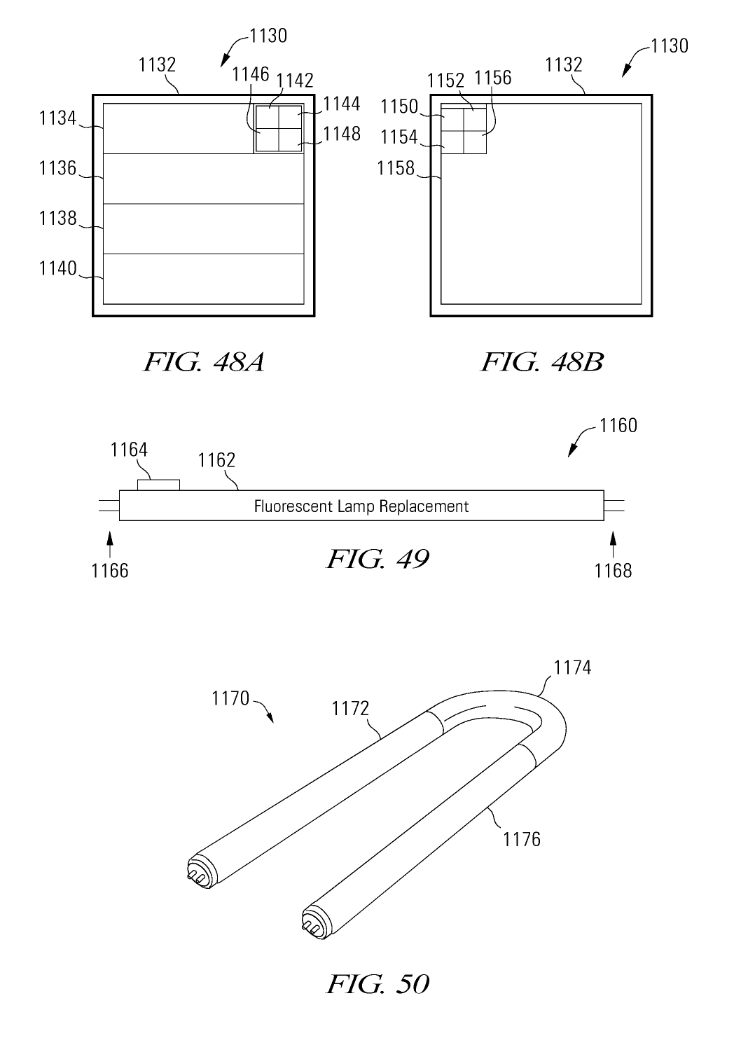

Turning to FIGS. 48A-48B, front and back sides of another solid state lighting panel 1130 for use in, for example health care and other applications including but not limited to, a circadian rhythm alignment lighting system are depicted in accordance with some embodiments of the invention. On one side, multiple light emitting panels 1134, 1136, 1138, 410 that could be yellow, orange, amber etc., combined with RGB or RGBY or RGBA, etc. LEDs 1140, 1142, 1144, 1146, are mounted on a substrate 1132, with a light emitting panel 444 in white, blue, etc. on the back side, implemented using one or more OLED panels, combinations of variously colored LEDs 1150, 1152, 1154, 1156, or in any other suitable manner.

Turning to FIG. 49, in some embodiments of the invention, a solid state fluorescent lamp replacement 1160 includes a lamp body 1162 with pins 1166, 1168 enabling it to be connected in a fluorescent lamp fixture. Depending on the type of fixture, any type of electrical connection 1166, 1168 can be provided, such as, but not limited to, single pins at each end, double pins at each end, or any other configuration. One or more control interfaces/sensors 1164 can be provided, supporting analog and/or digital (e.g., 0 to 10 V, 0 to 3 V, 0 to 5 V, 1 to 8 V, DALI, DMX, serial, UART, RS485, RS422, RS232, SPI, I2C, CAN Bus, Modbus, Profibus, DMX512, etc.) or wireless (RF, IR, ISM, Bluetooth, Bluetooth low energy, WiFi, ZigBee, Zwave, IEEE 802, RFID, etc.), or any other type of interface, sensors, sensor arrays, controls, detectors, communications, etc. including but not limited to those discussed herein, combinations of these, etc.

The SSL/LED lighting and associated electronics including drivers, power supplies, controls, etc. can be in any number of standard form factors including but not limited to T8, T12, T4, PL 2 pin and 4 pin, A lamp (E26 base), PAR 30, PAR 38, BR30, BR 40, R20, R30, R40, 2×2 ft panels, 2×4 ft panels, etc. in any white color temperature or one or more color temperatures, etc. with or without other colors as discussed herein as well as custom form factors.

Turning to FIG. 50, an example embodiment of a solid state fluorescent lamp replacement 1170 in a U-shape is depicted with multiple region control in accordance with some embodiments of the invention. It is important to note that this shape or form-factor is merely a non-limiting example. In this example embodiment, multiple regions of control 1172, 1176, 1174 are provided, each of which could be any color or multiple colors or adjustable colors. For example, in an emergency two of the regions 1172, 1176 could be set to output a primary illumination style such as white or combinations of white color temperatures or full spectrum or any other combinations including but not limited to one or more colors up to greater than 20 colors including but not limited to those discussed herein of full light output while another region 1174 could be set to, for example, but not limited to, a flashing red color and/or one or more other colors or color temperatures. Sensors can be provided in the FLR 1170 such as a temperature sensor to operate as or with a thermostat, to form part of a fire detection system for water sprinkler control, moisture or leak detection, etc. Such sensors and FLRs can be combined in a mesh network, and all can act as a system. Power supplies can be shared for multiple control regions in an FLR 1170, or multiple power supplies can be used, for example in providing multiple white temperatures or other colors. Furthermore, the FLRs can be solar/battery powered/charged in full or in part along with or in place of other power sources disclosed herein. In addition, microphones, cameras, infrared imagers, speakers, sirens, any other type of sensors, detectors, IOT, communications, monitoring, reporting including event reporting, logging, storing, power generation, energy harvesting, etc., other types of sensors, controls, devices, etc. including but not limited to those discussed herein, etc. can be incorporated/contained/etc. In embodiments and implementations of this present invention.

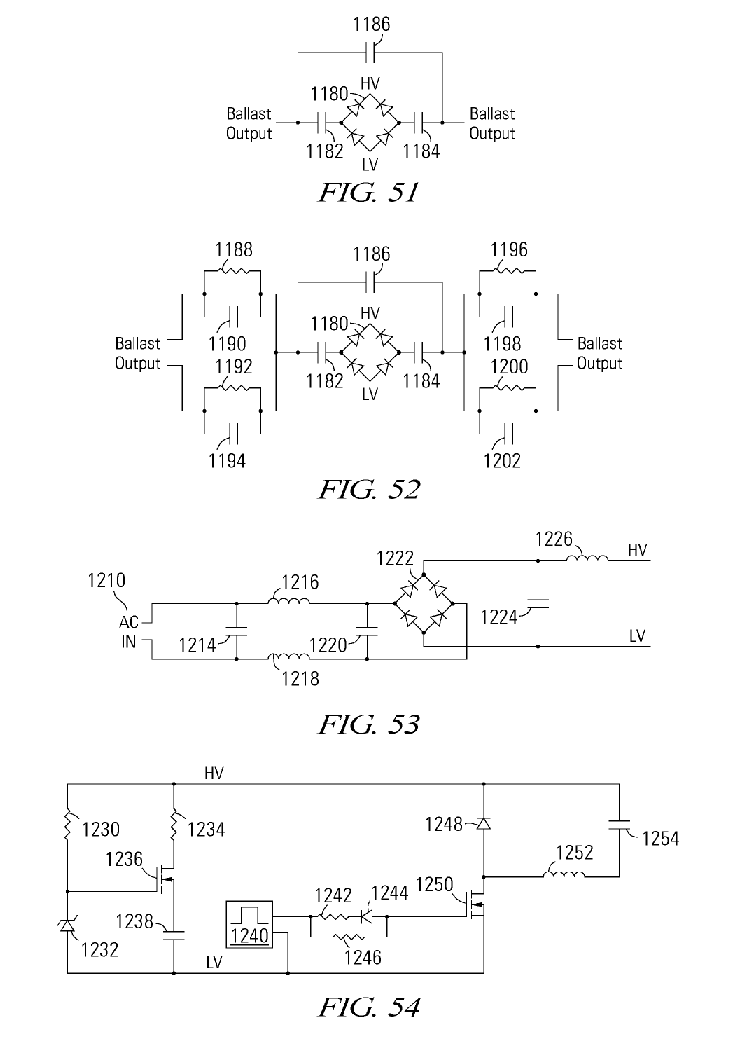

Turning now to FIG. 51, a solid state fluorescent lamp replacement input stage is depicted which can receive power from a ballast output in accordance with some embodiments of the invention. Power from ballast outputs is AC coupled through capacitors 1182, 1184 to a rectifier 1180 to yield rectified power across nodes HV, LV. One or more capacitors 1186 can be connected across the ballast outputs which provide the input power to the input stage. The one or more capacitors 1186 or other elements can be used to lower the output voltage of the ballast and can be used for dimming purposes. In some embodiments, the input capacitor 1186 can comprise a variable capacitor such as that depicted in FIG. 55 or one or more of a fixed/static capacitors and one or more variable capacitors which can be realized/achieved by any method, approach, topology, etc. Other elements can be included as desired, such as, but not limited to, inductors, fuses, EMI filters, etc., combinations of these, etc.

Turning now to FIG. 52. a solid state fluorescent lamp replacement input stage with heater emulation circuits is depicted which can receive power from a ballast output in accordance with some embodiments of the invention. Power is received from a ballast output, for example through bi-pins at each end of a linear FLR connected to tombstones in a fluorescent lamp fixture. Heater emulation circuits such as the parallel combinations of resistors 1188, 1192, 1196, 1200 and capacitors 1190, 1194, 1198, 1202 or other configurations and combinations of elements are included in various embodiments to enable the ballast to operate properly. Power from ballast outputs through the heater emulation circuits is AC coupled through capacitors 1182, 1184 to a rectifier 1180 to yield rectified power across nodes HV, LV. An input capacitor 1186 can be connected across the ballast outputs which provide the input power to the input stage. In some embodiments, the input capacitor 1186 can comprise a variable capacitor such as that depicted in FIG. 55 and discussed above which could comprise any number of fixed/constant and variable capacitors. Other elements can be included as desired, such as, but not limited to, inductors, fuses, EMI filters, etc.

Turning now to FIG. 53, a solid state fluorescent lamp replacement input stage with EMI filtering is depicted which can receive power from a ballast output or AC input in accordance with some embodiments of the invention. EMI filtering and output power control can be provided by capacitors 1214, 1220 and inductors 1216, 1218. Although the inductors are shown as being in series, the inductors including in the form of a choke can be also put in parallel depending on the implementation and especially so if the case where the AC input is from an electronic ballast output. The AC signal is rectified in diode bridge 1222, with output filtering provided by capacitor 1224 and inductor 1226.

Turning now to FIG. 54, a power supply circuit with output control is depicted that can be used in some embodiments of a solid state fluorescent replacement lighting system in accordance with some embodiments of the invention. A reference voltage as well as a voltage supply is generated by Zener diode 1232 and resistor 1230 from a rectified power signal HV, controlling switch 1236 to apply power to, for example, power the pulse generator 1240. In some embodiments, the output of pulse generator 1240 is conditioned by an optional gate EMI circuit including, for example, resistors 1242, 1246 and diode 1244. In some embodiments, resistor 1234 may consist or more than one resistor in series, parallel, combinations of series and parallel, etc. In some embodiments, resistor 1230 may consist or more than one resistor in series, parallel, combinations of series and parallel, etc. In some embodiments, resistor 1234 and transistor 1236 may be optional; in such embodiments, Zener diode 1232 may be connected to capacitor 1236. The switch 1236 can be operated to control a power converter such as, but not limited to, a buck converter comprising diode 1248, inductor 1252 and output capacitor 1254 to power a load in parallel with output capacitor 1254.

Note that in FIGS. 51-54, the AC lines can be tied to one set (side) of bi-pins for a linear fluorescent tube replacement (i.e., a FLR for T8s or T12s, etc.) which would be in parallel with, for example, one side for an instant start ballast and one set of heater emulation for a rapid start, programmed start, dimmable, and or prestart or, for example, magnetic ballast, respectively. Such implementations may be preferred for certain applications and agency approvals and listings. In other embodiments, the AC line can be connected so that one leg of the AC line is across each side of the linear tube replacement.

Turning to FIG. 55, a solid state fluorescent lamp replacement input stage with variable capacitance circuit is depicted in accordance with some embodiments of the invention. Such a variable capacitance circuit can connect capacitors (e.g., 1333, 1334) with, for example but not limited to, varying on time duty cycles to control and dim using conventional electronic ballasts. In the illustrative example embodiment of FIG. 55, an AC switch (e.g., transistors 1335, 1336) is/are used to adjust the on and off times of capacitors 1333, 1334. Note although two capacitors are shown, any number of capacitors from 1 to a practically large number can be used. In addition, one or more non-switched (i.e., static/fixed) capacitors in either series or parallel or combinations of these, etc. can be used with the variable capacitor or capacitors in some embodiments of the present invention. In other embodiments other components such as inductors and resistors can be used including in any configuration including but not limited to series, parallel, and/or other configurations, etc. can be used. In some embodiments one or more inductors maybe used in place of the one or more capacitors or both capacitors and inductors may be used. Power is received at AC input from a ballast output, AC mains or line, or any other suitable power source. A diode bridge 1332 or other rectifier can be used to rectify the input power, and can include any type or number of diodes, including multiple diodes in each leg of the bridge to provide the desired power handling capacity. Floating transistors 1335, 1336 surround a floating ground or common that can be used as a reference at various points of the system. Example signal conditioning components and/or EMI components can be included as desired, such as, but not limited to, capacitors 1338, 1340, 1342 and resistor 1339, as well as sensing components such as current sensing resistor(s) (e.g., 1341) that can be used, for example, to sense the current through output nodes 1343, 1344. Fuses (e.g., 1330, 1331) can also be included as desired. Signals other than pulse, PWM, on/off may also be used in some embodiments of the present invention.

Implementations of the present invention can also use combinations of example embodiments of the present invention—for example, a buck (or buck-boost, boost-buck, boost, fly back, forward converter, push-pull, etc.) can be combined with a the ballast current control and other example embodiments shown herein to achieve implementations that can be used with universal AC line voltage up from below 80 VAC to greater than 305 VAC and even 347 VAC and 480 VAC 50/60 Hz (and also 400 Hz) as well as magnetic ballasts and electronic ballasts, including but not limited to, instant start, rapid start, programmed start, programmable start, dimming ballasts, pre-start, etc. FIG. 55 shows an example of such a combined circuit that, in certain implementations, can also be locally or remotely controlled and dimmable. In FIG. 55, a buck circuit is used for low frequency operation (i.e., 50/60 or 400 Hz) and magnetic ballasts and the current control is used for electronic ballasts. The buck (or related switching circuit) can be used to control the current and/or voltage to the LED, OLED or QD load and by adjusting, for example, but not limited to the duty cycle of the buck or related switching circuit/topology (i.e., for example, the switching element, the output to the load could be dimmed or increased. The example embodiment shown in FIG. 55 consisting of a switching element and associated sense and measure circuitry to shunt current as needed or desired including for dimming while switching element could be either fully turned on or, depending on the implementation, fully turned off. The drain of the transistor or transistors can be attached to a point in front of a diode that can be used to block the shunting from directly affecting and shorting/shunting the output capacitor and load as discussed elsewhere in this document. Of course in some embodiments and implementations of the present invention, a buck (or buck-boost, boost-buck, boost, fly back, forward converter, push-pull, etc.) can be used for all types of magnetic and electronic ballasts as well as AC line voltage ranging from less than 80 VAC to greater than 480 VAC if desired. As discussed herein, other elements including but not limited to, EMI filters (consisting of, for example but not limited to, chokes, inductors, toroid inductors and chokes, two and four legged inductors, transformers, capacitors, diodes, resistors, other elements, etc.), OVP, OTP, SCP, OCP, shock hazard/pin safety, dimming, remote control and monitoring, color changing, color switching, etc. can be included into these and other implementations of the present invention. Embodiments of present invention are not restricted to the buck and can also be buck-boost, boost-buck, boost, fly back, forward converter, push-pull, etc. and include a shunt combination. Items such as snubbers and clamps, rectification bridges, gate networks (e.g., resistors and diodes, etc.), other components and connections, etc. have been left off as well as some of the details and connections for the control circuit labeled IC. The control circuit can use information, for example, including but not limited to about frequency and voltages to determine whether a low frequency ballast or AC line voltage or a high frequency ballast to determine the appropriate signals to apply to switches. In some embodiments and implementations of the combined buck (etc.) and shunt approach, a microcontroller or microcontrollers and/or DSP(s), FPGA(s), microprocessors, etc. can be used in place of or to, for example, augment and support the microcontroller(s), etc. A tagalong inductor (for which there could be one or more) such as those disclosed in U.S. patent application Ser. No. 13/674,072, filed Nov. 11, 2012 by Sadwick et al. for a “Dimmable LED Driver with Multiple Power Sources” can be used with embodiments of the present invention. It should be understood that one or more tagalong inductors could be incorporated into the example embodiment discussed and shown herein can contain tagalong inductors. It should be also understood that there many numerous variations of the example embodiments shown and discussed herein and nothing should not be construed or taken as limiting in any way or form.

Turning to FIG. 56, a PWM or one-shot controller is depicted that can be used to control the AC switch 1335, 1336 of FIG. 55 to regulate or turn off the output current and/or power. Optional capacitors 1352, 1353 can be used to couple to the AC input 1350, 1351, for example for use with instant start and also rapid start ballasts. In some embodiments, capacitors 1352, 1353 can be omitted or shorted out, for example with instant start/rapid start/programmed start/etc. electronic ballasts and magnetic ballasts. In other embodiments, for example, but not limited to, resistors and/or inductors can be put in series or parallel or both or combinations of series and parallel, etc. with the capacitors or one or more of the capacitors can be removed, etc. A rectifier 1354 and regulator 1355 provide regulated power to PWM controller 1356, which provides a pulse or ramp signal based on or controlled in part by a feedback voltage VFB. The rectifier 1354, as with other rectifiers disclosed herein, can include one or more diodes per leg in series or parallel or both, etc. The regulator 1355 can comprise a linear regulator, switching or combo regulator, etc. In some embodiments, resistor capacitor (RC), one or more resistor inductor (RL), resistor inductor capacitor (RLC), inductor capacitor (LC), etc. networks can be attached in series, parallel, combinations, etc. to each bi-pin output of the ballast to provide for heater/cathode simulation/emulation/etc. circuits. The PWM controller output is used to control transistors 1333, 1336 to vary the duty cycle of the input power, connected through buffer diode 1358 and resistors 1357, 1359.

Turning to FIG. 57, an example of a feedback control circuit to provide a constant output current or for other purposes using a setpoint reference signal is depicted in accordance with some embodiments of the invention. A linear regulator including Zener diode 302, BJT 1404 and resistors 1400, 1406 and capacitor 1408 can be used, or in other embodiments, switching or other regulators. A voltage divider 1410, 1412 provides a reference voltage to op-amps 1420, 1432 for feedback control, modified by sensors, external control inputs, variable resistors, etc. as desired (e.g., 1414). The feedback can have reversed or inverted polarities if desired. Time constants such as, but not limited to, that provided by resistor 1416, capacitor 1418 can be applied to the inputs and/or outputs of the op-amps 1420, 1432 or at any other points in the circuit. An opto-isolator 1460 can be used as an isolation or level-shifting circuit between the feedback control circuit and the output voltage feedback signal VFB. Although BJTs are depicted in the FIG. 57, virtually any type of transistor or switch with suitable properties including but not limited to MOSFETs, FETs, JFETs, GaNFETs, SiCFETs, HBTs, etc. may be used in place of, instead of, with, etc.

Turning to FIG. 58, a circuit schematic of an example embodiment of a solid state fluorescent lamp replacement is depicted where, among other things, shunting is used to set the solid state light output that can be remote controlled and monitored in accordance with some embodiments of the invention. Inputs 1550, 1552, 1554, 1556 represent the two (one on each side for a linear FL and both on the same side for, for example, a four pin PLC lamp) sets of bi-pins for, for example, a ballast and tombstone fluorescent lamp connection system/network. Input coupling components such as resistors 1558, 1560, 1564, 1566, 1570, 1572, 1576, 1578 and capacitors 1562, 1568, 1574, 1580 can be included as desired or needed to ensure proper operation of ballasts, for example to provide heater emulation. Fuses (e.g., 1582, 1584) can be included. One or more rectifiers 1586, 1588 can be included, as well as signal conditioning components and/or EMI components can be included as desired, such as, but not limited to, diodes 1590, 1592, capacitors 1598, 1600, as well as sensing components such as current sensing resistor(s) (e.g., 1594, 1596) that can be used, for example, to sense the current through output nodes 1602, 1604. Other components discussed herein may also be incorporated into FIG. 58 as appropriate.

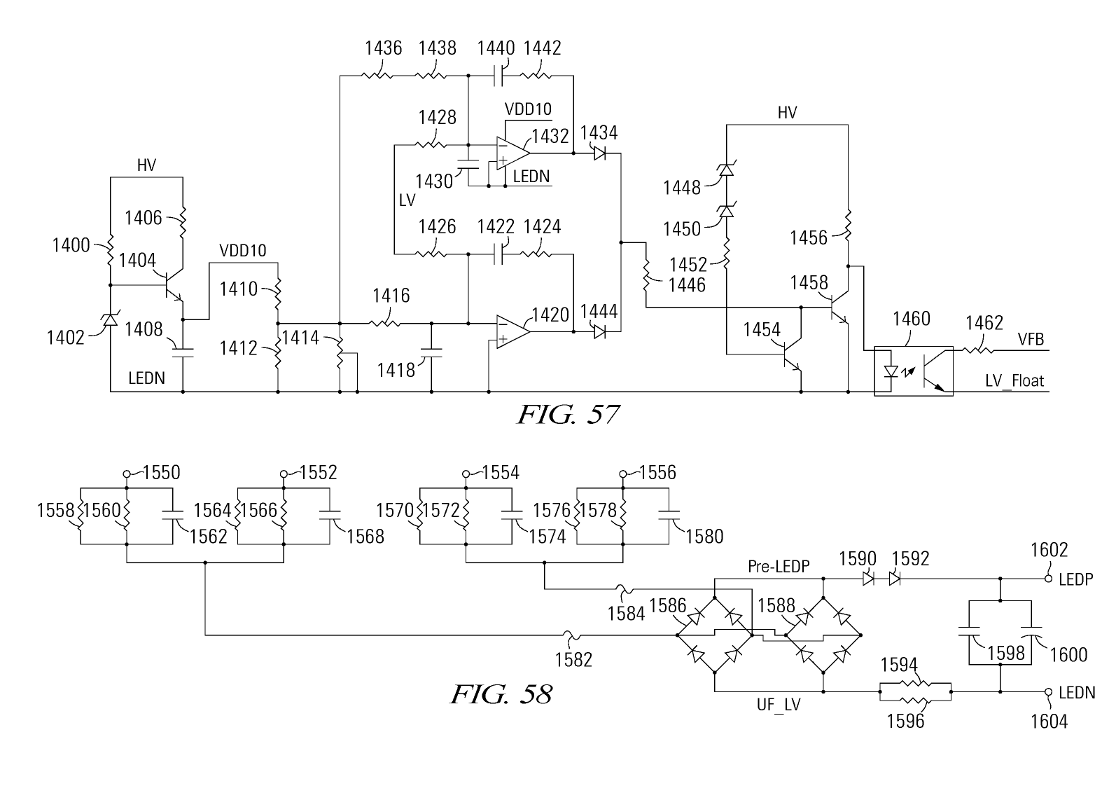

Turning to FIG. 59, an example embodiment of a control circuit is depicted that can be used with a solid state fluorescent lamp replacement in accordance with some embodiments of the invention. A regulator circuit (e.g., 1500, 1501, 1502, 1503, 1504, 1505, 1506, 1507, 1508, 1509, 1510, 1511, 1512, 1513, 1514) of any topology can be used to provide a power signal used to power the control circuit. Note that in some cases, multiple similar components are placed in series or parallel, for example to provide fault tolerance and power handling. Such techniques can be applied in any of the circuits disclosed herein as desired, or may be omitted.

Resistors 1516, 1517 and Zener diode 1518 along with optional capacitor 1515 form an example voltage reference (although other types of voltage references can be used to achieve a stable voltage reference including, but not limited to, bandgap references, precision voltage references, etc.). Resistors 1519, 1520 form a voltage divider that acts as a reference set point which could also be filtered by, for example, a capacitor (not shown) that is fed to the non-inverting terminal of a comparator 1522 (or similar function such as an op amp). The voltage from a sense resistor 1520 (e.g., the voltage across sense resistor 583 of FIG. 26) is fed to the inverting input of the comparator 1522 via an optional filter/time constant consisting of resistor 1520 and capacitor 1521 such that when the signal from the sense resistor is larger than the reference set point signal, the comparator 1522 goes low and provides a negative pulse.

The negative pulse from comparator 1522 is fed to an inverter made up of MOSFET 1526 and resistors 1523, 1524. A time constant can be included to control the rise and/or fall time at the gate of the MOSFET 1526. The inverter output is fed to the base of a Darlington pair made up of bipolar junction transistors 1529, 1530 which acts as a shunting transistor and which can be used to shunt any desired signal in the solid state lighting system, such as a point upstream from the load current output, e.g., node Pre-LEDP 578 of FIG. 26. With such an application, the circuit shunts the current of the rectified ballast output through the Darlington pair. In other embodiments of the present invention, other types of transistors, including but not limited to, MOSFETs, IGBTs, GaNFETs, SiCFETs, BJTs, etc. can be used in place of the Darlington transistor. Again, this shorts out the ballast and prevents current from reaching the load or capacitor 584, while diode 582 prevents capacitor 584 from being discharged and turning off the load. In the event that the current sensed is too high, then the output of the comparator 1522 (or op amp) goes low which results in turning on the Darlington pair 1529, 1530 (or other types of transistor(s)) to shunt the ballast output current. Other embodiments of the present invention may use different implementations, circuits, etc. that perform the same/similar function/operation, etc. Again, in general, embodiments of the present invention can use any type or form of circuit, implementation, design, etc.

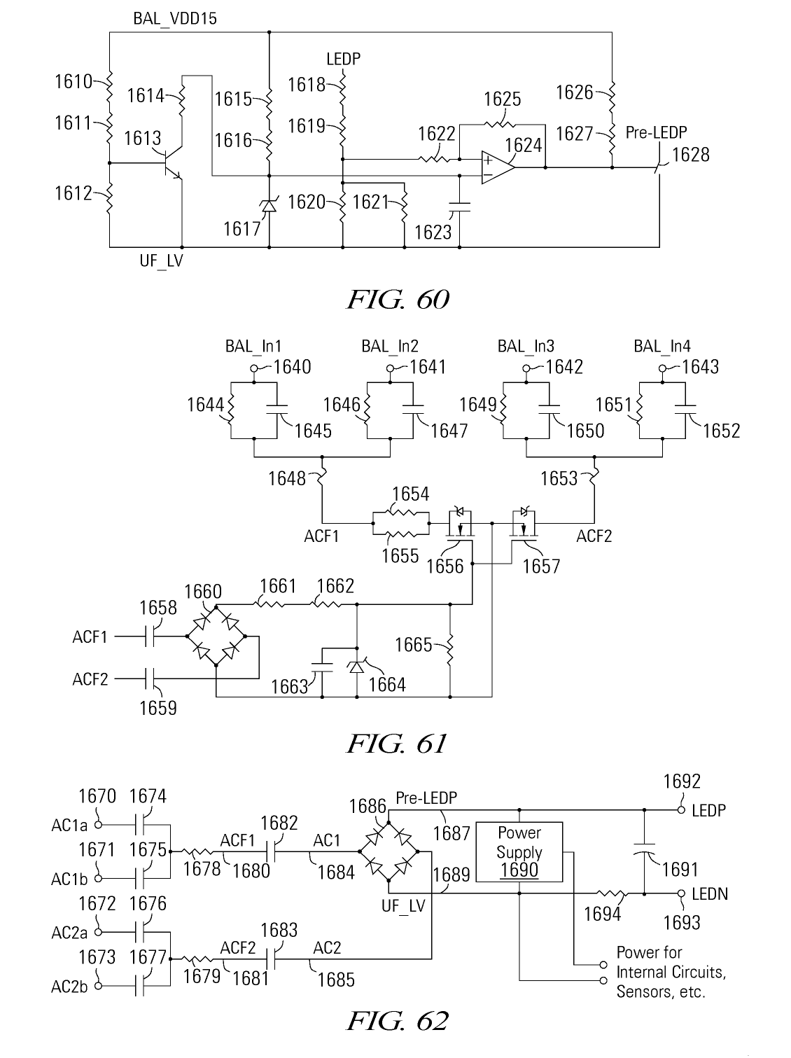

Turning to FIG. 60, an over-voltage protection and/or over-temperature protection circuit is depicted that can be used with a solid state fluorescent lamp replacement in accordance with some embodiments of the invention. An op-amp 1624 compares a reference voltage with a feedback voltage, with any suitable temperature-dependent voltage signals and over-voltage signals used to control a shunt switch 1628. The reference voltage can be generated, for example, by a linear regulator comprising BJT transistor 1613, voltage divider 1610, 1611, 1612, voltage divider 1614, 1615, 1616, Zener diode 1617 and capacitor 1623. The feedback voltage is generated, for example, from the SSL output voltage by voltage divider 1618, 1619, 1620, 1621. The amplification of op-amp 1624 can be controlled in any suitable manner, such as using resistors 1622, 1625. Pullup resistors 1626, 1627 and any other desired components can be included to provide time constants, filtering, buffering, amplification etc. In the over-voltage protection and/or over-temperature protection circuit. The over-voltage protection and/or over-temperature protection circuit can be used, for example, to shunt the load current through a switch 1628 such as, but not limited to, a Darlington pair or any other suitable switch.

Turning to FIG. 61, a ballast sequencing circuit with variable impedance circuit is depicted in accordance with some embodiments of the invention. Power is received from a ballast outputs 1640, 1641, 1642, 1643, for example through bi-pins at each end of a linear FLR connected to tombstones in a fluorescent lamp fixture. Heater emulation circuits such as the parallel combinations of resistors 1644, 1646, 1649, 1651 and capacitors 1645, 1647, 1650, 1652 or other configurations and combinations of elements are included in various embodiments to enable the ballast to operate properly. Optional fuses 1648, 1653 can be included to provide protection. Power from ballast outputs through the heater emulation circuits is AC coupled through capacitors 1182, 1184 to a rectifier 1180 to yield rectified power across nodes HV, LV. AC switch 1656, 1657 can be momentarily closed, connecting resistors 1654, 1655 to the ballast, providing a DC path between the ballast legs and enabling certain ballasts to operate properly. Power can be drawn from the fused AC nodes ACF1, ACF2 through AC coupling capacitors 1658, 1659 through diode bridge 1660. The rectified voltage can be further conditioned by resistors 1661, 1662, capacitor 1663, Zener diode 1664 and resistor 1665 to control the AC switch 1656, 1657 to momentarily close it at startup or at other times. Other elements can be included as desired, such as, but not limited to, inductors, fuses, EMI filters, etc., combinations of these, etc.

Turning to FIG. 62, a solid state lighting power supply is depicted that can draw power from a fluorescent lamp fixture to power a lighting system and to provide power for internal circuits, sensors or other applications in accordance with some embodiments of the invention. The power supply includes inputs 1670, 1671, 1672, 1673 for, for example, two pairs of bi-pin connections to a ballast via tombstones in a fluorescent lamp fixture. The power supply can include, for example, but not limited to one or more linear circuits, zero linear circuits, one or more switching circuits of virtually any topology including but not limited to non-isolated or isolated, combinations of these, etc. For example, but not limited to a non-isolated switching/storage circuit/power supply would be a buck (or boost, or boost-buck or buck-boost or others discussed herein) switching circuit that can be used with both a ballast or AC line which can also be optionally remote controlled and have features including OTP, OVP, SCP, dither, etc. and can be used with all types of ballasts including electronic rapid start, instant start, programmed start, preheat, magnetic, etc. that can be remote controlled and monitored and also has remote control/dimming Examples of isolated circuits include but are not limited to one or more of galvanic isolated circuits, flyback isolated circuits, forward converter isolated circuits, push-pull circuits, etc., combinations of these, etc. Input coupling capacitors 1674, 1675, 1676, 1677 and resistors/fuses 1678, 1679 as well as any other heating emulation approaches can be included along with, if desired, any other heater emulation or other input conditioning elements in any configuration. For example, one or more resistors can be connected in parallel with each of the input coupling capacitors 1674, 1675, 1676, 1677. One or more rectifiers 1686 can be included, as well as signal conditioning components and/or EMI components which can be included as desired, such as, but not limited to, output capacitor 1691, as well as sensing components such as current sensing resistor(s) (e.g., 1694) which can be used, for example, to sense the current through the output nodes LEDP 1692, LEDN 1693 which supply current to a solid state lighting load. An internal power supply 1690 of any topology can be used to draw power either from the ballast (if installed) or AC line to power internal circuits, sensors, etc. In some embodiments, the internal power supply 1690 can be used to generate power for internal circuits, sensors, etc. as well as external circuits, sensors, IOT, controls, communications, detectors, sirens, cameras, arrays, pattern, voice, sound, facial, etc. sensors, detectors, etc., combinations of these including but not limited to those discussed herein without impacting the constant current to the lighting output nodes LEDP 1692, LEDN 1693. In other embodiments of the present invention the current/power to the lamp may not be controlled and will depend on the ballast and the applications and uses of the present invention. In some embodiments of the present invention, the light output may not be directly controlled or regulated however the one or power supply 1690 with one or more isolated or non-isolated outputs may be used to provide internal and/or external power to sensors, IOT, controls, communications, etc., combinations of these, etc. including but not limited to those discussed herein using/with one or more of a fluorescent lamp ballast, a HID ballast of any type or lamp type, etc. including but not limited to electronic and magnetic ballasts for use with any type of gas discharge device including but not limited to any type of fluorescent, HID, Neon, etc. lamp ballast.

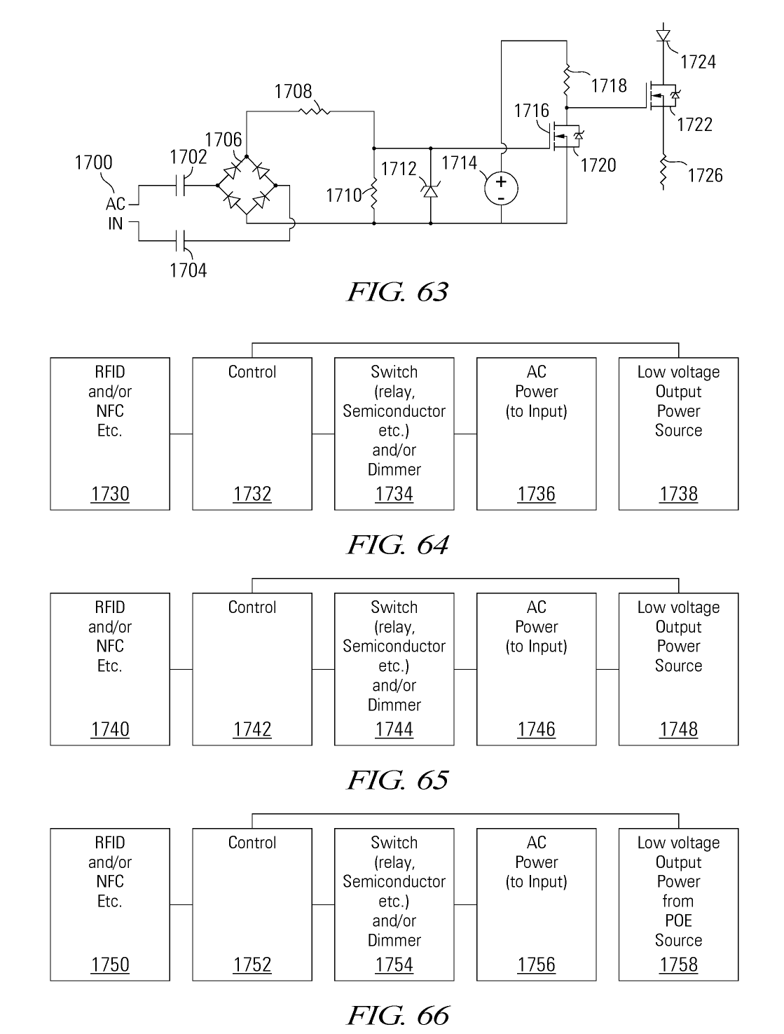

Turning to FIG. 63, a ballast detection circuit is depicted that can be used, for example, to gate other circuits such as to gate diode 1434 and/or diode 1444 in the feedback control circuit of FIG. 57 to detect and/or enable or disable power from a ballast output in accordance with some embodiments of the invention. A diode bridge 1706 rectifies power from an AC input 1700, optionally connected through AC coupling capacitors 1702, 1704, and a reference voltage is generated from the rectified power by Zener diode 1712 and voltage divider resistors 1708, 1710. The reference voltage controls a transistor 1716, which generates a control signal from any suitable source, such as a pullup resistor 1718 and any voltage supply (e.g., 1714) or reference voltage. The resulting control signal can be used to control a switch 1722, shunting current to gate off control signals or any other control points. For example, in some embodiments, the diode 1724 corresponds with either diode 1434 or 1444 of FIG. 57, shunting the output of either of those diodes 1434 or 1444 to a ground through resistor 1726 to disable power from a ballast output.

The diode bridge 1706 can be replaced in some embodiments with a half wave bridge or other such circuits including circuits that perform/provide rectification or circuits that pass AC and use the AC, including but not limited to the frequency of the AC, to determine whether a ballast is present or not, etc., and which provide a DC voltage which may be limited by Zener diode 1712 to the gate of transistor 1720 which in turns off transistor 1722 and thus, for example, but not limited to turning off and blocking the electrical path through diode 1724 as shown in FIG. 63. The gate signal at transistor 1720 can be used and fed to other devices and circuits to turn on enable when a ballast such as, but not limited to, a high frequency ballast is used to power embodiments and implementations of the present invention.

In some embodiments of the present invention, one or more time constants may be used to provide feedback and control. An example of such is shown in FIG. 57. In some implementations of the present invention it may be useful to turnoff or turn on one or more time constants or other feedback or control circuits when in the ballast powered mode of operation compared to the AC mode of operation. For such cases, a circuit such as that depicted in FIG. 63 may be used. The circuit depicted in FIG. 63 should not be taken to be limiting in any way or form.

Turning to FIGS. 64-66, block diagrams of identification circuits are depicted that can be used to identify solid state fluorescent lamp replacements in a solid state lighting system, powered by one or more of multiple sources in accordance with some embodiments of the invention. Some embodiments of the invention include Identification Switches 1730, 1740, 1750 with, for example but not limited to, RFID and/or NFC. Could have mechanical to electrical switch and/or gesturing, etc. that could, for example, but not limited to ZigBee to RFID, BTLE to RFID, etc. Control circuits 1732, 1742, 1752 interface with the FLRs, powered by any source, including but not limited to, power from the AC line 1736, 1746, 1756, power from one or more batteries, one or more solar cells of any type or form including to, but not limited to, inorganic, semiconductor, organic, quantum dot, etc., battery charger, vibration energy converter, RF converter, energy harvester of any type and source, etc., power of Ethernet, DC power sources, AC to DC conversion, etc., combinations of these, etc. The switch or actuator can be of any type including toggle, momentary, mechanical to electrical switch and/or gesturing, touch, capacitive sensing, etc. that could, for example, but not limited to also use ZigBee to RFID, BTLE to RFID, etc. WiFi to RFID, vice-versa, etc., two-way communications, etc. Embodiments of the present invention can also be powered by low voltage output power sources (e.g., 1738, 1748) including with power over Ethernet (POE) (e.g., 1758). Power switching and/or dimming 1734, 1744, 1754 can be of any known type including but not limited to electro-mechanical, reed, latching, other electrical and/or mechanical, solid state, etc., relay(s), triac, silicon controlled rectifier (SCR), transistor, etc., more than one of one, more than one of each, combinations of one, combinations of each, other combinations, etc.

Some embodiments of the invention include circuits to link to watches and in particular smart watches, wearable watches, health monitoring watches, FitBit, Apple. Nike, Android based smart watches and wearables, etc.

Some embodiments of the invention include circuits to link to watches and/or other types of wearables to interact with, control, dim, monitor, light and other systems.

Some embodiments of the invention include motion detectors for outdoor outside that can have motion sensor, ultrasonics, noise, etc. separate from the light source and connected via Bluetooth Smart, BLE, USB, use WEB and other info including but not limited to weather, wind, wind speed, could coordinate with other sensors, lights, etc. feedback information, etc.

Some embodiments of the invention includes lamps that can be all or partially screen printed, 3D printed, etc. including custom designs, customized designs, etc. using, for example, UL or CE approved, recognized, listed, etc. materials.

Some embodiments of the invention use proximity sensors and/or beacons, identifiers, etc. to identify who is near including by cellular/smart phone, smart watch, other Bluetooth devices, RFID, others, etc. and take appropriate actions including settings selection based on profile information stored, learned, taught, trained, memorized, etc, combinations of these, etc.

Some embodiments of the invention advertise and obtain Bluetooth and other ID, etc.

Some embodiments of the invention use display panels including but not limited to OLED panels, tablets, etc. as lighting panels.

Some embodiments of the invention use a synchronous bridge for the dimmer Some embodiments of the invention can also have a TRIAC that is, for example, but not limited to being in parallel with the diodes and transistors of embodiments of the present invention.

Some embodiments of the invention include motion sensing for either outdoor or indoor that can wirelessly, wired and/or powerline communications set, program, control, monitor, log, respond, alert, alarm, etc. including being able to be part of a cluster, group, community of lights, etc., that provides, for example, but not limited to, protection and security, etc., can, for example, but not limited to, detect a defective light, light (burned) out, can provide dimming, can use one or more colors of white, RGB, etc., can dim up and dim down, etc., Can control, set, program, sequence, synchronize, etc. all parameters including but not limited to distance, length of time on, sensitivity, ambient light level, response, synchronizing with outdoor and indoor motion sensors, response including but not limited to white color temperature and/or color choice(s), flashing or solid on, flashing, sequences of flashing, sequences of flashing and solid on, etc. of one or more colors including but not limited to one or more white colors, one or more white colors with one or more other colors, one or more colors,

Some embodiments of the invention include sensors in the light(s), sensors attached to and/or near the light(s), sensors remote from the lights including battery powered, AC powered, solar powered, energy harvested, battery charged, etc., combinations of these, etc., including, for example, but not limited to, solar power battery charging.

Some embodiments of the invention are adapted for use in stairwells, etc. especially ones that have doors to entry, use a device that makes a sound when the door is opened so that the light source ‘hears’ the sound and turns on. Can use any device, approach, method, etc. that can convey that the door is opened or someone has passed through the door including, for example, but not limited to, photoelectric beam and photoelectric eye, magnetic proximity switch, other types of detection of open door, etc., can use two tone or more tone frequency, etc.

Some embodiments of the invention can use active or passive or both high pass, low pass, bandpass, notch, other filters, combinations, etc. including with the voice, sound, noise detection.

Some embodiments of the invention can use isolated digital PWM that can be converted to analog near the control reference point.

Some embodiments of the invention can use proximity and/or signal strength to decide, for example, but not limited to turn on or off lights, etc.

Some embodiments of the invention can flash at the end of an allotted time to indicate that the next group is ready to use, for example, a conference room.

Some embodiments of the invention can listen for and respond to emergency sounds such as smoke, fire, carbon monoxide (CO), carbon dioxide (for, for example but not limited to, both health and occupancy information), etc. detectors, sensors, etc. by flashing, turning on, forwarding the information, alert, alarm, etc.

Some embodiments of the invention can be powered over Ethernet (POE), dimmed, controlled, monitored, logged, two way communicated with, data mined, analytics, etc. Can be powered, controlled, monitored, managed, etc. via wired or wireless or powerline control (PLC) including but not limited to serial communications, parallel communications, RS232, RS485, RS422, RS423, SPI, I2C, UART, Ethernet, ZigBee, Zwave, Bluetooth, BTLE, WiFi, cellular, mobile, ISM, Wink, powerline, etc., combinations of these, etc.

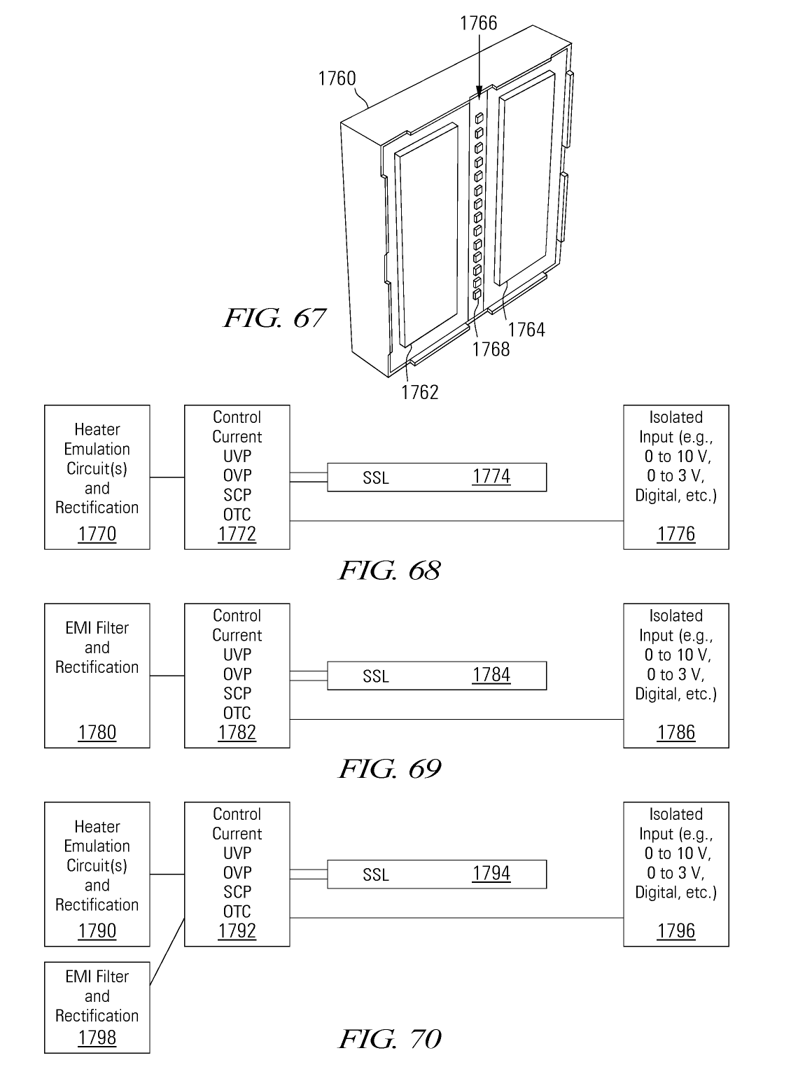

Turning to FIG. 67, a solid state lighting system is depicted with color controllable multiple light sources in accordance with some embodiments of the invention. For example, a solid state lighting system may include a solid state light fixture 1760 with multiple flat lighting panels 1762, 1764 (e.g., OLED panels) and multiple solid state point light sources 1766, such as LED 1768. The shape, layout, form factor, and types and numbers of light sources are merely examples and should not be viewed as limiting in any manner Embodiments of the present invention can also have lighting on the outside of, for example, the light bar, panel, etc. including direct lit, edge lit, back lit, etc. Some example embodiments are shown below which can also include one or multiple LEDs, OLEDs, QDs that can consist of one or more of white, red, green, blue, amber, yellow, orange, etc. In addition, such lighting can be used to convey information about the status of a situation including flashing lights which may convey emergency situations, etc. In some embodiments, the SSL can provide evening/night light using for example amber-orange-yellow SSLs including but not limited to LEDs and/or OLEDs that can be dimmed, flashed, color-changing, sound alarms, sequence, provide time of day and circadian rhythm and/or other health therapy or ailment alignment, information, etc. Some embodiments of the present invention can have light, motion, proximity, noise, sound RFID, NFC, etc. sensors that are either internal or external and connected by one or more of wired, wireless, powerline communications (PLC), etc.

Some embodiments of the present invention such as that in FIG. 67 can include LEDs. OLEDs, QDs, other SSLs, other types of lights, etc. combinations of these, etc. and can include combinations of flashing, sequencing, dimming, changing colors, individually and/or collectively, etc., sirens, alarms, alerts, web connectivity, wired, wireless and/or PLC, etc.

Turning to FIGS. 68-70, block diagrams of example embodiments of solid state lighting systems with isolated control inputs are depicted in accordance with some embodiments of the invention. The SSL systems can be powered by any suitable source(s), such as, but not limited to, a ballast output via heater emulation and rectification circuits(s) 1770, 1790 and/or AC inputs via EMI filter and rectification circuits(s) 1780, 1798. Power supply circuits 1772, 1782, 1792 can pass power through to solid state lights 1774, 1784, 1794 and can provide one or more of the functions disclosed herein, such as, but not limited to, current control, undervoltage protection (UVP), overvoltage protection (OVP), short circuit protection (SCP), over-temperature protection (OTP), etc. Dimming control signals, either or both wired and wireless, can be used to control the power supply circuits, including, for example, using isolated dimming inputs (e.g., 0 to 10 V, 0 to 3 V, digital, including wired and wireless including but not limited to those mentioned, discussed, listed, etc. herein, combinations of these, etc.) Other embodiments of the present invention can also monitor, log, store, access the web, the cloud, communicate with the Ethernet, mobile cellular carriers, etc., combinations of these, etc.

Some embodiments of the invention can include indoor and/or outdoor motion sensors. The lights and, for example, sensors can have auxiliary ports that allow both control signals and other types of sensors, detectors, features, functions, etc. including, for example, but not limited to, motion, sound, video, vision recognition, pattern recognition, etc., combinations of these, etc. The indoor and outdoor embodiments can be very similar except for weather-proof for outdoor uses. Embodiments of the present invention can use existing lighting fixtures, including those with or without motion sensing and make them motion sensing capable including having the motion sensing inside the light source or as an extension to the light source that can be plugged into the light source and control the turning on/off and dimming up/down of the light source(s), etc., other sensors, alarms, alerts, communications, etc. can be added to embodiments of the present invention as well as being capable of being compatible with existing/legacy lighting including, for example, but not limited to motion detection, security, photoelectric cell/dusk to dawn lighting, etc., combinations of these, etc., including for example but not limited to, detecting when a conventional, non-communicating motion detector light fixture turns on and wirelessly or wire (or, in some cases, PLC) reporting, communicating, logging, tracking, etc. such information, etc. Embodiments of the present invention can also completely set all parameters of the present invention including but not limited to, the light level, detection threshold, detection level, distance, proximity, etc., notify under what conditions, notify neighbors, etc., light level to turn on at, whether to flash or not, etc., detection, sniffing, identification, etc. of smart devices including but not limited to smart phones, cellular phones, tablets, smart watches, wrist watches, fitness, well being watches, other wearables, PDAs, mobile devices, RFID, wearables, sounds, noise, voice(s), one or more certain frequencies, other types of technologies that can be used in tandem, conjunction with the present invention, other signatures, signs, identification, etc., combinations of these. Embodiments of the present invention can use such information to decide or aid in deciding whether the detection is due to, for example, but not limited to, a friend or foe and an unidentified source or object, person, animal, wind, etc. Embodiments of the present invention can record, store, analyze, keep track of, for example, the frequency of such occurrences and incidents, including any new digital, electronic, or other information including unique information about the device or person, etc. such as cellular phone identifiers, RF/wireless IDs, names, user names, etc. In addition, embodiments and implementations of the present invention can use optical or other methods to act as a intruder alert system such that, for example, but not limited to, an optical beam that connects two or more of the present invention including, examples where the two or more embodiments of the present invention have direct line of sight to each other and effectively have a beam of light in between that is broken or disrupted, etc. Such a beam of light can be modulated with the user able to select one or more from a variety of modulations so as to make it more difficult to emulate the beam, etc. Such beam modulations and detection can be two or more way so as to add to the reliability and security, etc.

Some embodiments of the invention can be configured, controlled, monitored, etc., from/to smart devices using for example, but not limited to, Apps, laptops, desktops, servers, mobile and/or PDA devices of any type or form, combinations of these, etc.

Some embodiments of the invention can include motion sensors performing multiple duties—turning on/off lights, alerting that there are people there, heating or cooling spaces, burglar alarm, camera, image recognition, noise, voice, recognition, sound recognition, etc. accessories, thermal imagers, night vision, infrared cameras, infrared lit cameras, etc.

In some embodiments of the present invention, a small PWM pulse width can be the default pulse width such that the amount of power/current at the highest input voltage will limit the power applied without a signal to increase the pulse. This will allow a current/power limit in the event of, for example, a short circuit on the output since a small pulse to big pulse is needed for higher power in AC line voltage mode. The pulse width can be made larger by a circuit that measures the pulse width and allows the pulse width to increase until the desired current level is attained.

Some embodiments of the invention can include outdoor motion sensing with smart additional components, accessories, etc. Sense includes weather, including from any source such as a local weather station, personal weather station, web-based weather report, etc. Smart Motion sense can also dim, flash, change intensities, white colors, be color-changing, etc., communicate two or more way, etc., monitor weather locally, regionally, wind factor, have a wind indicator, etc., wind vane, wind generator, etc.

Implementations of the present invention are designed to be a cost-effective and complete solution that provides both forward and backward compatibility which is also ideal for retrofits and can use either wireless or wire (or both) communications.

Implementations of the present invention include comprehensive sensing and monitoring. Implementations of the present invention can be Web-based and/or WiFi-based (or other) and interface with smart phones, tablets, other mobile devices, laptops, computers, dedicated remote units, etc. and can support a number of wireless communications including, but not limited to, IEEE 802, ZigBee, Bluetooth, ISM, etc.

Implementations of the present invention can include, but not limited to, dimmers, drivers, power supplies of all types, switches, motion sensors, light sensors, temperature sensors, daylight harvesting, other sensors, thermostats and more and can include monitoring, logging, analytics, etc.

Embodiments of the present invention support and can include color changing, color tuning, etc. lights with numerous ways to interact with the lights.

Embodiments of the present invention can be integrated with video, burglar, fire alarm, etc. components, systems.

Other features and functions include but are not limited to detecting the frequency using a microprocessor, microcontroller, FPGA, DSP, etc. Use a switch including, for example, a transistor such as a field effect transistor (FET) such as a MOSFET or JFET to, for example, either turn on or turn off a circuit that operates in either ballast mode or AC line mode depending on the amplitude of the signal or with the inclusion of a time constant, the average, RMS, etc. voltage level. Embodiments of the present invention removes the requirement that a reference level and a comparison to the reference level is required to detect the amplitude of the waveform

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc.

The present invention can also provide two or more side (multi-side) lighting for example, for a FLR where one side contains SSL that, for example, consists of white color or white colors of one or more color temperatures and another side contains SSL or other lighting of one or more wavelengths such as red, green, blue, amber, white, yellow, etc., combinations of these, subsets of these, etc. The two or more sided lighting can perform different functions—for example, the side that is primarily white or all white light of one or more color temperatures can provide primary lighting whereas the side that has one or more color/wavelengths of light can provide indication of location, status, code level in, for example, a hospital (i.e., code red, code blue, code yellow, etc.), accent lighting, mood lighting, location indication, emergency information and direction, full spectrum lighting, etc.

The present invention can work with all types of communications devices including portable communications devices worn by individuals, walkie-talkie types of devices, etc.

The present device can use combinations of wireless and wired interfaces to control and monitor; for example for a linear or other fluorescent replacement for, for example, but not limited to, T4, T5, T8, T9, T10, T12, etc., one (or more) of the replacement lamps can be wireless with wired connections from the one (or more) replacement lamp(s) to the other replacement lamps such that the one or more wireless replacement lamps acts as a master receiving and/or transmitting information, data, commands, etc. wirelessly and passing along or receiving information, data, commands, etc. from the other remaining wired slaved units. In other embodiments one or more wired masters/leaders may transfer, transmit, or receive, etc. information, data, commands from other wireless and/or wired equipped fluorescent lamp replacements, etc. of combinations of these.

The present invention can also have one or more thermometers, thermostats, temperature controllers, temperature monitors, etc., combinations of these, etc. that can be wirelessly or wired interfaced controlled, monitored, etc. Such one or more thermometers, thermostats, temperature controllers, temperature monitors, etc., combinations of these, etc. can be connected/interfaced, for example, but not limited to, by Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, UART, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

In some embodiments of the present invention, the thermometer(s) and/or thermostats may be remotely located. In other embodiments of the present invention, such a temperature sensor or sensors or thermostat or thermostats can use wireless or wired units, interfaces. protocols, device, circuits, systems, etc. In some embodiments the thermometer(s) and/or thermostat(s) can communicate with each other and relay, share, and pass commands as well as provide information and data to one another.

In addition, embodiments of the present invention can use switches that are remotely controlled and monitored to detect the use of power or the absence of power usage, to open or close garage or other doors by locally and/or remotely sending signals to garage door openers including acting as a switch to complete detection circuits, remembering the status of garage door opening or closing, working with other motion sensors, photosensors, etc. horizontal/vertical detectors, inclinometers, etc., combinations of these, etc. Embodiments of the present invention can both control and monitor the status of the garage or other door and sound alarms, send alerts, flash lights including flashing white lights and/or one or more color/wavelength lights, turn on lights, turn off lights, activate cameras, record video, images, sounds, voices, respond to sounds, noise, movement, include and use microphones, speakers, earphones, headphones, cellular communications, etc., other communications, combinations of these, etc. Such embodiments and implementations can use Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc., relays, switches, transistors of any type and number, etc., combinations of these, etc.

The present invention also allows various types of radio frequency (RF) devices such as, but not limited to, window shades, drapes, diffusers, garage door openers, cable boxes, satellite boxes, etc. to be controlled and monitored by replacing and integrating these functions into implementations of the present invention including being able to synthesize and reproduce the RF signals which are typically in the range of less than 1 kHz to greater than 5 GHz using one or more RF synthesizers including ones based on phase lock loops and other such frequency tunable and adjustable circuits with may also employ frequency multiplication, amplification, modulation, etc., combinations of these, etc., amplitude modulation, phase modulation, pulses, pulse trains, combinations of these, etc.

A global positioning system (GPS) can be included in the present invention to track the location and, for example, to also make decisions as to where and when the present invention should do certain things including but not limited to turning on or off, dimming, turn on heat or cooling, control and monitor the lighting, etc., control, water, monitor the lawn and other plants, trees etc.

Embodiments of the present invention can use/incorporate/include/etc. thermal imagers including but not limited to IR imagers, IR imaging arrays, non-contact temperature measurements including point temperature and array temperature measurements including in lighting such as T8 replacements where the imagers are powered, for example, but not limited to the ballast.

Embodiments of the present invention allow for dimming with both ballasts and AC line voltage.

Implementations of the present invention can use, but are not limited to, Bluetooth, Bluetooth low energy, WiFi, IEEE 801, IEEE 802, ZigBee, Zwave, other 2.4 GHz and related/associated standards, protocols, interfaces, ISM, other frequencies including but not limited to, radio frequencies (RF), microwave frequencies, millimeter-wave frequencies, sub millimeter-wave frequencies, terahertz (THz), mobile cellular network connections, combinations of these. Wired connections, interfaces, protocols, etc. include but are not limited to, serial, parallel, SPI, I2C, RS232, RS485, RS422, other RS standards and serial standards, interfaces, protocols, etc. powerline communications, interfaces, protocols, etc. including both ones that work on DC and/or AC, DMX, DALI, 0 to 10 Volt, other voltage ranges including but not limited to 0 to 3 Volt, 0 to 5 Volt, 1 to 8 Volt, etc.

Embodiments of the present invention include SSL/LED Direct Fluorescent Tube Lamp Replacements that can be used, for example, but not limited to, for daylight harvesting/occupancy uses and applications.

Embodiments of the present invention uses wireless signals to both control (i.e., dim) the LED fluorescent lamp replacements (FLRs) and monitor the LED current, voltage and power. The present invention includes but is not limited to fluorescent lamp replacements that work directly with existing electronic ballasts and requires no re-wiring and can be installed in the same amount of time or less than changing a regular fluorescent lamp tube. These smart/intelligent LED FLRs are compatible with most daylight harvesting controls and protocols. Optional sensors allow for relative light output to be measured and wirelessly reported, monitored, and logged permitting analytics to be performed. Embodiments of the present invention come in a diversity of lengths including but are not limited to two foot and four foot T8 standard/nominal linear lengths as well as T12. Additional optional input power measurements allow total power usage, power factor, input current, input voltage, input real and apparent power to also be measured thus allowing efficiency to be measured. The wireless signals can be radio signals in the industrial, scientific and medical (ISM) for lower cost and simplicity or ZigBee, ZWave, IEEE 802, or WiFi or Bluetooth or any type of form. In addition to occupancy/motion sensors, photo sensors and daylight harvesting controls, simple and low cost interfaces that allow existing other brands, makes, and models of daylight harvesting controls, photo sensors, occupancy/motion sensors to be connected to and control/dim embodiments of the wireless SSL/LED FLRs. The SSL FLR can be switched on and off millions of times without damage as well as be dimmed up and down without damage. The wireless communications can be encrypted and secure. Such embodiments of the present invention FLRs do not require or need a dimmable ballast and work with virtually any T8 electronic ballast from all major ballast manufacturers (optionally with most T12 electronic ballasts).

The present invention can have integrated motion sensor as part of the housing and can also use auxiliary motion sensors and can also have integrated light/photocell sensor as well as auxiliary.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

Embodiments of the present invention permits enhanced circadian rhythm alignment and maintenance using sources of light. Such sources of light include, but are not limited to, computer screens, monitors, panels, etc., tablet screens, smart phone screens, etc., televisions (TVs), LCD and CRT displays of any type or form, DVD and other entertainment lighting and displays containing LEDs, OLEDs, CCFLs, FLs, CRTs, etc., displays, monitors, TVs, OLED, LED, CCFL, FL, incandescent lighting, etc.

The present invention can use smart phones, tablets, computers, dedicated remote controls, to provide lighting appropriate for circadian rhythm alignment, correction, support, maintenance, etc. that can be, for example, coordinated wake-up and sleep times whether on a ‘natural’ or shifted (i.e., night workers, shift workers, etc.) to set and align their sleep patterns and circadian rhythm to appropriates phases including time shifts and time zone shifts due to work and other related matters.

The present invention can use external and internal information gathered from a number of sources including clocks, internal and external lighting, time of the year, individual, specific input, physiological signals, movements, monitoring of physiological signals, stimuli, including but not limited to, EEG, melatonin levels, urine, wearable device information, sleep information, temperature, body temperature, weather conditions, etc., combinations of these, etc.

The present invention can use TVs essentially of any type or form, including, but not limited to smart TVs, and related and similar items, products and technologies including, but not limited to, computer and other monitors and displays that can either be remotely or manually controlled and, in some embodiments, monitored. The present invention can use smart phones, tablets, PCs, remote controls including programmable remote controls, consoles, etc., combinations of these etc., to control and set the content of the lighting (e.g., white or blue-enriched, etc. combinations of these, etc. for wake-up; yellow, amber, orange, red, etc., combinations of these, etc. for sleep-time, etc.) automatically to assist in circadian rhythm, sleep, SAD mitigation, reduction, elimination, etc. In some embodiments of the present invention, music, sounds, white noise, sea shore sounds, sound effects, narratives, live audio, inspirational audio including previously recorded, generated, synthesized, etc., soothing sounds, familiar sounds and voices, etc. and combinations of these to go to sleep with. Jarring, buzzing, alarming, beeping, interrupting sounds, alarm clock sounds and noises, sleep disruptive sounds, noises and/or voices, etc. accompanied by white light, blue color/wavelength light including, but not limited to, slowing dimming up to a preset, optimum, and/or maximum brightness or setting, etc. for wake-up in the morning. Embodiments of the present invention can provide multiple wake-ups to the same location and/or different locations including other locations in homes, houses, hotels, hospitals, dormitories including school and military and other types of barracks, dormitories, etc., assisted living homes and facilities, chronic care facilities, rehabilitation facilities, etc., children's hospitals and care facilities, etc. group living, elder living, etc., children's rooms and other family members whether in the same physical location or in different physical locations, friends and family, clients, guests, travelers, jet lagged and sleep deprived people and personnel, etc.

The present invention can have integrated motion sensor as part of the housing and can also use auxiliary motion sensors and can also have integrated light/photocell sensor as well as auxiliary. In some embodiments of the present invention, these can be stand-alone units that replace conventional fluorescent lamps including, but not limited to, T8, T12, T5, T10, T9, U-shaped, CFLs, etc. of any length, size and power as well as high intensity discharge lamps of any size, type, power, etc.

The present invention can also respond to proximity sensors including passive or active or both, as well as voice commands and can be used to turn on, turn off, dim, flash or change colors including doing so in response to an emergency situation. The present invention can use wireless, wired, powerline, combinations of these, etc., Bluetooth, RFID, WiFi, ZigBee, ZWave, IEEE 801, IEEE 802, ISM, etc. In addition the present invention can be connected to fire alarms, fire alarm monitoring equipment, etc.

The present invention can use a BACNET to wireless converter box or BACNET to Bluetooth including Bluetooth low energy (BLE) converter. The present invention can also use infrared signals to control and dim the lighting and other systems as well as other types of devices including but not limited to heating and cooling, thermostats, on/off switches, other types of switches, etc.

The present invention can have the motion proximity sensor send signals back to the controller/monitor or other devices including but not limited to cell phones, smart phones, tablets, computers, laptops, servers, remote controls, etc. when motion or proximity is detected etc. Embodiments of the present invention can have on/off switches for the ballasts where the ballasts connect to the AC lines and/or also where the ballasts connect to the present invention, etc.

Embodiments and implementations of the present invention allow for optional add-ons including but not limited to wired, wireless or powerline control which, for example, could be installed or added later and interfaced to the present invention as well as allowing sensors such as daylight harvesting/photo/light/solar/etc. sensors as well as motion/PIR/proximity/other types of motion, distance, proximity, location, etc., sensors, detectors, technologies, etc., combinations of these, etc. to be used with the present invention.

The present invention provides a means to improve circadian rhythm by providing the appropriate wavelengths of light at appropriate times.

Internal and external photosensors including wavelength specific or the ability to gather entire or partial spectrum, etc. and can use atomic clock(s) signals, other broadcast time signals, cellular phone, time, smart phone, tablet, computers, personal digital assistants, etc., remote control via dedicated units, smart phones, computers, laptops, tablets, etc.

The present invention can also have sirens, microphones, speakers, earphones, headphones, emergency lights, flashing lights, fans, heaters, sensors including, but not limited to, temperature sensors, humidity sensors, moisture sensors, noise sensors, light sensors, spectra sensors, infrared sensors, ultraviolet sensors, speech sensors, voice sensors, motion sensors, acoustic sensors, ultrasound sensors, RF sensors, proximity sensors, sonar sensors, radar sensors, etc., combinations of these, etc. The sound and/or noise sensors as well as other sensors, etc. can use one or more filters including one or more low pass, high pass, notch, bandpass including narrow bandpass filters, etc. Such filters can be realized by either or both analog and digital means, approaches, ways, functions, circuits, etc., combinations of these, etc. Such filter functions can be active or passive or both, can be manually and/or automatically set and adjustable, can be set, adjusted, programmed, etc. by an app, by other types and forms of software and hardware, by smart phone(s), tablet(s), laptops, servers, computers, other types of personal digital assistant(s), etc.

Embodiments of the present invention can have more than one wavelength or color of LEDs and/or SSLs and can include more than one array of LEDs, OLEDs, QDs, etc. that permit color selection, color blending, color tuning, color adjustment, etc. Embodiments of the present invention can include multiple arrays that can be switched on or off or in or out and/or dimmed with either power being supplied by a ballast or the AC line that can be remotely selected, controlled and monitored. Examples of the present invention include different wavelengths, combinations of colors and phosphors, etc. are used to obtain desired performance, effects, operation, use, etc. Embodiments can include one, two, three or more arrays of SSLs, including, but not limited to, side-by-side, 180 degrees from each other, on opposite sides, on multiple sides for example hexagon or octagon, etc. The SSLs including but not limited to LEDs, OLEDs, QDs, etc. may be put in series, parallel or combinations of series and parallel, parallel and series, etc. In other embodiments of the present invention, phosphors, quantum dots, and other types of light absorbing/changing materials that for example can effectively change wavelengths, colors, etc. for example by applying a voltage bias or electric field. The present invention can also take the form of linear fluorescent lamps from less than 1 foot to more than 8 feet in length and may typically be T4, T5, T8, T9, T10, T12, etc. Such embodiments of the present invention may use an insulating housing made from, for example but not limited to, glass or an appropriate type of plastic, which may or may not have a diffuser or be a diffuser in terms of the plastic. In some embodiments of the present invention plastic housings may be used that can include diffusers on the entire surface, diffusers on half the surface, diffusers on less than half the surface, diffusers on more than half of the surface, with the rest of the surface either being clear plastic, opaque plastic or a metal such as aluminum or an aluminum alloy.

Photon/wavelength conversion including down conversion can be used with the present invention including being able to adjust the photon/wavelength conversion electrically. Spectral/spectrum sensors can be used to detect the light spectral content and adjust the light spectrum by turning on or off certain wavelengths/colors of SSL. The spectral sensors could consist of color/wavelength sensitive detectors covering a range of colors/wavelengths of filters that only each only permit a certain, typically relatively narrow, range of wavelengths to be detected. As an example, red, orange, amber, yellow, green, blue, etc. color detectors could be included as part of the spectral/spectrum sensor or sensors. In some embodiments of the present invention, quantum dots can be used as part of and to implement the spectral/spectrum sensors.

Implementations of the present invention can include and consist of any number and arrangement of smart dimmers (by wired, wireless, powerline communications, etc. combinations of these, etc.) including ones that connect directly to the AC power lines that can control, but are not limited to, one or more of, for example, but not limited to, as an example, FLRs, A-lamps, PAR 30, PAR 38, PLC lamps, R20, R30, dimmable compact florescent lamps, incandescent bulbs, halogen bulbs, etc. as well as smart dimmable (i.e., by wired, wireless, powerline communications, etc., combinations of these, etc.), infrared controlled devices including heaters of any type or form, air conditioners of any type or form, color-changing, color-tunable, white color-changing, lighting of any type including but not limited to those discussed herein. Non-dimmable lamps and appliances and entertainment device can also be included in such implementations of the present invention and may be turned on and off by one or more of the smart on/off switches or a dimmer that is, for example, but not limited to, programmed to full on and full off only, etc. Such implementations of the present invention can also use one or more or all of the sensors, detectors, processes, approaches, etc. discussed herein and well as any other type or types of sensors, detectors, controls, etc. The smart lighting, dimmers, power supplies, sensors, controls, etc. can you any type or types of wired, wireless, and/or powerline communications. Any practical number of dimmers, lights, lighting, sensors, detectors, controls, monitoring, logging, analytics, heaters, air conditioners, fire, safety, burglar alarm(s), burglar protection, etc., appliances, entertainment devices, home safety, personal safety, thermometer(s), thermostat(s), humidifier(s), etc.

The present invention may use any type of circuit, integrated circuit (IC), microchip(s), microcontroller, microprocessor, digital signal processor (DSP), application specific IC (ASIC), field gate programmable array (FPGA), complex logic device (CLD), analog and/or digital circuit, system, component(s), filters, etc. including, but not limited to, any method to provide a switched signal such as a PWM drive signal to the switching devices. In addition, additional voltage and/or current detect circuits may be used in place of or to augment the control and feedback circuits.

Some embodiments of the present invention can accept the output of a fluorescent ballast replacement that is designed and intended for a LED Fluorescent Lamp Replacement that is remote dimmable and can also be Triac, Triac-based, forward and reverse dimmer dimmable and incorporates all of the discussion above for the example embodiments. The remote fluorescent lamp replacement ballast can use or receive control signals/commands from, for example, but not limited to any or all of wired, wireless, optical, acoustic, voice, voice recognition, motion, light, sonar, gesturing, sound, ultrasound, ultrasonic, mechanical, vibrational, and/or PLC, etc., combinations of these, etc. remote control, monitoring and dimming, motion detection/proximity detection/gesture detection, etc. In some embodiments, dimming or/other control can be performed using methods/techniques/approaches/algorithms/etc. that implement one or more of the following: motion detection, recognizing motion or proximity to a detector or sensor and setting a dimming level or control response/level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. sonar, light, mechanical, vibration, detection and sensing, etc. Some embodiments may be dual or multiple dimming and/or control, supporting the use of multiple sources, methods, algorithms, interfaces, sensors, detectors, protocols, etc. to control and/or monitor including data logging, data mining and analytics. Some embodiments of the present invention may be multiple dimming or control (i.e., accept dimming information, input(s), control from two or more sources).

Remote interfaces include, but are not limited to, 0 to 10 V, 0 to 2 V, 0 to 1 V, 0 to 3 V, etc., RS 232, RS485, DMX, WiFi, Bluetooth, ZigBee, IEEE 802, two wire, three wire, SPI, I2C, PLC, and others discussed in this document, etc. In various embodiments, the control signals can be received and used by the remote fluorescent lamp replacement ballast or by the LED, OLED and/or QD fluorescent lamp replacement or both. Such a Remote Controlled Florescent Ballast Replacement can also support color LED Fluorescent Lamp Replacements including single and multi-color including RGB, White plus red-green-blue (RGB) LEDs or OLEDs or other lighting sources, RGB plus one or more colors, red yellow blue (RYB), other variants, etc. Color-changing/tuning can include more than one color including RGB, WRGB, RGBW, WRGBA where A stands for amber, etc. 5 color, 6 color, N color, etc. Color-changing/tuning can include, but is not limited to, white color-tuning including the color temperature tuning/adjustments/settings/ etc., color correction temperature (CCT), color rendering index (CRI), etc. Color rendering, color monitoring, color feedback and control can be implemented using wired or wireless circuits, systems, interfaces, etc. that can be interactive using for example, but not limited to, smart phones, tablets, computers, laptops, servers, remote controls, etc. The present invention can use or, for example, make, create, produces, etc. any color of white including but not limited to soft, warm, bright, daylight, cool, etc. Color temperature monitoring, feedback, and adjustment can be performed in such embodiments of the present invention. The ability to change to different colors when using light sources capable of supporting such (i.e., LEDs, OLEDs and/or QDs including but not limited to red, green, blue, amber, white LEDs and/or any other possible combination of LEDs and colors). Embodiments of the present invention has the ability to store color choices, selections, etc. and retrieve, restore, display, update, etc. these color choices and selections when using non-fluorescent light sources that can support color changing. Embodiments of the present invention also have the ability to change between various color choices, selections, and associated inputs to do as well as the ability to modulate the color choices and selections.

A further feature and capability of embodiments of present invention is use of passive or active color filters and diffusers to produce enhanced lighting effects.

In addition, protection can be enabled (or disabled) by microcontroller(s), microprocessor(s), FPGAs, CLDs, PLDs, digital logic, etc. including remotely via wireless or wired connections, based on but not limited to, for example, a sequence of events and/or fault or no-fault conditions, sensor, monitoring, detection, safe operation, etc. An example of protection detection/sensing can include measuring/detecting/sensing lower current than expected due to, for example, a human person being in series with (e.g., in between) one leg of the LED, OLED and/or QD replacement fluorescent lamp and one side of the power being provided by the energized ballast. The present invention can use microcontroller(s), microprocessor(s), FPGA(s), other firmware and/or software means, digital state functions, etc. to accomplish protection, control, monitoring, operation, etc.

In addition to using a switching element, a linear regulation/ regulator instead of switching regulation/regulator can be used or both linear and switching regulation or combinations of both can be used in embodiments of the present invention.

Rapid start ballasts with heater connections may be made operable using resistors and/or capacitors. Certain implementations require less power and also evenly divide and resistance or reactive (e.g., capacitive and/or inductive) impedances so as to reduce or minimize power losses for the current supplied to the fluorescent lamp replacement(s). An example when having power supplied from an instant start or other ballast without heater(s) with only one electrical connection per ‘side’ of the fluorescent tube/lamp or fluorescent tube replacement (for a total of two connections) the resistors are effectively put into parallel thus reducing the resistance by a factor of four compared to being in serial for, for example, a heater emulation circuit or as part of a heater emulation circuit. Such heater circuits can contain resistors, capacitors, inductors, transformers, transistors, switches, diodes, silicon controlled rectifiers (SCR), triacs, other types of semiconductors and ICs including but not limited to op amps, comparators, timers, counters, microcontroller(s), microprocessors, DSPs, FPGAs, ASICs, CLDs, AND, NOR, Inverters and other types of Boolean logic digital components, combinations of the above, etc.

In some embodiments of the present invention, a switch may be put (at an appropriate location) in between the ballast output and the fluorescent lamp/fluorescent lamp replacement such that there is no completion of current flow in the fluorescent lamp replacement to act as a protection including shock hazard protection for humans and other living creatures in the event of an improper installation or attempt at or during installation. The detection of a such a fault or improper installation can be done by any method including analog and/or digital circuits including, but not limited to, op amps, comparators, voltage reference, current references, current sensing, voltage sensing, mechanical sensing, etc., microcontrollers, microprocessors, FPGAs, CLDs, wireless transmission, wireless sensing, optical sensing, motion sensing, light/daylight/etc. sensing, gesturing, sonar, infrared, visible light sensing, etc. A microprocessor or other alternative including, but not limited to, those discussed herein may be used to enable or disable protection and may be combined with other functions, features, controls, monitoring, etc. to improve the safety and performance of the present invention including before, during, after dimming, etc.

In embodiments of the present invention that include or involve buck, buck-boost, boost, boost-buck, etc. inductors, one or more tagalong inductors such as those disclosed in U.S. patent application Ser. No. 13/674,072, filed Nov. 11, 2012 by Sadwick et al. for a “Dimmable LED Driver with Multiple Power Sources”, which is incorporated herein for all purposes, may be used and incorporated into embodiments of the present invention. Such tagalong inductors can be used, among other things and for example, to provide power and increase and enhance the efficiency of certain embodiments of the present invention. In addition, other methods including charge pumps, floating diode pumps, level shifters, pulse and other transformers, bootstrapping including bootstrap diodes, capacitors and circuits, floating gate drives, carrier drives, etc. can also be used with the present invention.

The present invention can work with programmable soft start ballasts including being able to also have a soft short at turn-on which then allows the input voltage to rise to its running and operational level can also be included in various implementations and embodiments of the present invention.

Some embodiments of the present invention utilize high frequency diodes including high frequency diode bridges and current to voltage conversion to transform the ballast output into a suitable form so as to be able to work with existing AC line input PFC-LED circuits and drivers. Some other embodiments of the present invention utilize high-frequency diodes to transform the AC output of the electronic ballast (or the low frequency AC output of a magnetic ballast into a direct current (DC) format that can be used directly or with further current or voltage regulation to power and driver LEDs for a fluorescent lamp replacement. Embodiments of the present invention can be used to convert the low frequency (i.e., typically 50 or 60 Hz) magnetic ballast AC output to an appropriate current or voltage to drive and power LEDs using either or both shunt or series regulation. Some other embodiments of the present invention combine one or more of these. In some embodiments of the present invention, one or more switches can be used to clamp the output compliance current and/or voltage of the ballast. Various implementations of the present invention can involve voltage or current forward converters and/or inverters, square-wave, sine-wave, resonant-wave, etc. that include, but are not limited to, push pull, half-bridge, full-bridge, square wave, sine wave, fly-back, resonant, synchronous, etc.

For the present invention, in general, any type of transistor or vacuum tube or other similarly functioning device can be used including, but not limited to, MOSFETs, JFETs, GANFETs, depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

The example figure and embodiments shown in herein are merely intended to provide some illustrations of the present inventions and not limiting in any way or form for the present inventions.

Using digital and/or analog designs and/or microcontrollers and /or microprocessors any and all practical combinations of control, protection, sequencing, levels, etc., some examples of which are listed below for the present invention, can be realized.

In addition to these examples, a potentiometer or similar device such as a variable resistor may be used to control the dimming level. Such a potentiometer may be connected across a voltage such that the wiper of the potentiometer can swing from minimum voltage (i.e., full dimming) to maximum voltage(i.e., full light). Often the minimum voltage will be zero volts which may correspond to full off and, for the example embodiments shown here, the maximum will be equal to or approximately equal to the voltage on the negative input of, for example, a comparator.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in patent application 61/652,033 filed on May 25, 2012, for a “Dimmable LED Driver”, which is incorporated herein by reference for all purposes.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or kilowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), provide data monitoring, data logging, analytics, analysis, etc. including, but not limited to, input and output current, voltage, power, phase angle, real power, light output (lumens, lux), dimming level if appropriate, kilowatt hours (kWH), efficiency, temperature including temperatures of components, driver, LED or OLED array or array or strings or other types of configurations and groupings, etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, DALI, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, Bluetooth, etc.), powerline (PLC) including X-10, Insteon, HomePlug, etc.), etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters including but not limited to push-pull, single and double forward converters, current mode, voltage mode, current fed, voltage fed, etc. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc. It should be noted that the various blocks shown in the drawings and discussed herein may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load. In addition to capacitors, inductors and resistors may also be used in some embodiments of the present invention.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

The present invention may be used in conjunction with dimming to provide thermal control or other types of control to, for example, a dimming LED driver. For example, embodiments of the present invention or variations thereof may also be adapted to provide overvoltage or overcurrent protection, short circuit protection for, for example, a dimming LED or OLED driver, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless including as discussed above, powerline, etc. and can be implemented in any part of the circuit for the present invention. The present invention can be used with a buck, a buck-boost, a boost-buck and/or a boost, flyback, or forward-converter design, topology, implementation, others discussed herein, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

Some embodiments include a circuit that dynamically adjusts such that the output current to a load such as a LED and/or OLED array is essentially kept constant by, for example, in some embodiments of the present invention shorting or shunting current from the ballast as needed to maintain the output current to a load such as a LED array essentially constant. Some embodiments of the present invention may use time constants to as part of the circuit.

Some embodiments include a circuit to power a protection device/switch such that the switch is on unless commanded or controlled to be set off in the event/situation/condition of a fault hazard. Such a control can be implemented in various and diverse forms and types including, but not limited to, latching, hiccup mode, etc. In some embodiments of the present invention such a circuit may have a separate rectification stage. In and for various embodiments of the present invention, the device/switch may be of any type or form or function and includes but is not limited to, semiconductor switches, vacuum tube switches, mechanical switches, relays, etc.

Some embodiments include an over-voltage protection (OVP) circuit that shunts/shorts or limits the ballast output and/or the output to the load such as a LED array in the event that the output voltage exceeds a set value.

Some embodiments include an over temperature protection (OTP) circuit that shunts/shorts or limits the ballast output and/or the output to the load such as a LED array in the event that the temperature at one or more locations exceeds a set value or set values.

Embodiments of the present invention may also include short circuit protection (SCP) and other forms of protection including protection against damage due to other sources of power including but not limited to AC mains power lines and/or other types of devices, circuits, etc. Some embodiments of the present invention may use, for example, but are not limited to capacitors to limit the low frequency (examples include, but are not limited to, AC line mains at 50 Hz, 60 Hz, 400 Hz) voltage and/or current that can be applied to the load.

Embodiments of the present invention include, but are not limited to, having a rectification stage (such as, but not limited to) consisting of a single full wave rectification stage to provide power/current to the output load such as an LED output load and a rectification stage (such as, but not limited to) consisting of a single full wave rectification stage to provide power to, for example, the hazard protection circuit.

Remote dimming can be performed using a controller implementing motion detection, recognizing motion or proximity to a detector or sensor and setting a dimming level in response to the detected motion or proximity, or with audio detection, for example detecting sounds or verbal commands to set the dimming level in response to detected sounds, volumes, or by interpreting the sounds, including voice recognition or, for example, by gesturing including hand or arm gesturing, etc. Some embodiments may be dual dimming, supporting the use of a 0-10 V dimming signal in addition to a Triac-based or other phase-cut or phase angle dimmer. Some embodiments of the present invention may multiple dimming (i.e., accept dimming information, input(s), control from two or more sources). In addition, the resulting dimming, including current or voltage dimming, can be either PWM (digital) or analog dimming or both or selectable either manually, automatically, or by other methods and ways including software, remote control of any type including, but not limited to, wired, wireless, voice, voice recognition, gesturing including hand and/or arm gesturing, pattern and motion recognition, PLC, RS232, RS422, RS485, SPI, I2C, universal serial bus (USB), Firewire 1394, DALI, DMX, etc. Voice, voice recognition, gesturing, motion, motion recognition, etc. can also be transmitted via wireless, wired and/or powerline communications or other methods, etc. In some embodiments of the present invention speakers, earphones, microphones, etc. may be used with voice, voice recognition, sound, etc. and other methods, ways, approaches, algorithms, etc. discussed herein.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention, although described primarily for motion and light/photodetection control, can and may also use other types of stimuli, input, detection, feedback, response, etc. including but not limited to sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) can also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

The examples shown above are intended to provide non-limiting examples of the present invention and represent only a very small sampling of the possible ways, topologies, connections, arrangements, applications, etc. of the present invention. Based upon the disclosure provided herein, one of skill of the art will recognize a number of combinations and applications of solid state lighting system elements disclosed herein that can be used in accordance with various embodiments of the invention without departing from the inventive concepts.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some cases, parts of a given system, block or circuit may be implemented in software or firmware, while other parts are implemented in hardware.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wireles sly interacting components and/or logically interacting and/or logically interactable components. For example, op amp and comparator in most cases may be used in place of one another in this document.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A lighting system comprising:
at least one solid state light adapted to replace a lamp in a fluorescent lamp fixture; and
a power supply configured to convert power drawn from the fluorescent lamp fixture to power the at least one solid state light, the power supply comprising an auxiliary DC power output, wherein the power supply is configured to generate a regulated DC voltage at the auxiliary DC power output based on the power drawn from the fluorescent lamp fixture.

2. The lighting system of claim 1, the power supply comprising a rectifier, a voltage regulator, and a power output for the at least one solid state light.

3. The lighting system of claim 1, further comprising an isolation circuit configured to control the voltage regulator based on the regulated DC voltage at the auxiliary DC power output.

4. The lighting system of claim 1, further comprising an isolated voltage regulator inductively coupled to the power output for the at least one solid state light to generate an isolated signal based on the power drawn from the fluorescent lamp fixture.

5. The lighting system of claim 4, further comprising an isolation circuit configured to control the voltage regulator based on the isolated DC voltage.

6. The lighting system of claim 4, further comprising a voltage to pulse width converter circuit configured to convert a voltage level-based dimming control signal to a pulse width-based dimming control signal, wherein the voltage to pulse width converter circuit is powered by the isolated DC voltage.

7. The lighting system of claim 1, wherein the power supply is embodied in a fluorescent lamp replacement, and wherein the power supply is configured to automatically draw power from a ballast output in the fluorescent lamp fixture when a ballast is present in the fluorescent lamp fixture.

8. The lighting system of claim 1, wherein the power supply is embodied in a fluorescent lamp replacement, and wherein the power supply is configured to automatically draw power from an AC line in the fluorescent lamp fixture when a ballast is not present in the fluorescent lamp fixture.

9. The lighting system of claim 1, wherein the lighting system comprises a plurality of fluorescent lamp replacements, each comprising at least one of said at least one solid state light and said power supply.

10. The lighting system of claim 9, wherein the lighting system comprises a wall switch configured to control the plurality of fluorescent lamp replacements.

11. The lighting system of claim 10, wherein the wall switch comprises a ballast disengaging circuit.

12. The lighting system of claim 9, wherein the lighting system comprises at least one control system configured to control dimming in the plurality of fluorescent lamp replacements.

13. The lighting system of claim 12, wherein each of the plurality of fluorescent lamp replacements comprise a motion sensor and a signaling transmitter and is configured to activate the signaling transmitter when the motion sensor is trigger, wherein the at least one control system comprises a signaling receiver, wherein the at least one control system is configured to control at least one of the plurality of fluorescent lamp replacements based at least in part on an output of the signaling receiver.

14. The lighting system of claim 12, wherein the lighting system comprises a plurality of interconnected control systems.

15. The lighting system of claim 12, wherein the at least one control system is configured to communicate with at least one remote sensors.

16. The lighting system of claim 12, wherein the at least one control system is configured to communicate with at least one remote sensors using wired and wireless connections.

17. The lighting system of claim 12, wherein the at least one control system is configured to communicate with a gateway device.

18. The lighting system of claim 12, wherein the at least one control system is configured to communicate with remote devices through a gateway device.

19. The lighting system of claim 1, further comprising an inrush current resistive element and bypass switch.

20. The lighting system of claim 1, further comprising a heater emulation circuit.
